(19) United States
(12) Patent Application Publication
(10) Pub. No.: US 2012/0115633 A1
(43) Pub. Date: May 10, 2012

(54) GOLF BALL COMPOSITIONS

(76) Inventors: David A. Bulpett, Boston, MA (US); Robert Blink, Newport, RI (US); Michael J. Sullivan, Barrington, RI (US); Mark L. Binette, Mattapoisett, MA (US); Brian Comeau, Berkley, MA (US); Murali Rajagopalan, South Dartmouth, MA (US)

(21) Appl. No.: 12/941,082

(22) Filed: Nov. 8, 2010

(51) Int. Cl. A63B 37/06; C08L 33/02; A63B 37/00

(52) U.S. Cl. 473/371; 473/351; 525/221

(57) ABSTRACT

Disclosed herein are soft and stiff compositions, i.e., compositions which have a flexural modulus that is greater than the value that is expected based on the composition's hardness. The compositions preferably have a hardness/modulus relationship represented by the formula

H≦11.889Ln(M)+42,

where H is the hardness of the composition, in JIS-C, and M is the flexural modulus of the composition, in ksi; or a softness/stiffness relationship represented by the formula

if M<56, then H≦8.5218Ln(M)+26.5

if M≧56, then H≦8.5218Ln(M)+28.5,

where H is the hardness of the composition, in Shore D, and M is the flexural modulus of the composition, in ksi.

### FIELD OF THE INVENTION

The present invention is directed to thermoplastic compositions that are soft and stiff, and to the use of such compositions in golf balls.

### BACKGROUND OF THE INVENTION

For the vast majority of materials, hardness is used synonymously with flexural modulus. Although both hardness and flexural modulus reflect how a material feels to the touch, hardness measures the resistance to indentation, while flexural modulus measures the resistance to bending. Generally, flexural modulus tends to increase with hardness in a predictable manner, such that the flexural modulus of a material can be predicted based on the material's hardness.

The present invention provides novel compositions in which the flexural modulus is greater than the value that is expected based on the composition's hardness. Such compositions provide unique properties of spin and feel to a golf ball.

### SUMMARY OF THE INVENTION

In one embodiment, the present invention is directed to a golf ball comprising at least one layer formed from a thermoplastic composition having a JIS-C hardness (H) and a flexural modulus in ksi (M) wherein H≦11.889Ln(M)+42, and wherein M>6 ksi.

In another embodiment, the present invention is directed to a golf ball comprising a core, a cover, and an intermediate layer disposed between the core and the cover, wherein the intermediate layer is formed from a polymer blend composition. The polymer blend composition comprises an ionomer and has a JIS-C hardness (H) and a flexural modulus in ksi (M) wherein H≦9.45Ln(−0.0105M²+3.95M−14)+40, and wherein M>40 ksi.

In another embodiment, the present invention is directed to a polymer blend composition comprising an ionomer and having a JIS-C hardness (H) and a flexural modulus in ksi (M) wherein H≦11.889Ln(M)+42, and wherein M>6 ksi.

### BRIEF DESCRIPTION OF THE DRAWINGS

FIG. 1 is a plot of the hardness (in JIS-C, measured according to the method given in the Examples below) versus flex modulus (in ksi, measured according to the method given in the Examples below) of several golf ball compositions.

FIG. 2 is a plot of the hardness (in Shore D, measured according to the method given in the Examples below) versus flex modulus (in ksi, measured according to the method given in the Examples below) of several golf ball compositions.

### DETAILED DESCRIPTION

Thermoplastic compositions of the present invention are soft and stiff. For purposes of the present invention, a composition is soft and stiff if the hardness (H) and flex modulus (M, in ksi, measured according to the method given in the Examples below) of the composition satisfy one of the following equations:
(1) when H is JIS-C hardness, measured according to the JIS-C method given in the Examples below,

H≦11.889Ln(M)+42
(2) when H is Shore D hardness, measured according to the Shore D method given in the Examples below,

if M<56, then H≦8.5218Ln(M)+26.5

if M≧56, then H≦8.5218Ln(M)+28.5.

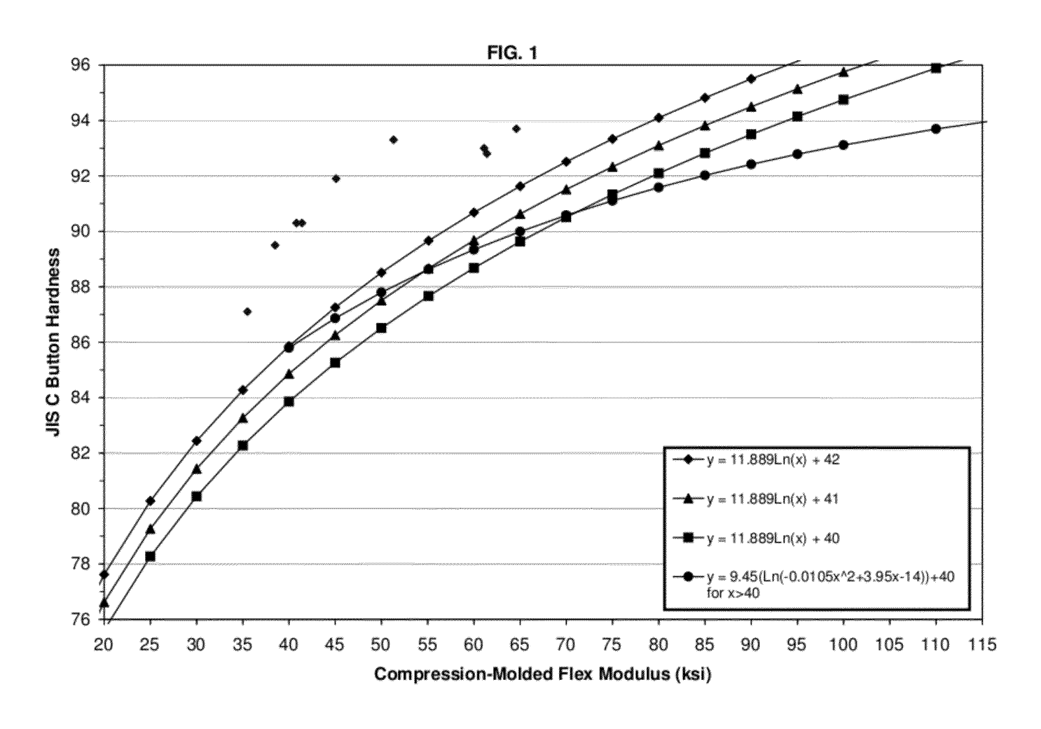

In a particular embodiment, the hardness (H, in JIS-C) and flex modulus (M) satisfy the following equation: H≦11.889Ln(M)+41. In another particular embodiment, the hardness (H, in JIS-C) and flex modulus (M) satisfy the following equation: H≦11.889Ln(M)+40. In another particular embodiment, the composition has a flex modulus of greater than 40 ksi, and the hardness (H, in JIS-C) and flex modulus (M) satisfy the following equation: H≦9.45Ln(−0.0105M²+3.95M−14)+40. In another particular embodiment, a plot of the hardness (H, in JIS-C) versus flex modulus (M) of the composition is within the region below the curve defined by an equation selected from the equations shown in FIG. 1.

In another particular embodiment, the hardness (H, in Shore D) and flex modulus (M) satisfy the following equation:

if M<56, then H≦8.5218Ln(M)+25.5

if M≧56, then H≦8.5218Ln(M)+28.5.

In another particular embodiment, the hardness (H, in Shore D) and flex modulus (M) satisfy the following equation:

if M<56, then H≦8.5218Ln(M)+24

if M≧56, then H≦8.5218Ln(M)+28.5.

In another particular embodiment, the hardness (H, in Shore D) and flex modulus (M) satisfy one of the following equations:
(1) if M is <56, then hardness and flex modulus satisfy an equation selected from the following:

H≦8.5218Ln(M)+26.5,

H≦8.5218Ln(M)+25.5, and

H≦8.5218Ln(M)+24;
(2) if M is ≧56, then hardness and flex modulus satisfy an equation selected from the following:

H≦8.5218Ln(M)+28.5,

H≦8.5218Ln(M)+26.5,

H≦8.5218Ln(M)+25.5, and

H≦8.5218Ln(M)+24.

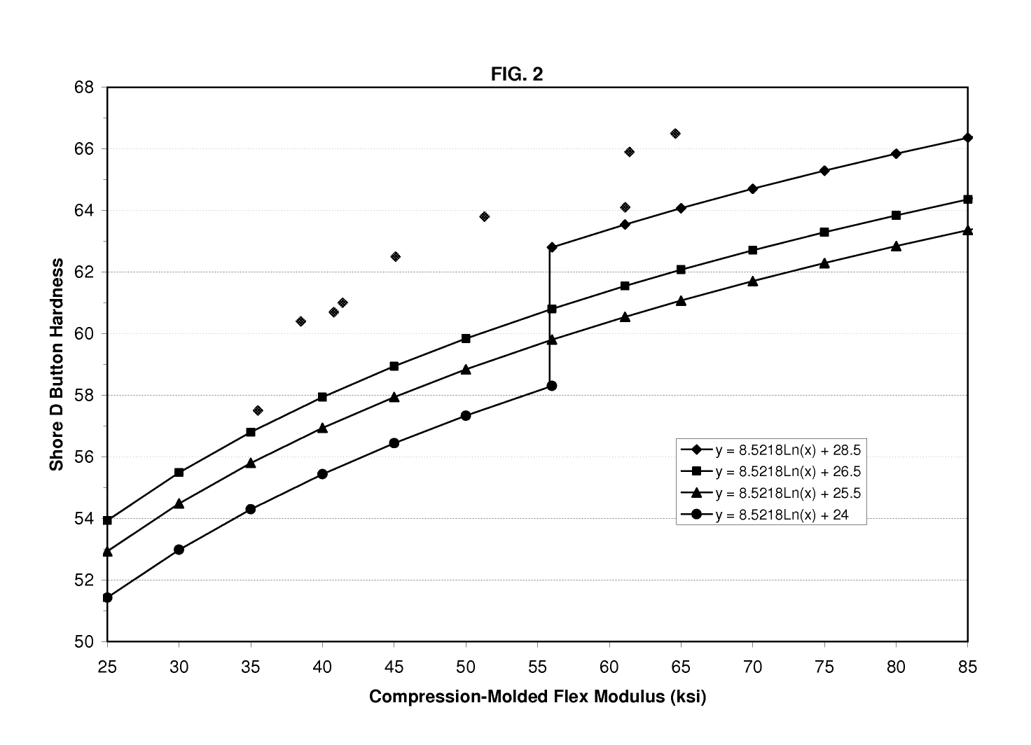

In another particular embodiment, a plot of the hardness (H, in Shore D) versus flex modulus (M) of the composition is within the region below the curve defined by an equation or a combination of two equations (a first equation for M<56, and a second equation for M≧56) selected from the equations shown in FIG. 2.

Thermoplastic compositions of the present invention comprise a base polymer, and optionally additive(s) and filler(s). The base polymer is preferably selected from the group consisting of ionomers, non-ionomeric polyolefins, polyesters, polyamides, polyurethanes, polystyrenes, and combinations of two or more thereof.

Suitable ionomers for use in the base polymer include partially neutralized ionomers, blends of two or more partially neutralized ionomers, highly neutralized ionomers, blends of two or more highly neutralized ionomers, and blends of one or more partially neutralized ionomers with one or more highly neutralized ionomers. Preferred ionomers are salts of O/X- and O/X/Y-type acid copolymers, wherein O is an α-olefin, X is a C₃-C₈ α,β-ethylenically unsaturated carboxylic acid, and Y is a softening monomer. O is preferably selected from ethylene and propylene. X is preferably selected from methacrylic acid, acrylic acid, ethacrylic acid, maleic acid, crotonic acid, fumaric acid, and itaconic acid. Methacrylic acid and acrylic acid are particularly preferred. As used herein, “(meth) acrylic acid” means methacrylic acid and/or acrylic acid Likewise, “(meth) acrylate” means methacrylate and/or acrylate. Y is preferably selected from (meth)acrylate and alkyl (meth)acrylates wherein the alkyl groups have from 1 to 8 carbon atoms, including, but not limited to, n-butyl (meth)acrylate, isobutyl (meth)acrylate, methyl (meth)acrylate, and ethyl (meth) acrylate. Particularly preferred O/X/Y-type copolymers are ethylene/(meth) acrylic acid/n-butyl acrylate, ethylene/(meth) acrylic acid/methyl acrylate, and ethylene/(meth) acrylic acid/ethyl acrylate. The acid is typically present in the acid copolymer in an amount of 10 wt % or less, or 11 wt % or less, or 15 wt % or greater, or 16 wt % or greater, or in an amount within a range having a lower limit of 1 or 4 or 6 or 8 or 10 or 11 or 12 or 15 wt % and an upper limit of 15 or 16 or 20 or 25 or 30 or 35 or 40 wt %, based on the total weight of the acid copolymer. The acid copolymer is at least partially neutralized with a cation source, optionally in the presence of a high molecular weight organic acid, such as those disclosed in U.S. Pat. No. 6,756,436, the entire disclosure of which is hereby incorporated herein by reference. Suitable cation sources include, but are not limited to, metal ions and compounds of alkali metals, alkaline earth metals, and transition metals; metal ions and compounds of rare earth elements; ammonium salts and monoamine salts; and combinations thereof. Preferred cation sources are metal ions and compounds of magnesium, sodium, potassium, cesium, calcium, barium, manganese, copper, zinc, tin, lithium, and rare earth metals.

Methods of preparing ionomers are well known, and are disclosed, for example, in U.S. Pat. No. 3,264,272, the entire disclosure of which is hereby incorporated herein by reference. The acid copolymer can be a direct copolymer wherein the polymer is polymerized by adding all monomers simultaneously, as disclosed, for example, in U.S. Pat. No. 4,351,931, the entire disclosure of which is hereby incorporated herein by reference. Alternatively, the acid copolymer can be a graft copolymer wherein a monomer is grafted onto an existing polymer, as disclosed, for example, in U.S. Patent Application Publication No. 2002/0013413, the entire disclosure of which is hereby incorporated herein by reference.

Commercially available ionomers that are particularly suitable for use in the base polymer include, but are not limited to, Surlyn® ionomers and DuPont® HPF 1000 and HPF 2000 highly neutralized ionomers, commercially available from E. I. du Pont de Nemours and Company; Clarix® ionomers, commercially available from A. Schulman, Inc.; Iotek® ionomers, commercially available from ExxonMobil Chemical Company; Amplify® IO ionomers, commercially available from The Dow Chemical Company; and blends of two or more thereof.

Additional suitable ionomers for use in the base polymer are disclosed, for example, in U.S. Patent Application Publication Nos. 2005/0049367, 2005/0148725, 2005/0020741, 2004/0220343, and 2003/0130434, and U.S. Pat. Nos. 5,691,418, 6,100,321, 6,562,906, 6,653,382, 6,777,472, 6,762,246, 6,815,480, and 6,953,820, the entire disclosures of which are hereby incorporated herein by reference.

Suitable non-ionomeric polyolefins for use in the base polymer include, but are not limited to, polyethylenes, polypropylenes, rubber-toughened olefin polymers, acid copolymers, styrenic block copolymers, dynamically vulcanized elastomers, ethylene vinyl acetates, ethylene acrylate based terpolymers, ethylene elastomers, propylene elastomers, ethylene-propylene-diene rubbers (EPDM), and combinations thereof. Commercially available non-ionomeric polyolefins that are particularly suitable for use in the base polymer include, but are not limited to, Amplify® GR functional polymers and Amplify® TY functional polymers, commercially available from The Dow Chemical Company; Fusabond® functionalized polymers, including ethylene vinyl acetates, polyethylenes, metallocene-catalyzed polyethylenes, ethylene propylene rubbers, and polypropylenes, commercially available from E. I. du Pont de Nemours and Company; Exxelor® maleic anhydride grafted polymers, including high density polyethylene, polypropylene, semi-crystalline ethylene copolymer, amorphous ethylene copolymer, commercially available from ExxonMobil Chemical Company; ExxonMobil® PP series polypropylene impact copolymers, such as PP7032E3, PP7032KN, PP7033E3, PP7684KN, commercially available from ExxonMobil Chemical Company; Vistamaxx® propylene-based elastomers, commercially available from ExxonMobil Chemical Company; Vistalon® EPDM rubbers, commercially available from ExxonMobil Chemical Company; Exact® plastomers, commercially available from ExxonMobil Chemical Company; Santoprene® thermoplastic vulcanized elastomers, commercially available from ExxonMobil Chemical Company; Nucrel® acid copolymers, commercially available from E. I. du Pont de Nemours and Company; Escor® acid copolymers, commercially available from ExxonMobil Chemical Company; Primacor® acid copolymers, commercially available from The Dow Chemical Company; Kraton® styrenic block copolymers, commercially available from Kraton Performance Polymers Inc.; Septon® styrenic block copolymers, commercially available from Kuraray Co., Ltd.; Lotader® ethylene acrylate based terpolymers, commercially available from Arkema Corporation; Polybond® grafted polyethylenes and polypropylenes, commercially available from Chemtura Corporation; Royaltuf® chemically modified EPDM, commercially available from Chemtura Corporation; and Vestenamer® polyoctenamer, commercially available from Evonik Industries.

In a particular embodiment, the base polymer is a blend of at least two different polymers. In a particular aspect of this embodiment, at least one polymer is an ionomer.

In another particular embodiment, the base polymer is a blend of at least a first and a second ionomer.

In another particular embodiment, the base polymer is a blend of at least an ionomer and an additional polymer selected from non-ionomeric polyolefins, polyesters, polyamides, polyurethanes, and polystyrenes.

In another particular embodiment, the base polymer is a blend of at least a functionalized polyethylene and a functionalized polymer selected from polyethylenes, including metallocene-catalyzed and non-metallocene-catalyzed polyethylenes, ethylene vinyl acetates, ethylene-acid random copolymers, ethylene elastomers, and polypropylenes. In a particular aspect of this embodiment, the functionalized polyethylene is a maleic anhydride-grafted polymer selected from ethylene homopolymers, ethylene-hexene copolymers, ethylene-octene copolymers, ethylene-ethyl acrylate copolymers, and ethylene-butene copolymers.

In another particular embodiment, the base polymer is a blend of at least an ionomer, a functionalized polyethylene and a functionalized polymer selected from polyethylenes, including metallocene-catalyzed and non-metallocene-catalyzed polyethylenes, ethylene vinyl acetates, ethylene-acid random copolymers, ethylene elastomers, and polypropylenes. In a particular aspect of this embodiment, the functionalized polyethylene is a maleic anhydride-grafted polymer selected from ethylene homopolymers, ethylene-hexene copolymers, ethylene-octene copolymers, ethylene-ethyl acrylate copolymers, and ethylene-butene copolymers.

In another particular embodiment, the base polymer is a blend of at least an ionomer and a maleic anhydride-grafted polyethylene. In a particular aspect of this embodiment, the polyethylene is selected from ethylene homopolymers, ethylene-hexene copolymers, ethylene-octene copolymers, ethylene-ethyl acrylate copolymers, and ethylene-butene copolymers.

In another particular embodiment, the base polymer is a blend of at least an ionomer and a functionalized polymer selected from polyethylenes, including metallocene-catalyzed and non-metallocene-catalyzed polyethylenes, ethylene vinyl acetates, ethylene-acid random copolymers, ethylene elastomers, and polypropylenes.

In another particular embodiment, the base polymer is a blend of at least an ionomer and an acid copolymer.

In another particular embodiment, the base polymer is a blend of at least an ionomer and a functionalized styrenic block copolymer.

In another particular embodiment, the base polymer is a blend of at least an ionomer and an ethylene acrylate based terpolymer.

In another particular embodiment, the base polymer is a blend of at least an ionomer and a functionalized EPDM.

In another particular embodiment, the base polymer is a blend of at least an ionomer and a polyoctenamer.

In another particular embodiment, the base polymer is a blend of at least an ionomer, particularly a medium acid (11-16 wt %) or high acid (>16 wt %) ionomer, and a highly crystalline polymer, particularly wherein the highly crystalline polymer is selected from highly crystalline ionomers and acid copolymers disclosed in and prepared according to the process for producing highly crystalline ionomers and acid copolymers disclosed in U.S. Pat. Nos. 5,580,927 and 6,100,340, the entire disclosures of which are hereby incorporated herein by reference. In a particular aspect of this embodiment, the base polymer is a blend of a high acid ionomer and a highly crystalline polymer, wherein the high acid ionomer is selected from sodium ionomers, lithium ionomers, zinc ionomers, magnesium ionomers, and blends of two or more thereof.

In another particular embodiment, the base polymer is a blend of an ionomer and a second component selected from ionomers and acid copolymers, wherein the second component has a high melting point, i.e., a melting point of 98° C. or greater, preferably 100° or greater.

Soft and stiff compositions of the present invention optionally include additive(s) and/or filler(s) in an amount of 50 wt % or less, or 30 wt % or less, or 20 wt % or less, or 15 wt % or less, based on the total weight of the soft and stiff composition. Suitable additives and fillers include, but are not limited to, chemical blowing and foaming agents, optical brighteners, coloring agents, fluorescent agents, whitening agents, UV absorbers, light stabilizers, defoaming agents, processing aids, antioxidants, stabilizers, softening agents, fragrance components, plasticizers, impact modifiers, TiO₂, acid copolymer wax, surfactants, performance additives (e.g., A-C® performance additives, particularly A-C® low molecular weight ionomers and copolymers, A-C® oxidized polyethylenes, and A-C® ethylene vinyl acetate waxes, commercially available from Honeywell International Inc.), fatty acid amides (e.g., ethylene bis-stearamide and ethylene bis-oleamide), fatty acids and salts thereof (e.g., stearic acid, oleic acid, zinc stearate, magnesium stearate, zinc oleate, and magnesium oleate), and fillers, such as zinc oxide, tin oxide, barium sulfate, zinc sulfate, calcium oxide, calcium carbonate, zinc carbonate, barium carbonate, tungsten, tungsten carbide, silica, lead silicate, regrind (recycled material), clay, mica, talc, nano-fillers, carbon black, glass flake, milled glass, flock, fibers, and mixtures thereof. Suitable additives are more fully described in, for example, U.S. Patent Application Publication No. 2003/0225197, the entire disclosure of which is hereby incorporated herein by reference. In a particular embodiment, the total amount of additive(s) and filler(s) present in the soft and stiff composition is 20 wt % or less, or 15 wt % or less, or 12 wt % or less, or 10 wt % or less, or 9 wt % or less, or 6 wt % or less, or 5 wt % or less, or 4 wt % or less, or 3 wt % or less, or within a range having a lower limit of 0 or 2 or 3 or 5 wt %, based on the total weight of the soft and stiff composition, and an upper limit of 9 or 10 or 12 or 15 or 20 wt %, based on the total weight of the soft and stiff composition. In a particular aspect of this embodiment, the soft and stiff composition includes filler(s) selected from carbon black, micro- and nano-scale clays and organoclays, including (e.g., Cloisite® and Nanofil® nanoclays, commercially available from Southern Clay Products, Inc.; Nanomax® and Nanomer® nanoclays, commercially available from Nanocor, Inc., and Perkalite® nanoclays, commercially available from Akzo Nobel Polymer Chemicals), micro- and nano-scale talcs (e.g., Luzenac HAR® high aspect ratio talcs, commercially available from Luzenac America, Inc.), glass (e.g., glass flake, milled glass, microglass, and glass fibers), micro- and nano-scale mica and mica-based pigments (e.g., Iriodin® pearl luster pigments, commercially available from The Merck Group), and combinations thereof. Particularly suitable combinations of fillers include, but are not limited to, micro-scale filler(s) combined with nano-scale filler(s), and organic filler(s) with inorganic filler(s).

Soft and stiff compositions of the present invention optionally include one or more melt flow modifiers. Suitable melt flow modifiers include materials which increase the melt flow of the composition, as measured using ASTM D-1238, condition E, at 190° C., using a 2160 gram weight. Examples of suitable melt flow modifiers include, but are not limited to, fatty acids and fatty acid salts, including, but not limited to, those disclosed in U.S. Pat. No. 5,306,760, the entire disclosure of which is hereby incorporated herein by reference; fatty amides and salts thereof; polyhydric alcohols, including, but not limited to, those disclosed in U.S. Pat. No. 7,365,128, and U.S. Patent Application Publication No. 2010/0099514, the entire disclosures of which are hereby incorporated herein by reference; polylactic acids, including, but not limited to, those disclosed in U.S. Pat. No. 7,642,319, the entire disclosure of which is hereby incorporated herein by reference; and the modifiers disclosed in U.S. Patent Application Publication No. 2010/0099514 and 2009/0203469, the entire disclosures of which are hereby incorporated herein by reference. Flow enhancing additives also include, but are not limited to, montanic acids, esters of montanic acids and salts thereof, bis-stearoylethylenediamine, mono- and polyalcohol esters such as pentaerythritol tetrastearate, zwitterionic compounds, and metallocene-catalyzed polyethylene and polypropylene wax, including maleic anhydride modified versions thereof, amide waxes and alkylene diamides such as bistearamides. Particularly suitable fatty amides include, but not limited to, saturated fatty acid monoamides (e.g., lauramide, palmitamide, arachidamide behenamide, stearamide, and 12-hydroxy stearamide); unsaturated fatty acid monoamides (e.g., oleamide, erucamide, and recinoleamide); N-substituted fatty acid amides (e.g., N-stearyl stearamide, N-behenyl behenamide, N-stearyl behenamide, N-behenyl stearamide, N-oleyl oleamide, N-oleyl stearamide, N-stearyl oleamide, N-stearyl erucamide, erucyl erucamide, and erucyl stearamide, N-oleyl palmitamide, methylol amide (more preferably, methylol stearamide, methylol behenamide); saturated fatty acid bis-amides (e.g., methylene bis-stearamide, ethylene bis-stearamide, ethylene bis-isostearamide, ethylene bis-hydroxystearamide, ethylene bis-behenamide, hexamethylene bis-stearamide, hexamethylene bis-behenamide, hexamethylene bis-hydroxystearamide, N,N′-distearyl adipamide, and N,N′-distearyl sebacamide); unsaturated fatty acid bis-amides (e.g., ethylene bis-oleamide, hexamethylene bis-oleamide, N,N′-dioleyl adipamide, N,N′-dioleyl sebacamide); and saturated and unsaturated fatty acid tetra amides, stearyl erucamide, ethylene bis stearamide and ethylene bis oleamide. Suitable examples of commercially available fatty amides include, but are not limited to, Kemamide® fatty acids, such as Kemamide® B (behenamide/arachidamide), Kemamide® W40 (N,N′-ethylenebisstearamide), Kemamide® P181 (oleyl palmitamide), Kemamide® S (stearamide), Kemamide® U (oleamide), Kemamide® E (erucamide), Kemamide® 0 (oleamide), Kemamide® W45 (N,N′-ethylenebisstearamide), Kenamide® W20 (N,N′-ethylenebisoleamide), Kemamide® E180 (stearyl erucamide), Kemamide® E221 (erucyl erucamide), Kemamide® S180 (stearyl stearamide), Kemamide® S221 (erucyl stearamide), commercially available from Humko Chemical Company; and Crodamide® fatty amides, such as Crodamide® OR (oleamide), Crodamide® ER (erucamide), Crodamide® SR (stereamide), Crodamide® BR (behenamide), Crodamide® 203 (oleyl palmitamide), and Crodamide® 212 (stearyl erucamide), commercially available from Croda Universal Ltd. In a particular embodiment, the soft and stiff composition includes a melt flow modifier in an amount within a range having a lower limit of 0.0001 or 0.001 or 0.01 parts per hundred parts polymer (pph) and an upper limit of 5 or 10 or 15 pph.

In a particular embodiment, the soft and stiff composition is modified with organic fiber micropulp, as disclosed, for example, in U.S. Pat. No. 7,504,448, the entire disclosure of which is hereby incorporated herein by reference.

In another particular embodiment, the soft and stiff composition comprises at least one nanoclay, preferably wherein the total amount of nanoclay(s) present is from 3 to 25 wt % based on the total weight of the composition, and an ionomer. In a particular aspect of this embodiment, the ionomer is at least partially neutralized with a zinc ionomer. In another particular aspect of this embodiment, the ionomer is at least partially neutralized with a sodium ionomer. In another particular aspect of this embodiment, the ionomer is at least partially neutralized with a first and a second cation, wherein the first cation is zinc.

Soft and stiff compositions of the present invention preferably have a JIS-C hardness, as measured according to the method given in the Examples below, within a range having a lower limit of 75 or 80 or 82 or 84 or 86 and an upper limit of 86 or 87 or 88 or 90 or 92 or 95 or 96, or a JIS-C hardness of 96 or less, or 95 or less, or 90 or less, or 88 or less, or less than 88, or 87 or less, or less than 87, or 86 or less, or less than 86.

Soft and stiff compositions of the present invention preferably have a flexural modulus, as measured according to the method given in the Examples below, of 6 ksi or greater, or 8 ksi or greater, or 10 ksi or greater, or 15 ksi or greater, or 20 ksi or greater, or 25 ksi or greater, or 30 ksi or greater, or 35 ksi or greater, or 40 ksi or greater, or 45 ksi or greater, or 48 ksi or greater, or 50 ksi or greater, or 52 ksi or greater, or 55 ksi or greater, or 60 ksi or greater, or 63 ksi or greater, or 65 ksi or greater, or 70 or greater, or a flexural modulus within a range having a lower limit of 5 or 6 or 8 or 10 or 15 or 20 or 25 or 30 or 35 or 40 or 45 or 48 or 50 or 52 or 55 or 55 or 60 or 63 or 65 or 70 ksi and an upper limit of 75 or 80 or 85 or 90 or 95 or 100 or 105 or 110 or 115 ksi, or a flexural modulus within a range having a lower limit of 20 or 25 or 30 or 35 or 40 or 45 or 50 or 55 or 60 ksi and an upper limit of 60 or 65 or 70 or 75 or 80 ksi.

Particularly suitable soft and stiff compositions are given in the Examples below.

### Golf Ball Applications

Soft and stiff compositions according to the present invention can be used in a variety of applications. For example, the polymer compositions are suitable for use in golf balls, including one-piece, two-piece (i.e., a core and a cover), multi-layer (i.e., a core of one or more layers and a cover of one or more layers), and wound golf balls, having a variety of core structures, intermediate layers, covers, and coatings.

In golf balls of the present invention, at least one layer is formed from a thermoplastic composition that is soft and stiff as described herein. In golf balls having two or more layers which comprise a soft and stiff composition, the soft and stiff composition of one layer may be the same or a different soft and stiff composition as another layer. The layer(s) comprising the soft and stiff composition can be any one or more of a core layer, an intermediate layer, or a cover layer.

### Core Layer(s)

Cores of the golf balls formed according to the invention may be solid, semi-solid, hollow, fluid-, powder-, or gas-filled, and may be one-piece or multi-layered. Multilayer cores include a center, innermost portion, which may be solid, semi-solid, hollow, fluid-, powder-, or gas-filled, surrounded by at least one outer core layer. The outer core layer may be solid, or it may be a wound layer formed of a tensioned elastomeric material. For purposes of the present disclosure, the term “semi-solid” refers to a paste, a gel, or the like. Any core material known to one of ordinary skill in that art is suitable for use in the golf balls of the invention. Suitable core materials include thermoset materials, such as rubber, styrene butadiene, polybutadiene, isoprene, polyisoprene, trans-isoprene, as well as thermoplastics such as ionomer resins, polyamides or polyesters, and thermoplastic and thermoset polyurethane elastomers. As mentioned above, the soft and stiff compositions of the present invention may be incorporated into any component of a golf ball, including the core.

In a particular embodiment, the core layer(s) are each formed from a rubber composition comprising a base rubber, an initiator agent, a coagent, and optionally one or more of a zinc oxide, zinc stearate or stearic acid, antioxidant, and a soft and fast agent. Suitable base rubbers include Suitable rubber compositions for forming the inner core layer(s) comprise a base rubber, an initiator agent, a coagent, and optionally one or more of a zinc oxide, zinc stearate or stearic acid, antioxidant, and soft and fast agent. Suitable base rubbers include natural and synthetic rubbers including, but not limited to, polybutadiene, polyisoprene, ethylene propylene rubber (“EPR”), styrene-butadiene rubber, styrenic block copolymer rubbers (such as SI, SIS, SB, SBS, SIBS, and the like, where “S” is styrene, “I” is isoprene, and “B” is butadiene), butyl rubber, halobutyl rubber, polystyrene elastomers, polyethylene elastomers, polyurethane elastomers, polyurea elastomers, metallocene-catalyzed elastomers and plastomers, copolymers of isobutylene and para-alkylstyrene, halogenated copolymers of isobutylene and para-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof (e.g., polybutadiene combined with lesser amounts of other thermoset materials selected from cis-polyisoprene, trans-polyisoprene, balata, polychloroprene, polynorbornene, polyoctenamer, polypentenamer, butyl rubber, EPR, EPDM, styrene-butadiene, and similar thermoset materials). Diene rubbers are preferred, particularly polybutadiene (including 1,4-polybutadiene having a cis-structure of at least 40%), styrene-butadiene, and mixtures of polybutadiene with other elastomers wherein the amount of polybutadiene present is at least 40 wt % based on the total polymeric weight of the mixture. Particularly preferred polybutadienes include high-cis neodymium-catalyzed polybutadienes and cobalt-, nickel-, or lithium-catalyzed polybutadienes. Suitable examples of commercially available polybutadienes include, but are not limited to, Buna CB high-cis neodymium-catalyzed polybutadiene rubbers, such as Buna CB 23, and high-cis cobalt-catalyzed polybutadiene rubbers, such as Buna CB 1220 and CB 1221, commercially available from LANXESS® Corporation, and BR 1220, commercially available from BST Elastomers Co., Ltd.; Europrene® NEOCIS® BR 40 and BR 60, commercially available from Polimeri Europa®; UBEPOL-BR® rubbers, commercially available from UBE Industries, Inc.; BR rubbers, commercially available from Japan Synthetic Rubber Co., Ltd.; and Neodene high-cis neodymium-catalyzed polybutadiene rubbers, such as Neodene BR 40 and BR 45, commercially available from Karbochem.

Suitable initiator agents include organic peroxides, high energy radiation sources capable of generating free radicals, and combinations thereof. High energy radiation sources capable of generating free radicals include, but are not limited to, electron beams, ultra-violet radiation, gamma radiation, X-ray radiation, infrared radiation, heat, and combinations thereof. Suitable organic peroxides include, but are not limited to, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; lauryl peroxide; benzoyl peroxide; and combinations thereof. Examples of suitable commercially available peroxides include, but are not limited to Perkadox® and Trigonox® organic peroxides, both of which are commercially available from Akzo Nobel, and Varox® peroxides, such as Varox® ANS benzoyl peroxide, Varox® 231 1,1-di(t-butylperoxy)3,3,5-trimethylcyclohexane, and Varox® 230-XL n-butyl-4,4-bis(tert-butylperoxy)valerate, commercially available from RT Vanderbilt Company, Inc.

Peroxide initiator agents are generally present in the rubber composition in an amount of at least 0.05 parts by weight per 100 parts of the base rubber, or an amount within the range having a lower limit of 0.05 parts or 0.1 parts or 0.4 parts or 0.5 parts or 0.8 parts or 1 part or 1.25 parts or 1.5 parts by weight per 100 parts of the base rubber, and an upper limit of 2.5 parts or 3 parts or 5 parts or 6 parts or 10 parts or 15 parts by weight per 100 parts of the base rubber.

Coagents are commonly used with peroxides to increase the state of cure. Suitable coagents include, but are not limited to, metal salts of unsaturated carboxylic acids; unsaturated vinyl compounds and polyfunctional monomers (e.g., trimethylolpropane trimethacrylate); phenylene bismaleimide; and combinations thereof. Particular examples of suitable metal salts include, but are not limited to, one or more metal salts of acrylates, diacrylates, methacrylates, and dimethacrylates, wherein the metal is selected from magnesium, calcium, zinc, aluminum, lithium, nickel, and sodium. In a particular embodiment, the coagent is selected from zinc salts of acrylates, diacrylates, methacrylates, dimethacrylates, and mixtures thereof. In another particular embodiment, the coagent is zinc diacrylate. When the coagent is zinc diacrylate and/or zinc dimethacrylate, the coagent is typically included in the rubber composition in an amount within the range having a lower limit of 1 or 5 or 10 or 15 or 19 or 20 parts by weight per 100 parts of the base rubber, and an upper limit of 24 or 25 or 30 or 35 or 40 or 45 or 50 or 60 parts by weight per 100 parts of the base rubber. When one or more less active coagents are used, such as zinc monomethacrylate and various liquid acrylates and methacrylates, the amount of less active coagent used may be the same as or higher than for zinc diacrylate and zinc dimethacrylate coagents. The desired compression may be obtained by adjusting the amount of crosslinking, which can be achieved, for example, by altering the type and amount of coagent.

The rubber composition optionally includes a sulfur-based agent. Suitable sulfur-based agents include, but are not limited to, sulfur; N-oxydiethylene 2-benzothiazole sulfenamide; N,N-di-ortho-tolylguanidine; bismuth dimethyldithiocarbamate; N-cyclohexyl 2-benzothiazole sulfenamide; N,N-diphenylguanidine; 4-morpholinyl-2-benzothiazole disulfide; dipentamethylenethiuram hexasulfide; thiuram disulfides; mercaptobenzothiazoles; sulfenamides; dithiocarbamates; thiuram sulfides; guanidines; thioureas; xanthates; dithiophosphates; aldehyde-amines; dibenzothiazyl disulfide; tetraethylthiuram disulfide; tetrabutylthiuram disulfide; and combinations thereof.

The rubber composition optionally contains one or more antioxidants. Antioxidants are compounds that can inhibit or prevent the oxidative degradation of the rubber. Some antioxidants also act as free radical scavengers; thus, when antioxidants are included in the rubber composition, the amount of initiator agent used may be as high or higher than the amounts disclosed herein. Suitable antioxidants include, for example, dihydroquinoline antioxidants, amine type antioxidants, and phenolic type antioxidants.

The rubber composition may also contain one or more fillers to adjust the density and/or specific gravity of the core. Exemplary fillers include precipitated hydrated silica, clay, talc, asbestos, glass fibers, aramid fibers, mica, calcium metasilicate, zinc sulfate, barium sulfate, zinc sulfide, lithopone, silicates, silicon carbide, diatomaceous earth, polyvinyl chloride, carbonates (e.g., calcium carbonate, zinc carbonate, barium carbonate, and magnesium carbonate), metals (e.g., titanium, tungsten, aluminum, bismuth, nickel, molybdenum, iron, lead, copper, boron, cobalt, beryllium, zinc, and tin), metal alloys (e.g., steel, brass, bronze, boron carbide whiskers, and tungsten carbide whiskers), metal oxides (e.g., zinc oxide, tin oxide, iron oxide, calcium oxide, aluminum oxide, titanium dioxide, magnesium oxide, and zirconium oxide), particulate carbonaceous materials (e.g., graphite, carbon black, cotton flock, natural bitumen, cellulose flock, and leather fiber), microballoons (e.g., glass and ceramic), fly ash, regrind (i.e., core material that is ground and recycled), nanofillers, and combinations of two or more thereof. The amount of particulate material(s) present in the rubber composition is typically within a range having a lower limit of 5 parts or 10 parts by weight per 100 parts of the base rubber, and an upper limit of 30 parts or 50 parts or 100 parts by weight per 100 parts of the base rubber. Filler materials may be dual-functional fillers, such as zinc oxide (which may be used as a filler/acid scavenger) and titanium dioxide (which may be used as a filler/brightener material).

The rubber composition may also contain one or more additives selected from processing aids, processing oils, plasticizers, coloring agents, fluorescent agents, chemical blowing and foaming agents, defoaming agents, stabilizers, softening agents, impact modifiers, free radical scavengers, accelerators, scorch retarders, and the like. The amount of additive(s) typically present in the rubber composition is typically within a range having a lower limit of 0 parts by weight per 100 parts of the base rubber, and an upper limit of 20 parts or 50 parts or 100 parts or 150 parts by weight per 100 parts of the base rubber.

The rubber composition optionally includes a soft and fast agent. Preferably, the rubber composition contains from 0.05 phr to 10.00 phr of a soft and fast agent. In one embodiment, the soft and fast agent is present in an amount within a range having a lower limit of 0.05 or 0.10 or 0.20 or 0.50 phr and an upper limit of 1.00 or 2.00 or 3.00 or 5.00 phr. In another embodiment, the soft and fast agent is present in an amount within a range having a lower limit of 2.00 or 2.35 phr and an upper limit of 3.00 or 4.00 or 5.00 phr. In an alternative high concentration embodiment, the soft and fast agent is present in an amount within a range having a lower limit of 5.00 or 6.00 or 7.00 phr and an upper limit of 8.00 or 9.00 or 10.00 phr. In another embodiment, the soft and fast agent is present in an amount of 2.6 phr.

Suitable soft and fast agents include, but are not limited to, organosulfur and metal-containing organosulfur compounds; organic sulfur compounds, including mono, di, and polysulfides, thiol, and mercapto compounds; inorganic sulfide compounds; blends of an organosulfur compound and an inorganic sulfide compound; Group VIA compounds; substituted and unsubstituted aromatic organic compounds that do not contain sulfur or metal; aromatic organometallic compounds; hydroquinones; benzoquinones; quinhydrones; catechols; resorcinols; and combinations thereof.

As used herein, “organosulfur compound” refers to any compound containing carbon, hydrogen, and sulfur, where the sulfur is directly bonded to at least 1 carbon. As used herein, the term “sulfur compound” means a compound that is elemental sulfur, polymeric sulfur, or a combination thereof. It should be further understood that the term “elemental sulfur” refers to the ring structure of S₈ and that “polymeric sulfur” is a structure including at least one additional sulfur relative to elemental sulfur.

Particularly suitable as soft and fast agents are organosulfur compounds having the following general formula:

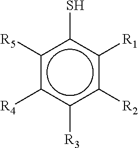

where R₁-R₅ can be C₁-C₈ alkyl groups; halogen groups; thiol groups (—SH), carboxylated groups; sulfonated groups; and hydrogen; in any order; and also pentafluorothiophenol; 2-fluorothiophenol; 3-fluorothiophenol; 4-fluorothiophenol; 2,3-fluorothiophenol; 2,4-fluorothiophenol; 3,4-fluorothiophenol; 3,5-fluorothiophenol 2,3,4-fluorothiophenol; 3,4,5-fluorothiophenol; 2,3,4,5-tetrafluorothiophenol; 2,3,5,6-tetrafluorothiophenol; 4-chlorotetrafluorothiophenol; pentachlorothiophenol; 2-chlorothiophenol; 3-chlorothiophenol; 4-chlorothiophenol; 2,3-chlorothiophenol; 2,4-chlorothiophenol; 3,4-chlorothiophenol; 3,5-chlorothiophenol; 2,3,4-chlorothiophenol; 3,4,5-chlorothiophenol; 2,3,4,5-tetrachlorothiophenol; 2,3,5,6-tetrachlorothiophenol; pentabromothiophenol; 2-bromothiophenol; 3-bromothiophenol; 4-bromothiophenol; 2,3-bromothiophenol; 2,4-bromothiophenol; 3,4-bromothiophenol; 3,5-bromothiophenol; 2,3,4-bromothiophenol; 3,4,5-bromothiophenol; 2,3,4,5-tetrabromothiophenol; 2,3,5,6-tetrabromothiophenol; pentaiodothiophenol; 2-iodothiophenol; 3-iodothiophenol; 4-iodothiophenol; 2,3-iodothiophenol; 2,4-iodothiophenol; 3,4-iodothiophenol; 3,5-iodothiophenol; 2,3,4-iodothiophenol; 3,4,5-iodothiophenol; 2,3,4,5-tetraiodothiophenol; 2,3,5,6-tetraiodothiophenoland; zinc salts thereof; non-metal salts thereof, for example, ammonium salt of pentachlorothiophenol; magnesium pentachlorothiophenol; cobalt pentachlorothiophenol; and combinations thereof. Preferably, the halogenated thiophenol compound is pentachlorothiophenol, which is commercially available in neat form or under the tradename STRUKTOL® A95, a clay-based carrier containing the sulfur compound pentachlorothiophenol loaded at 45 percent. STRUKTOL® A95 is commercially available from Struktol Company of America of Stow, Ohio. PCTP is commercially available in neat form from eChinachem of San Francisco, Calif. and in the salt form from eChinachem of San Francisco, Calif. Most preferably, the halogenated thiophenol compound is the zinc salt of pentachlorothiophenol, which is commercially available from eChinachem of San Francisco, Calif. Suitable organosulfur compounds are further disclosed, for example, in U.S. Pat. Nos. 6,635,716, 6,919,393, 7,005,479 and 7,148,279, the entire disclosures of which are hereby incorporated herein by reference.

Suitable metal-containing organosulfur compounds include, but are not limited to, cadmium, copper, lead, and tellurium analogs of diethyldithiocarbamate, diamyldithiocarbamate, and dimethyldithiocarbamate, and combinations thereof. Additional examples are disclosed in U.S. Pat. No. 7,005,479, the entire disclosure of which is hereby incorporated herein by reference.

Suitable disulfides include, but are not limited to, 4,4′-diphenyl disulfide; 4,4′-ditolyl disulfide; 2,2′-benzamido diphenyl disulfide; bis(2-aminophenyl) disulfide; bis(4-aminophenyl) disulfide; bis(3-aminophenyl) disulfide; 2,2′-bis(4-aminonaphthyl) disulfide; 2,2′-bis(3-aminonaphthyl) disulfide; 2,2′-bis(4-aminonaphthyl) disulfide; 2,2′-bis(5-aminonaphthyl) disulfide; 2,2′-bis(6-aminonaphthyl) disulfide; 2,2′-bis(7-aminonaphthyl) disulfide; 2,2′-bis(8-aminonaphthyl) disulfide; 1,1′-bis(2-aminonaphthyl) disulfide; 1,1′-bis(3-aminonaphthyl) disulfide; 1,1′-bis(3-aminonaphthyl) disulfide; 1,1′-bis(4-aminonaphthyl) disulfide; 1,1′-bis(5-aminonaphthyl) disulfide; 1,1′-bis(6-aminonaphthyl) disulfide; 1,1′-bis(7-aminonaphthyl) disulfide; 1,1′-bis(8-aminonaphthyl) disulfide; 1,2′-diamino-1,2′-dithiodinaphthalene; 2,3′-diamino-1,2′-dithiodinaphthalene; bis(4-chlorophenyl) disulfide; bis(2-chlorophenyl) disulfide; bis(3-chlorophenyl) disulfide; bis(4-bromophenyl) disulfide; bis(2-bromophenyl) disulfide; bis(3-bromophenyl) disulfide; bis(4-fluorophenyl) disulfide; bis(4-iodophenyl) disulfide; bis(2,5-dichlorophenyl) disulfide; bis(3,5-dichlorophenyl) disulfide; bis(2,4-dichlorophenyl) disulfide; bis(2,6-dichlorophenyl) disulfide; bis(2,5-dibromophenyl) disulfide; bis(3,5-dibromophenyl) disulfide; bis(2-chloro-5-bromophenyl) disulfide; bis(2,4,6-trichlorophenyl) disulfide; bis(2,3,4,5,6-pentachlorophenyl) disulfide; bis(4-cyanophenyl) disulfide; bis(2-cyanophenyl) disulfide; bis(4-nitrophenyl) disulfide; bis(2-nitrophenyl) disulfide; 2,2′-dithiobenzoic acid ethylester; 2,2′-dithiobenzoic acid methylester; 2,2′-dithiobenzoic acid; 4,4′-dithiobenzoic acid ethylester; bis(4-acetylphenyl) disulfide; bis(2-acetylphenyl) disulfide; bis(4-formylphenyl) disulfide; bis(4-carbamoylphenyl) disulfide; 1,1′-dinaphthyl disulfide; 2,2′-dinaphthyl disulfide; 1,2′-dinaphthyl disulfide; 2,2′-bis(1-chlorodinaphthyl) disulfide; 2,2′-bis(1-bromonaphthyl) disulfide; 1,1′-bis(2-chloronaphthyl) disulfide; 2,2′-bis(1-cyanonaphthyl) disulfide; 2,2′-bis(1-acetylnaphthyl) disulfide; and the like; and combinations thereof.

Suitable inorganic sulfide compounds include, but are not limited to, titanium sulfide, manganese sulfide, and sulfide analogs of iron, calcium, cobalt, molybdenum, tungsten, copper, selenium, yttrium, zinc, tin, and bismuth.

Suitable Group VIA compounds include, but are not limited to, elemental sulfur and polymeric sulfur, such as those which are commercially available from Elastochem, Inc. of Chardon, Ohio; sulfur catalyst compounds which include PB(RM-S)-80 elemental sulfur and PB(CRST)-65 polymeric sulfur, each of which is available from Elastochem, Inc; tellurium catalysts, such as TELLOY®, and selenium catalysts, such as VANDEX®, each of which is commercially available from RT Vanderbilt Company, Inc.

Suitable substituted and unsubstituted aromatic organic components that do not include sulfur or a metal include, but are not limited to, 4,4′-diphenyl acetylene, azobenzene, and combinations thereof. The aromatic organic group preferably ranges in size from C₆ to C₂₀, and more preferably from C₆ to C₁₀.

Suitable substituted and unsubstituted aromatic organometallic compounds include, but are not limited to, those having the formula (R₁)ₓ—R₃-M-R₄—(R₂)_{y}, wherein R₁ and R₂ are each hydrogen or a substituted or unsubstituted C₁₋₂₀ linear, branched, or cyclic alkyl, alkoxy, or alkylthio group, or a single, multiple, or fused ring C₆ to C₂₄ aromatic group; x and y are each an integer from 0 to 5; R₃ and R₄ are each selected from a single, multiple, or fused ring C₆ to C₂₄ aromatic group; and M includes an azo group or a metal component. Preferably, R₃ and R₄ are each selected from a C₆ to C₁₀ aromatic group, more preferably selected from phenyl, benzyl, naphthyl, benzamido, and benzothiazyl. Preferably R₁ and R₂ are each selected from substituted and unsubstituted C₁₋₁₀ linear, branched, and cyclic alkyl, alkoxy, and alkylthio groups, and C₆ to C₁₀ aromatic groups. When R₁, R₂, R₃, and R₄ are substituted, the substitution may include one or more of the following substituent groups: hydroxy and metal salts thereof; mercapto and metal salts thereof; halogen; amino, nitro, cyano, and amido; carboxyl including esters, acids, and metal salts thereof; silyl; acrylates and metal salts thereof; sulfonyl and sulfonamide; and phosphates and phosphites. When M is a metal component, it may be any suitable elemental metal. The metal is generally a transition metal, and is preferably tellurium or selenium.

Suitable hydroquinones are further disclosed, for example, in U.S. Patent Application Publication No. 2007/0213440, the entire disclosure of which is hereby incorporated herein by reference. Suitable benzoquinones are further disclosed, for example, in U.S. Patent Application Publication No. 2007/0213442, the entire disclosure of which is hereby incorporated herein by reference. Suitable quinhydrones are further disclosed, for example, in U.S. Patent Application Publication No. 2007/0213441, the entire disclosure of which is hereby incorporated herein by reference. Suitable catechols are further disclosed, for example, in U.S. Patent Application Publication No. 2007/0213144, the entire disclosure of which is hereby incorporated herein by reference. Suitable resorcinols are further disclosed, for example, in U.S. Patent Application Publication No. 2007/0213144, the entire disclosure of which is hereby incorporated herein by reference. When the rubber composition includes one or more hydroquinones, benzoquinones, quinhydrones, catechols, resorcinols, or a combination thereof, the total amount of hydroquinone(s), benzoquinone(s), quinhydrone(s), catechol(s), and/or resorcinol(s) present in the composition is typically at least 0.1 parts by weight or at least 0.15 parts by weight or at least 0.2 parts by weight per 100 parts of the base rubber, or an amount within the range having a lower limit of 0.1 parts or 0.15 parts or 0.25 parts or 0.3 parts or 0.375 parts by weight per 100 parts of the base rubber, and an upper limit of 0.5 parts or 1 part or 1.5 parts or 2 parts or 3 parts by weight per 100 parts of the base rubber.

In a particular embodiment, the soft and fast agent is selected from zinc pentachlorothiophenol, pentachlorothiophenol, ditolyl disulfide, diphenyl disulfide, dixylyl disulfide, 2-nitroresorcinol, and combinations thereof.

Suitable types and amounts of base rubber, initiator agent, coagent, filler, and additives are more fully described in, for example, U.S. Pat. Nos. 6,566,483, 6,695,718, 6,939,907, 7,041,721 and 7,138,460, the entire disclosures of which are hereby incorporated herein by reference. Particularly suitable diene rubber compositions are further disclosed, for example, in U.S. Patent Application Publication No. 2007/0093318, the entire disclosure of which is hereby incorporated herein by reference.

### Intermediate Layer(s)

When the golf ball of the present invention includes one or more intermediate layers, i.e., layer(s) disposed between the core and the outer cover of a golf ball, each intermediate layer can include any materials known to those of ordinary skill in the art including thermoplastic and thermosetting materials.

In one embodiment, the present invention provides a golf ball having an intermediate layer formed, at least in part, from a soft and stiff composition of the present invention.

Also suitable for forming intermediate layer(s) are the rubber compositions disclosed above for forming core layer(s), and thermoplastic compositions including, but are not limited to, partially- and fully-neutralized ionomers and blends thereof, including blends of HNPs with partially neutralized ionomers (as disclosed, for example, in U.S. Application Publication No. 2006/0128904), blends of HNPs with additional thermoplastic and thermoset materials (such as acid copolymers, engineering thermoplastics, fatty acid/salt-based HNPs, polybutadienes, polyurethanes, polyureas, polyesters, thermoplastic elastomers, and other conventional polymer materials), and particularly the ionomer compositions disclosed, for example, in U.S. Pat. Nos. 6,653,382, 6,756,436, 6,777,472, 6,894,098, 6,919,393, and 6,953,820. Suitable HNP compositions also include those disclosed, for example, in U.S. Pat. Nos. 6,653,382, 6,756,436, 6,777,472, 6,894,098, 6,919,393, and 6,953,820. The entire disclosure of each of the above references is hereby incorporated herein by reference. Preferred ionomeric compositions have an acid content (prior to neutralization) of from 1 wt % to 30 wt %, or from 5 wt % to 20 wt %.

Also suitable for forming the intermediate layer(s) are graft copolymers of ionomer and polyamide; and the following non-ionomeric polymers, including homopolymers and copolymers thereof, as well as their derivatives that are compatibilized with at least one grafted or copolymerized functional group, such as maleic anhydride, amine, epoxy, isocyanate, hydroxyl, sulfonate, phosphonate, and the like: polyesters, particularly those modified with a compatibilizing group such as sulfonate or phosphonate, including modified poly(ethylene terephthalate), modified poly(butylene terephthalate), modified poly(propylene terephthalate), modified poly(trimethylene terephthalate), modified poly(ethylene naphthenate), and those disclosed in U.S. Pat. Nos. 6,353,050, 6,274,298, and 6,001,930, and blends of two or more thereof; polyamides, polyamide-ethers, and polyamide-esters, and those disclosed in U.S. Pat. Nos. 6,187,864, 6,001,930, and 5,981,654, and blends of two or more thereof; thermosetting and thermoplastic polyurethanes, polyureas, polyurethane-polyurea hybrids, and blends of two or more thereof; fluoropolymers, such as those disclosed in U.S. Pat. Nos. 5,691,066, 6,747,110 and 7,009,002, and blends of two or more thereof; non-ionomeric acid polymers, such as E/Y- and E/X/Y-type copolymers, wherein E is an olefin (e.g., ethylene), Y is a carboxylic acid such as acrylic, methacrylic, crotonic, maleic, fumaric, or itaconic acid, and X is a softening comonomer such as vinyl esters of aliphatic carboxylic acids wherein the acid has from 2 to 10 carbons, alkyl ethers wherein the alkyl group has from 1 to 10 carbons, and alkyl alkylacrylates such as alkyl methacrylates wherein the alkyl group has from 1 to 10 carbons; and blends of two or more thereof; metallocene-catalyzed polymers, such as those disclosed in U.S. Pat. Nos. 6,274,669, 5,919,862, 5,981,654, and 5,703,166, and blends of two or more thereof; polystyrenes, such as poly(styrene-co-maleic anhydride), acrylonitrile-butadiene-styrene, poly(styrene sulfonate), polyethylene styrene, and blends of two or more thereof; polypropylenes and polyethylenes, particularly grafted polypropylene and grafted polyethylenes that are modified with a functional group, such as maleic anhydride of sulfonate, and blends of two or more thereof; polyvinyl chlorides and grafted polyvinyl chlorides, and blends of two or more thereof; polyvinyl acetates, preferably having less than about 9% of vinyl acetate by weight, and blends of two or more thereof; polycarbonates, blends of polycarbonate/acrylonitrile-butadiene-styrene, blends of polycarbonate/polyurethane, blends of polycarbonate/polyester, and blends of two or more thereof; polyvinyl alcohols, and blends of two or more thereof; polyethers, such as polyarylene ethers, polyphenylene oxides, block copolymers of alkenyl aromatics with vinyl aromatics and poly(amic ester)s, and blends of two or more thereof; polyimides, polyetherketones, polyamideimides, and blends of two or more thereof; polycarbonate/polyester copolymers and blends; and combinations of any two or more of the above polymers. Also suitable are the thermoplastic compositions disclosed in U.S. Pat. Nos. 5,919,100, 6,872,774 and 7,074,137. The entire disclosure of each of the above references is hereby incorporated herein by reference.

Examples of suitable commercially available thermoplastics include, but are not limited to, Pebax® thermoplastic polyether block amides, commercially available from Arkema Inc.; Surlyn® ionomer resins, Hytrel® thermoplastic polyester elastomers, and ionomeric materials sold under the trade names DuPont® HPF 1000 and HPF 2000, all of which are commercially available from E. I. du Pont de Nemours and Company; Iotek® ionomers, commercially available from ExxonMobil Chemical Company; Amplify® IO ionomers of ethylene acrylic acid copolymers, commercially available from The Dow Chemical Company; Clarix® ionomer resins, commercially available from A. Schulman Inc.; Elastollan® polyurethane-based thermoplastic elastomers, commercially available from BASF; and Xylex® polycarbonate/polyester blends, commercially available from SABIC Innovative Plastics.

Additional materials suitable for forming the intermediate layer(s) include the core compositions disclosed in U.S. Pat. No. 7,300,364, the entire disclosure of which is hereby incorporated herein by reference. For example, suitable materials include HNPs neutralized with organic fatty acids and salts thereof, metal cations, or a combination of both. In addition to HNPs neutralized with organic fatty acids and salts thereof, core layer compositions may comprise at least one rubber material having a resilience index of at least about 40. Preferably the resilience index is at least about 50. Polymers that produce resilient golf balls and, therefore, are suitable for the present invention, include but are not limited to CB23, CB22, commercially available from LANXESS® Corporation, BR60, commercially available from Enichem, and 1207G, commercially available from Goodyear Corp. Additionally, the unvulcanized rubber, such as polybutadiene, in golf balls prepared according to the invention typically has a Mooney viscosity of between about 40 and about 80, more preferably, between about 45 and about 65, and most preferably, between about 45 and about 55. Mooney viscosity is typically measured according to ASTM-D1646.

Also suitable for forming the intermediate layer(s) are the thermoplastic compositions disclosed herein as suitable for forming cover layers.

In a particular embodiment, the intermediate layer comprises a layer formed from a blend of two or more ionomers. In a particular aspect of this embodiment, the intermediate layer is formed from a 50 wt %/50 wt % blend of two different partially-neutralized ethylene/methacrylic acid copolymers. In another particular aspect of this embodiment, the intermediate layer is formed from a composition comprising a blend of a first high acid ionomer and a second high acid ionomer, wherein the first high acid ionomer is optionally neutralized with a different cation than the second high acid ionomer (e.g., 50 wt %/50 wt % blend of Surlyn® 8150 and Surlyn® 9120, commercially available from E. I. du Pont de Nemours and Company), and wherein the composition optionally includes one or more melt flow modifiers such as an ionomer, ethylene-acid copolymer or ester terpolymer.

In another particular embodiment, the intermediate layer comprises a layer formed from a blend of one or more ionomers and a maleic anhydride-grafted non-ionomeric polymer. In a particular aspect of this embodiment, the non-ionomeric polymer is a metallocene-catalyzed polymer. In another particular aspect of this embodiment, the intermediate layer is formed from a blend of a partially-neutralized ethylene/methacrylic acid copolymer and a maleic anhydride-grafted metallocene-catalyzed polyethylene.

In another particular embodiment, the intermediate layer comprises at least one layer formed from a composition selected from partially- and fully-neutralized ionomers, polyesters, polyamides, polyurethanes, polyureas, polyurethane/polyurea hybrids, fluoropolymers, and blends of two or more thereof. Particularly suitable are the “non-ionomeric compositions comprising a non-ionomeric stiffening polymer and at least one E/Y copolymer or E/X/Y terpolymer” disclosed in U.S. Pat. No. 6,872,774 and the hard, stiff core materials disclosed in U.S. Pat. No. 7,074,137, the entire disclosures of which are hereby incorporated herein by reference.

In yet another particular embodiment, the intermediate layer comprises a layer formed from a composition selected from the group consisting of partially- and fully-neutralized ionomers, and blends of two or more thereof, optionally blended with a maleic anhydride-grafted non-ionomeric polymer; polyester elastomers; polyamide elastomers; and combinations of two or more thereof.

The intermediate layer composition may be treated or admixed with a thermoset diene composition to reduce or prevent flow upon overmolding. Optional treatments may also include the addition of peroxide to the material prior to molding, or a post-molding treatment with, for example, a crosslinking solution, electron beam, gamma radiation, isocyanate or amine solution treatment, or the like. Such treatments may prevent the intermediate layer from melting and flowing or “leaking” out at the mold equator, as a thermoset layer is molded thereon at a temperature necessary to cros slink the layer, which is typically from 280° F. to 360° F. for a period of about 5 to 30 minutes.

Suitable thermoplastic intermediate layer compositions are further disclosed, for example, in U.S. Pat. Nos. 5,919,100, 6,872,774 and 7,074,137, the entire disclosures of which are hereby incorporated herein by reference.

A moisture vapor barrier layer is optionally employed between the core and the cover. Moisture vapor barrier layers are further disclosed, for example, in U.S. Pat. Nos. 6,632,147, 6,838,028, 6,932,720, 7,004,854, and 7,182,702, and U.S. Patent Application Publication Nos. 2003/0069082, 2003/0069085, 2003/0130062, 2004/0147344, 2004/0185963, 2006/0068938, 2006/0128505 and 2007/0129172, the entire disclosures of which are hereby incorporated herein by reference.

### Cover

The outer cover layer may be formed, at least in part, from a soft and stiff composition of the present invention. For example, in one embodiment, the outer cover layer includes about 1 percent to about 100 percent by weight of a soft and stiff compositions of the present invention.

Additional suitable cover materials include, but are not limited to, polyurethanes, polyureas, and hybrids of polyurethane and polyurea; ionomer resins and blends thereof (e.g., Surlyn® ionomer resins and DuPont® HPF 1000 and HPF 2000, commercially available from E. I. du Pont de Nemours and Company; Iotek® ionomers, commercially available from ExxonMobil Chemical Company; Amplify® IO ionomers of ethylene acrylic acid copolymers, commercially available from The Dow Chemical Company; and Clarix® ionomer resins, commercially available from A. Schulman Inc.); polyethylene, including, for example, low density polyethylene, linear low density polyethylene, and high density polyethylene; polypropylene; rubber-toughened olefin polymers; acid copolymers, e.g., ethylene (meth)acrylic acid; plastomers; flexomers; styrene/butadiene/styrene block copolymers; styrene/ethylene-butylene/styrene block copolymers; dynamically vulcanized elastomers; ethylene vinyl acetates; ethylene methyl acrylates; polyvinyl chloride resins; polyamides, amide-ester elastomers, and graft copolymers of ionomer and polyamide, including, for example, Pebax® thermoplastic polyether block amides, commercially available from Arkema Inc; crosslinked trans-polyisoprene and blends thereof; polyester-based thermoplastic elastomers, such as Hytrel®, commercially available from E. I. du Pont de Nemours and Company; polyurethane-based thermoplastic elastomers, such as Elastollan®, commercially available from BASF; synthetic or natural vulcanized rubber; and combinations thereof.

Polyurethanes, polyureas, and polyurethane-polyurea hybrids (i.e., blends and copolymers of polyurethanes and polyureas) are particularly suitable for forming cover layers of the present invention. Suitable polyurethanes are further disclosed, for example, in U.S. Pat. Nos. 5,334,673, 6,506,851, 6,756,436, 6,867,279, 6,960,630, and 7,105,623, the entire disclosures of which are hereby incorporated herein by reference. Suitable polyureas are further disclosed, for example, in U.S. Pat. Nos. 5,484,870 and 6,835,794, and U.S. Patent Application No. 60/401,047, the entire disclosures of which are hereby incorporated herein by reference. Suitable polyurethane-urea cover materials include polyurethane/polyurea blends and copolymers comprising urethane and urea segments, as disclosed in U.S. Patent Application Publication No. 2007/0117923, the entire disclosure of which is hereby incorporated herein by reference.

Compositions comprising an ionomer or a blend of two or more ionomers are also particularly suitable for forming cover layers. Preferred ionomeric cover compositions include:
(a) a composition comprising a “high acid ionomer” (i.e., having an acid content of greater than 16 wt %), such as Surlyn 8150®;
(b) a composition comprising a high acid ionomer and a maleic anhydride-grafted non-ionomeric polymer (e.g., Fusabond® functionalized polymers). A particularly preferred blend of high acid ionomer and maleic anhydride-grafted polymer is a 84 wt %/16 wt % blend of Surlyn 8150® and Fusabond®. Blends of high acid ionomers with maleic anhydride-grafted polymers are further disclosed, for example, in U.S. Pat. Nos. 6,992,135 and 6,677,401, the entire disclosures of which are hereby incorporated herein by reference;
(c) a composition comprising a 50/45/5 blend of Surlyn® 8940/Surlyn® 9650/Nucrel® 960, preferably having a material hardness of from 80 to 85 Shore C;
(d) a composition comprising a 50/25/25 blend of Surlyn® 8940/Surlyn® 9650/Surlyn® 9910, preferably having a material hardness of about 90 Shore C;
(e) a composition comprising a 50/50 blend of Surlyn® 8940/Surlyn® 9650, preferably having a material hardness of about 86 Shore C;
(f) a composition comprising a blend of Surlyn® 7940/Surlyn® 8940, optionally including a melt flow modifier;
(g) a composition comprising a blend of a first high acid ionomer and a second high acid ionomer, wherein the first high acid ionomer is neutralized with a different cation than the second high acid ionomer (e.g., 50/50 blend of Surlyn® 8150 and Surlyn® 9150), optionally including one or more melt flow modifiers such as an ionomer, ethylene-acid copolymer or ester terpolymer; and
(h) a composition comprising a blend of a first high acid ionomer and a second high acid ionomer, wherein the first high acid ionomer is neutralized with a different cation than the second high acid ionomer, and from 0 to 10 wt % of an ethylene/acid/ester ionomer wherein the ethylene/acid/ester ionomer is neutralized with the same cation as either the first high acid ionomer or the second high acid ionomer or a different cation than the first and second high acid ionomers (e.g., a blend of 40-50 wt % Surlyn® 8140, 40-50 wt % Surlyn® 9120, and 0-10 wt % Surlyn® 6320).

Surlyn 8150®, Surlyn® 8940, and Surlyn® 8140 are different grades of E/MAA copolymer in which the acid groups have been partially neutralized with sodium ions. Surlyn® 9650, Surlyn® 9910, Surlyn® 9150, and Surlyn® 9120 are different grades of E/MAA copolymer in which the acid groups have been partially neutralized with zinc ions. Surlyn® 7940 is an E/MAA copolymer in which the acid groups have been partially neutralized with lithium ions. Surlyn® 6320 is a very low modulus magnesium ionomer with a medium acid content. Nucrel® 960 is an E/MAA copolymer resin nominally made with 15 wt % methacrylic acid. Surlyn® ionomers, Fusabond® polymers, and Nucrel® copolymers are commercially available from E. I. du Pont de Nemours and Company.

Ionomeric cover compositions can be blended with non-ionic thermoplastic resins, particularly to manipulate product properties. Examples of suitable non-ionic thermoplastic resins include, but are not limited to, polyurethane, poly-ether-ester, poly-amide-ether, polyether-urea, thermoplastic polyether block amides (e.g., Pebax® block copolymers, commercially available from Arkema Inc.), styrene-butadiene-styrene block copolymers, styrene(ethylene-butylene)-styrene block copolymers, polyamides, polyesters, polyolefins (e.g., polyethylene, polypropylene, ethylene-propylene copolymers, polyethylene-(meth)acrylate, polyethylene-(meth)acrylic acid, functionalized polymers with maleic anhydride grafting, Fusabond® functionalized polymers commercially available from E. I. du Pont de Nemours and Company, functionalized polymers with epoxidation, elastomers (e.g., ethylene propylene diene monomer rubber, metallocene-catalyzed polyolefin) and ground powders of thermoset elastomers.

Ionomer golf ball cover compositions may include a flow modifier, such as, but not limited to, acid copolymer resins (e.g., Nucrel® acid copolymer resins, and particularly Nucrel® 960, commercially available from E. I. du Pont de Nemours and Company), performance additives (e.g., A-C® performance additives, particularly A-C® low molecular weight ionomers and copolymers, A-C® oxidized polyethylenes, and A-C® ethylene vinyl acetate waxes, commercially available from Honeywell International Inc.), fatty acid amides (e.g., ethylene bis-stearamide and ethylene bis-oleamide), fatty acids and salts thereof.

Suitable ionomeric cover materials are further disclosed, for example, in U.S. Pat. Nos. 6,653,382, 6,756,436, 6,894,098, 6,919,393, and 6,953,820, the entire disclosures of which are hereby incorporated by reference.

Cover compositions may include one or more filler(s), such as the fillers given above for rubber compositions of the present invention (e.g., titanium dioxide, barium sulfate, etc.), and/or additive(s), such as coloring agents, fluorescent agents, whitening agents, antioxidants, dispersants, UV absorbers, light stabilizers, plasticizers, surfactants, compatibility agents, foaming agents, reinforcing agents, release agents, and the like.

In a particular embodiment, the cover is a single layer formed from a fully aliphatic polyurea. In another particular embodiment, the cover is a single layer formed from a polyurea composition, preferably selected from those disclosed in U.S. Patent Application Publication No. 2009/0011868, the entire disclosure of which is hereby incorporated herein by reference.

Suitable cover materials and constructions also include, but are not limited to, those disclosed in U.S. Patent Application Publication No. 2005/0164810, U.S. Pat. Nos. 5,919,100, 6,117,025, 6,767,940, and 6,960,630, and PCT Publications WO00/23519 and WO00/29129, the entire disclosures of which are hereby incorporated herein by reference.

The cover may also be at least partially formed from a rubber composition discussed above as suitable for forming core layers.

### Construction

As stated above, soft and stiff compositions of the present invention may be used with any type of ball construction including, but not limited to, one-piece, two-piece, and multi-layer designs, as a core composition, intermediate layer composition, or cover composition, depending on the type of performance desired of the ball.

In a particular embodiment, the present invention is directed to a golf ball comprising a core and a single cover layer, wherein the single cover layer is formed from a soft and stiff composition disclosed herein. In a particular aspect of this embodiment, the single cover layer has a thickness of from 0.020 inches to 0.150 inches. In another particular aspect of this embodiment, the core is a solid, thermoset rubber core, preferably having a center hardness within a range having a lower limit of 65 or 68 Shore C and an upper limit of 77 or 80 Shore C, and preferably having a surface hardness within a range having a lower limit of 60 or 66 Shore C and an upper limit of 75 or 89 Shore C.

In another particular embodiment, the present invention is directed to a golf ball comprising a core and a cover, wherein the cover comprises an inner cover layer and an outer cover layer. In a particular aspect of this embodiment, the outer cover layer is formed from a soft and stiff composition disclosed herein, and the outer cover layer preferably has a hardness greater than that of the inner cover layer. In a particular aspect of this embodiment, the outer cover layer is formed from a soft and stiff composition disclosed herein, and the outer cover layer preferably has a hardness less than that of the inner cover layer. In another particular aspect of this embodiment, the inner cover layer is formed from a soft and stiff composition disclosed herein, and the inner cover layer preferably has a hardness greater than that of the outer cover layer. In another particular aspect of this embodiment, the inner cover layer is formed from a soft and stiff composition disclosed herein, and the inner cover layer preferably has a hardness less than that of the outer cover layer.

In another particular embodiment, the present invention is directed to a golf ball comprising a core and a cover, wherein the cover comprises an inner cover layer, an outer cover layer, and an intermediate cover layer disposed between the inner and outer cover layers. In a particular aspect of this embodiment, the intermediate cover layer is formed from a soft and stiff composition disclosed herein.

In another particular embodiment, the present invention is directed to a golf ball comprising a core and a cover, wherein the cover comprises a first layer formed from a first soft and stiff composition and a second layer formed from a second soft and stiff composition, and wherein the first and second soft and stiff compositions have different hardnesses.

In another particular embodiment, the present invention is directed to a golf ball comprising a core and a cover, wherein the core comprises a layer formed from a soft and stiff composition disclosed herein. In a particular aspect of this embodiment, the core comprises an inner core layer, an outer core layer, and an intermediate core layer disposed between the inner and outer core layers, wherein at least one of the inner core layer, intermediate core layer, and outer core layer is formed from a soft and stiff composition disclosed herein. In another particular aspect of this embodiment, the core comprises an inner core layer, an outer core layer, and an intermediate core layer disposed between the inner and outer core layers, wherein the inner core layer and the outer core layer are formed from the same or different thermoset rubber compositions, preferably selected from diene rubbers, and wherein the intermediate core layer is formed from a soft and stiff composition disclosed herein.

Non-limiting examples of suitable types of ball constructions that may be used with the present invention include those described in U.S. Pat. Nos. 6,056,842, 5,688,191, 5,713,801, 5,803,831, 5,885,172, 5,919,100, 5,965,669, 5,981,654, 5,981,658, and 6,149,535, as well as in U.S. Patent Publication Nos. 2001/0009310, 2002/0025862, and 2002/0028885. The entire disclosures of which are hereby incorporated herein by reference.

The present invention is not limited by any particular process for forming the golf ball layer(s). It should be understood that the layer(s) can be formed by any suitable technique, including injection molding, compression molding, casting, and reaction injection molding.

Thermoplastic layers herein may be treated in such a manner as to create a positive or negative hardness gradient. In golf ball layers of the present invention wherein a thermosetting rubber is used, gradient-producing processes and/or gradient-producing rubber formulation may be employed. Gradient-producing processes and formulations are disclosed more fully, for example, in U.S. patent application Ser. Nos. 12/048,665, filed on Mar. 14, 2008; 11/829,461, filed on Jul. 27, 2007; 11/772,903, filed Jul. 3, 2007; 11/832,163, filed Aug. 1, 2007; 11/832,197, filed on Aug. 1, 2007; the entire disclosure of each of these references is hereby incorporated herein by reference.

### Dimples

The use of various dimple patterns and profiles provides a relatively effective way to modify the aerodynamic characteristics of a golf ball. As such, the manner in which the dimples are arranged on the surface of the ball can be by any available method. Golf balls of the present invention typically have dimple coverage of 60% or greater, or 65% or greater, or 75% or greater, or 80% or greater, or 85% or greater.

### Golf Ball Post-Processing

The golf balls of the present invention may be painted, coated, or surface treated for further benefits.

For example, golf balls covers frequently contain a fluorescent material and/or a dye or pigment to achieve the desired color characteristics. A golf ball of the invention may also be treated with a base resin paint composition. In addition, the golf ball may be coated with a composition including a whitening agent. For example, U.S. Patent Application Publication No. 2002/0082358, the entire disclosure of which is hereby incorporated herein by reference, uses a derivative of 7-triazinylamino-3-phenylcoumarin as a fluorescent whitening agent to provide improved weather resistance and brightness.

In one embodiment, golf balls of the present invention are UV cured. Suitable methods for UV curing are disclosed in U.S. Pat. Nos. 6,500,495, 6,248,804, and 6,099,415, the entire disclosures of which are hereby incorporated herein by reference. In one embodiment, the top coat is UV curable. In another embodiment, the ink is UV curable and may be used as a paint layer or as a discrete marking tool for logos and indicias.

In addition, trademarks or other indicia may be stamped, i.e., pad-printed, on the outer surface of the ball cover, and the stamped outer surface is then treated with at least one clear coat to give the ball a glossy finish and protect the indicia stamped on the cover.

Golf balls of the present invention may also be subjected to dye sublimation, wherein at least one golf ball component is subjected to at least one sublimating ink that migrates at a depth into the outer surface and forms an indicia. The at least one sublimating ink preferably includes at least one of an azo dye, a nitroarylamine dye, or an anthraquinone dye. U.S. Pat. No. 6,935,240, the entire disclosure of which is hereby incorporated herein by reference.

Laser marking of a selected surface portion of a golf ball causing the laser light-irradiated portion to change color is also contemplated for use with the present invention. U.S. Pat. Nos. 5,248,878 and 6,075,223 generally disclose such methods, the entire disclosures of which are hereby incorporated herein by reference. In addition, the golf balls may be subjected to ablation, i.e., directing a beam of laser radiation onto a portion of the cover, irradiating the cover portion, wherein the irradiated cover portion is ablated to form a detectable mark, wherein no significant discoloration of the cover portion results therefrom. Ablation is discussed in U.S. Pat. No. 6,462,303, the entire disclosure of which is hereby incorporated herein by reference.

Protective and decorative coating materials, as well as methods of applying such materials to the surface of a golf ball cover are well known in the golf ball art. Generally, such coating materials comprise urethanes, urethane hybrids, epoxies, polyesters and acrylics. If desired, more than one coating layer can be used. The coating layer(s) may be applied by any suitable method known to those of ordinary skill in the art. In one embodiment, the coating layer(s) is applied to the golf ball cover by an in-mold coating process, such as described in U.S. Pat. No. 5,849,168, the entire disclosure of which is hereby incorporated herein by reference.

The use of the saturated polyurea and polyurethane compositions in golf equipment obviates the need for typical post-processing, e.g., coating a golf ball with a pigmented coating prior to applying a clear topcoat to the ball. Unlike compositions with no light stable properties, the compositions used in forming the golf equipment of the present invention do not discolor upon exposure to light (especially in the case of extended exposure). Also, by eliminating at least one coating step, the manufacturer realizes economic benefits in terms of reduced process times and consequent improved labor efficiency. Further, significant reduction in volatile organic compounds (“VOCs”), typical constituents of paint, may be realized through the use of the present invention, offering significant environmental benefits.

Thus, while it is not necessary to use pigmented coating on the golf balls of the present invention when formed with the saturated compositions, the golf balls of the present invention may be painted, coated, or surface treated for further benefits. For example, the value of golf balls made according to the invention and painted offer enhanced color stability as degradation of the surface paint occurs during the normal course of play. The mainstream technique used nowadays for highlighting whiteness is to form a cover toned white with titanium dioxide, subjecting the cover to such surface treatment as corona treatment, plasma treatment, UV treatment, flame treatment, or electron beam treatment, and applying one or more layers of clear paint, which may contain a fluorescent whitening agent. This technique is productive and cost effective.

### Golf Ball Properties

The properties such as hardness, modulus, core diameter, intermediate layer thickness and cover layer thickness of the golf balls of the present invention have been found to effect play characteristics such as spin, initial velocity and feel of the present golf balls. For example, the flexural and/or tensile modulus of the intermediate layer are believed to have an effect on the “feel” of the golf balls of the present invention. It should be understood that the ranges herein are meant to be intermixed with each other, i.e., the low end of one range may be combined with a high end of another range.

### Component Dimensions

Dimensions of golf ball components, i.e., thickness and diameter, may vary depending on the desired properties. For the purposes of the invention, any layer thickness may be employed. Non-limiting examples of the various embodiments outlined above are provided here with respect to layer dimensions.

The present invention relates to golf balls of any size. While USGA specifications limit the size of a competition golf ball to more than 1.68 inches in diameter, golf balls of any size can be used for leisure golf play. The preferred diameter of the golf balls is from about 1.68 inches to about 1.8 inches. The more preferred diameter is from about 1.68 inches to about 1.76 inches. A diameter of from about 1.68 inches to about 1.74 inches is most preferred, however diameters anywhere in the range of from 1.7 to about 1.95 inches can be used. Preferably, the overall diameter of the core and all intermediate layers is about 80 percent to about 98 percent of the overall diameter of the finished ball.

The core typically has a diameter ranging from 0.09 inches to 1.65 inches. In one embodiment, the diameter of the core of the present invention is within a range having a lower limit of 1.20 or 1.30 or 1.50 or 1.53 or 1.55 inches and an upper limit of 1.55 or 1.60 or 1.63 or 1.65 inches.

The core of the golf ball may be extremely large in relation to the rest of the ball. For example, in one embodiment, the core makes up about 90 percent to about 98 percent of the ball, preferably about 94 percent to about 96 percent of the ball. In this embodiment, the diameter of the core is within a range having a lower limit of 1.54 or 1.55 or 1.59 inches and an upper limit of 1.64 inches.

When the core includes an inner core layer and an outer core layer, the inner core layer is preferably 0.9 inches or greater and the outer core layer preferably has a thickness of 0.1 inches or greater. In a particular embodiment, the inner core layer has a diameter within a range having a lower limit of 0.090 or 0.095 inches and an upper limit of 1.10 or 1.20 inches, and the outer core layer has a thickness within a range having a lower limit of 0.10 or 0.20 inches and an upper limit of 0.30 or 0.5 or 0.8 inches.

The cover typically has a thickness to provide sufficient strength, good performance characteristics, and durability. In a particular embodiment, the cover thickness is within a range having a lower limit of 0.020 or 0.025 or 0.030 inches and an upper limit of 0.030 or 0.040 or 0.045 or 0.050 or 0.070 or 0.100 or 0.120 or 0.350 or 0.400 or inches.

The range of thicknesses for an intermediate layer of a golf ball is large because of the vast possibilities when using an intermediate layer, i.e., as an inner cover layer, a wound layer, a moisture/vapor barrier layer, etc. When used in a golf ball of the present invention, the intermediate layer typically has a thickness about 0.3 inches or less. In a particular embodiment, the thickness of the intermediate layer is within a range having a lower limit of 0.002 or 0.010 or 0.020 or 0.025 or 0.030 inches and an upper limit of 0.035 or 0.040 or 0.045 or 0.050 or 0.060 or 0.090 or 0.100 inches

The ratio of the thickness of the intermediate layer to the outer cover layer is preferably about 10 or less, preferably from about 3 or less. In another embodiment, the ratio of the thickness of the intermediate layer to the outer cover layer is about 1 or less.

The core and intermediate layer(s) together form an inner ball preferably having a diameter of about 1.48 inches or greater for a 1.68-inch ball. In one embodiment, the inner ball of a 1.68-inch ball has a diameter of about 1.52 inches or greater. In another embodiment, the inner ball of a 1.68-inch ball has a diameter of about 1.66 inches or less. In yet another embodiment, a 1.72-inch (or more) ball has an inner ball diameter of about 1.50 inches or greater. In still another embodiment, the diameter of the inner ball for a 1.72-inch ball is about 1.70 inches or less.

### Hardness

The cores of the present invention may have varying hardnesses depending on the particular golf ball construction. In one embodiment, the core hardness is at least about 15 Shore A, preferably about 30 Shore A, as measured on a formed sphere. In another embodiment, the core has a hardness of about 50 Shore A to about 90 Shore D. In yet another embodiment, the hardness of the core is about 80 Shore D or less. Preferably, the core has a hardness about 30 to about 65 Shore D, and more preferably, the core has a hardness about 35 to about 60 Shore D.

The intermediate layer(s) of the present invention may also vary in hardness depending on the specific construction of the ball. In one embodiment, the hardness of the intermediate layer is about 30 Shore D or greater. In another embodiment, the hardness of the intermediate layer is about 90 Shore D or less, preferably about 80 Shore D or less, and more preferably about 70 Shore D or less. In yet another embodiment, the hardness of the intermediate layer is about 50 Shore D or greater, preferably about 55 Shore D or greater. In one embodiment, the intermediate layer hardness is from about 55 Shore D to about 65 Shore D. The intermediate layer may also be about 65 Shore D or greater.

When the intermediate layer is intended to be harder than the core layer, the ratio of the intermediate layer hardness to the core hardness preferably about 2 or less. In one embodiment, the ratio is about 1.8 or less. In yet another embodiment, the ratio is about 1.3 or less.

As with the core and intermediate layers, the cover hardness may vary depending on the construction and desired characteristics of the golf ball. The ratio of cover hardness to inner ball hardness is a primary variable used to control the aerodynamics of a ball and, in particular, the spin of a ball. In general, the harder the inner ball, the greater the driver spin and the softer the cover, the greater the driver spin.

For example, when the intermediate layer is intended to be the hardest point in the ball, e.g., about 50 Shore D to about 75 Shore D, the cover material may have a hardness of about 20 Shore D or greater, preferably about 25 Shore D or greater, and more preferably about 30 Shore D or greater, as measured on the slab. In another embodiment, the cover itself has a hardness of about 30 Shore D or greater. In particular, the cover may be from about 30 Shore D to about 70 Shore D. In one embodiment, the cover has a hardness of about 40 Shore D to about 65 Shore D, and in another embodiment, about 40 Shore to about 55 Shore D. In another aspect of the invention, the cover has a hardness less than about 45 Shore D, preferably less than about 40 Shore D, and more preferably about 25 Shore D to about 40 Shore D. In one embodiment, the cover has a hardness from about 30 Shore D to about 40 Shore D.

In this embodiment when the outer cover layer is softer than the intermediate layer or inner cover layer, the ratio of the Shore D hardness of the outer cover material to the intermediate layer material is about 0.8 or less, preferably about 0.75 or less, and more preferably about 0.7 or less. In another embodiment, the ratio is about 0.5 or less, preferably about 0.45 or less.

In yet another embodiment, the ratio is about 0.1 or less when the cover and intermediate layer materials have hardnesses that are substantially the same. When the hardness differential between the cover layer and the intermediate layer is not intended to be as significant, the cover may have a hardness of about 55 Shore D to about 65 Shore D. In this embodiment, the ratio of the Shore D hardness of the outer cover to the intermediate layer is about 1.0 or less, preferably about 0.9 or less.

The cover hardness may also be defined in terms of Shore C. For example, the cover may have a hardness of about 70 Shore C or greater, preferably about 80 Shore C or greater. In another embodiment, the cover has a hardness of about 95 Shore C or less, preferably about 90 Shore C or less.

In another embodiment, the cover layer is harder than the intermediate layer. In this design, the ratio of Shore D hardness of the cover layer to the intermediate layer is about 1.33 or less, preferably from about 1.14 or less.

When a two-piece ball is constructed, the core may be softer than the outer cover. For example, the core hardness may range from about 30 Shore D to about 50 Shore D, and the cover hardness may be from about 50 Shore D to about 80 Shore D. In this type of construction, the ratio between the cover hardness and the core hardness is preferably about 1.75 or less. In another embodiment, the ratio is about 1.55 or less. Depending on the materials, for example, if a composition of the invention is acid-functionalized wherein the acid groups are at least partially neutralized, the hardness ratio of the cover to core is preferably about 1.25 or less.

### Initial Velocity and COR

There is currently no USGA limit on the COR of a golf ball, but the initial velocity of the golf ball cannot exceed 250±5 feet/second (ft/s). Thus, in one embodiment, the initial velocity is about 245 ft/s or greater and about 255 ft/s or greater. In another embodiment, the initial velocity is about 250 ft/s or greater. In one embodiment, the initial velocity is about 253 ft/s to about 254 ft/s. In yet another embodiment, the initial velocity is about 255 ft/s. While the current rules on initial velocity require that golf ball manufacturers stay within the limit, one of ordinary skill in the art would appreciate that the golf ball of the invention would readily convert into a golf ball with initial velocity outside of this range.

As a result, of the initial velocity limitation set forth by the USGA, the goal is to maximize COR without violating the 255 ft/s limit. The COR of a ball is measured by taking the ratio of the outbound or rebound velocity to the incoming or inbound velocity. In a one-piece solid golf ball, the COR will depend on a variety of characteristics of the ball, including its composition and hardness. For a given composition, COR will generally increase as hardness is increased. In a two-piece solid golf ball, e.g., a core and a cover, one of the purposes of the cover is to produce a gain in COR over that of the core. When the contribution of the core to high COR is substantial, a lesser contribution is required from the cover. Similarly, when the cover contributes substantially to high COR of the ball, a lesser contribution is needed from the core.

The present invention contemplates golf balls having CORs from about 0.700 to about 0.850 at an inbound velocity of about 125 ft/sec. In one embodiment, the COR is about 0.750 or greater, preferably about 0.780 or greater. In another embodiment, the ball has a COR of about 0.800 or greater. In yet another embodiment, the COR of the balls of the invention is about 0.800 to about 0.815.

In addition, the inner ball preferably has a COR of about 0.780 or more. In one embodiment, the COR is about 0.790 or greater.

### Spin Rate

As known to those of ordinary skill in the art, the spin rate of a golf ball will vary depending on the golf ball construction. In a multilayer ball, e.g., a core, an intermediate layer, and a cover, wherein the cover is formed from the polyurea or polyurethane compositions of the invention, the spin rate of the ball off a driver (“driver spin rate”) is preferably about 2700 rpm or greater. In one embodiment, the driver spin rate is about 2800 rpm to about 3500 rpm. In another embodiment, the driver spin rate is about 2900 rpm to about 3400 rpm. In still another embodiment, the driver spin rate may be less than about 2700 rpm.

Two-piece balls made according to the invention may also have driver spin rates of 2700 rpm and greater. In one embodiment, the driver spin rate is about 2700 rpm to about 3300 rpm. Wound balls made according to the invention may have similar spin rates.

Methods of determining the spin rate should be well understood by those of ordinary skill in the art. Examples of methods for determining the spin rate are disclosed in U.S. Pat. Nos. 6,500,073, 6,488,591, 6,286,364, and 6,241,622, which are incorporated by reference herein in their entirety.

### EXAMPLES

It should be understood that the examples below are for illustrative purposes only. In no manner is the present invention limited to the specific disclosures therein.

Various compositions were melt blended using components as given in Table 1 below. The relative amounts of each component used are also indicated in Table 1 below, and are reported in wt %, based on the total weight of the composition, unless otherwise indicated.

Flex modulus of each composition was measured according to the following procedure, and the results are reported in Table 1 below. Flex bars are prepared by compression molding the composition under sufficient temperature and pressure for a sufficient amount of time to produce void- and defect-free plaques of appropriate dimensions to produce the required flex bars. The flex bar dimensions are about 0.125 inches by about 0.5 inches, and of a length sufficient to satisfy the test requirements. Flex bars are died out from the compression molded plaque(s) soon after the blend composition has reached room temperature. The flex bars are then aged for 14 days at 23° C. and 50% RH before testing. Flex modulus is then measured according to ASTM D790-03 Procedure B, using a load span of 1.0 inches, a support span length of 2.0 inches, a support span-to-depth ratio of 16:1 and a crosshead rate of 0.5 inches/minute. The support and loading noses are a radius of 5 mm.

Hardness of each composition was measured according to the following procedure, and the results are reported in Table 1 below. Hardness buttons are compression molded under sufficient temperature and pressure for a sufficient amount of time to produce void- and defect-free parts. The buttons are surface ground soon after the part reaches room temperature after demolding, to produce smooth, flat and parallel surfaces. The finished buttons are approximately 1.25 inches in diameter and at least 6 mm in thickness. The buttons are then aged for 10 days at 23° C. in a dessicator before testing. ASTM D2240 Shore D and JIS C (K6301 Type) measurements are made using a digital durometer set to peak mode, and an automatic loading stand which is properly mounted and calibrated. The automatic stand has a travel speed of approximately 25 mm/sec.

Melt flow of each composition was measured according to ASTM D-1238, condition E, at 190° C., using a 2.16 kg or 5 kg weight (as indicated), and the results are reported in Table 2 below.

TABLE 1

| | | | | | | | | | | | Flex |
|---|---|---|---|---|---|---|---|---|---|---|---|
| | | | | | | | | | JIS-C | Shore D | Mod |
| Ex. | Component 1 | wt % | Component 2 | wt % | Component 3 | wt % | Component 4 | Component 5 | Hardness | Hardness | (ksi) |
| 1 | Surlyn | 90 | Akroflock | 10 | | | | | * | * | * |
| | 9945 | | CDV-2 | | | | | | | | |
| 2 | Surlyn | 90 | Akroflock | 10 | | | | | * | * | 62.3 |
| | 9945 | | ND-109 | | | | | | | | |
| 3 | Surlyn | 60 | Amplify | 20 | Fusabond | 20 | | | 87.0 | 57.3 | 50.8 |
| | 9945 | | GR204 | | 525D | | | | | | |
| 4 | Surlyn | 60 | Amplify | 30 | Fusabond | 10 | | | * | * | * |
| | 9945 | | GR204 | | 525D | | | | | | |
| 5 | Surlyn | 56.7 | Amplify | 28.3 | Fusabond | 15 | | | * | * | * |
| | 9945 | | GR204 | | 525D | | | | | | |
| 6 | Surlyn | 53 | Amplify | 27 | Fusabond | 20 | | | * | * | * |
| | 9945 | | GR204 | | 525D | | | | | | |
| 7 | Surlyn | 37.5 | Amplify | 37.5 | Fusabond | 25 | | | * | * | * |
| | 9945 | | GR204 | | 525D | | | | | | |
| 8 | Surlyn | 35 | Amplify | 35 | Fusabond | 30 | | | * | * | * |
| | 9945 | | GR204 | | 525D | | | | | | |
| 9 | Surlyn | 32.5 | Amplify | 32.5 | Fusabond | 35 | | | * | * | * |
| | 9945 | | GR204 | | 525D | | | | | | |
| 10 | Surlyn | 75 | Amplify | 25 | | | | | * | * | * |
| | 9945 | | GR204 | | | | | | | | |
| 11 | Surlyn | 40 | Amplify | 40 | Fusabond | 20 | | | 89.1 | 60.4 | 61.6 |
| | 9945 | | GR205 | | 525D | | | | | | |
| 12 | Surlyn | 42.5 | Amplify | 42.5 | Fusabond | 15 | | | 91.2 | 62.1 | 66.2 |
| | 9945 | | GR205 | | 525D | | | | | | |
| 13 | Surlyn | 45 | Amplify | 45 | Fusabond | 10 | | | 91.6 | 63.1 | 79.7 |
| | 9945 | | GR205 | | 525D | | | | | | |
| 14 | Surlyn | 60 | Amplify | 20 | Fusabond | 20 | | | 87.8 | 59.2 | 48.3 |
| | 9945 | | GR205 | | 525D | | | | | | |
| 15 | Surlyn | 63.75 | Amplify | 21.25 | Fusabond | 15 | | | 89.7 | 61.8 | 58.4 |
| | 9945 | | GR205 | | 525D | | | | | | |
| 16 | Surlyn | 67.5 | Amplify | 22.5 | Fusabond | 10 | | | 90.7 | 62.2 | 62.8 |
| | 9945 | | GR205 | | 525D | | | | | | |
| 17 | Surlyn | 60 | Amplify | 20 | Fusabond | 20 | | | * | * | 44.2 |
| | 9945 | | GR205 | | 525D | | | | | | |
| 18 | Surlyn | 50 | Amplify | 50 | | | | | 93.1 | 65.7 | 105.5 |
| | 9945 | | GR205 | | | | | | | | |
| 19 | Surlyn | 75 | Amplify | 25 | | | | | 93.1 | 65.3 | 75.3 |
| | 9945 | | GR205 | | | | | | | | |
| 20 | Surlyn | 50 | Amplify | 50 | | | | | * | * | 119.0 |
| | 9945 | | GR205 | | | | | | | | |
| 21 | Surlyn | 70 | Amplify | 30 | | | | | 85.8 | 58.1 | 34.7 |
| | 8150 | | GR216 | | | | | | | | |
| 22 | Surlyn | 75 | Amplify | 25 | | | | | 87.2 | 59.5 | 37.4 |
| | 8150 | | GR216 | | | | | | | | |
| 23 | Surlyn | 80 | Amplify | 20 | | | | | 89.4 | 62.7 | 44.8 |
| | 8150 | | GR216 | | | | | | | | |
| 24 | Clarix | 85 | Carbon | 15 | | | | | 87.5 | 59.9 | * |
| | 011370-01 | | Black | | | | | | | | |
| 25 | Surlyn | 54 | Clarix | 46 | | | | | 88.4 | 61.8 | * |
| | 9910 | | 011370-01 | | | | | | | | |
| 26 | Surlyn | 54 | Clarix | 46 | Carbon | 8 | | | 90.2 | 63.8 | * |
| | 9910 | | 011370-01 | | Black | pph | | | | | |
| 27 | Surlyn | 54 | Clarix | 46 | Carbon | 4 | | | 90.4 | 64.0 | * |
| | 9910 | | 011370-01 | | Black | pph | | | | | |
| 28 | Clarix | 45 | Clarix | 45 | Fusabond | 10 | | | 92.4 | 64.2 | 55.8 |
| | 111704-01 | | 211702-01 | | 525D | | | | | | |
| 29 | Clarix | 42.5 | Clarix | 42.5 | Fusabond | 15 | | | 92.5 | 65.8 | 57.1 |
| | 111704-01 | | 211702-01 | | 525D | | | | | | |
| 30 | Clarix | 40 | Clarix | 40 | Fusabond | 20 | | | 91.5 | 64.5 | 49.6 |
| | 111704-01 | | 211702-01 | | 525D | | | | | | |
| 31 | Clarix | 50 | Clarix | 50 | | | | | 94.9 | 68.7 | 74.3 |
| | 111704-01 | | 211702-01 | | | | | | | | |
| 32 | Clarix | 45 | Clarix 5152 | 45 | Fusabond | 10 | | | 88.8 | 60.6 | 42.8 |
| | 2155 | | | | 525D | | | | | | |
| 33 | Clarix | 42.5 | Clarix 5152 | 42.5 | Fusabond | 15 | | | 88.5 | 60.6 | 40.3 |
| | 2155 | | | | 525D | | | | | | |
| 34 | Clarix | 40 | Clarix 5152 | 40 | Fusabond | 20 | | | 86.2 | 59.7 | 32.4 |
| | 2155 | | | | 525D | | | | | | |
| 35 | Clarix | 50 | Clarix 5152 | 50 | | | | | 91.0 | 64.6 | 51.9 |
| | 2155 | | | | | | | | | | |
| 36 | Surlyn | 97 | Cloisite | 3 | | | | | 91.0 | 63.8 | 75.3 |
| | 9650 | | 20A | | | | | | | | |
| 37 | Surlyn | 94 | Cloisite | 6 | | | | | 91.7 | 65.3 | 85.9 |
| | 9650 | | 20A | | | | | | | | |
| 38 | Surlyn | 91 | Cloisite | 9 | | | | | 92.2 | 65.9 | 97.3 |
| | 9650 | | 20A | | | | | | | | |
| 39 | Surlyn | 88 | Cloisite | 12 | | | | | 92.5 | 66.3 | 111.0 |
| | 9650 | | 20A | | | | | | | | |
| 40 | Surlyn | 75 | Cloisite | 25 | | | | | * | * | * |
| | 8320 | | 20A | | | | | | | | |
| 41 | Surlyn | 91 | Cloisite | 9 | | | | | * | * | * |
| | 9650 | | 20A | | | | | | | | |
| 42 | Surlyn | 88 | Cloisite | 12 | | | | | * | * | * |
| | 9650 | | 20A | | | | | | | | |
| 43 | Surlyn | 90 | Fusabond | 10 | | | | | 87.0 | 59.2 | 35.8 |
| | 9650 | | 525D | | | | | | | | |
| 44 | Surlyn | 79.5 | Fusabond | 17.5 | Cloisite | 3 | | | 87.1 | 57.4 | 46.5 |
| | 9650 | | 525D | | 20A | | | | | | |
| 45 | Surlyn | 77.1 | Fusabond | 16.9 | Cloisite | 6 | | | 87.8 | 58.6 | 48.9 |
| | 9650 | | 525D | | 20A | | | | | | |
| 46 | Surlyn | 74.6 | Fusabond | 16.4 | Cloisite | 9 | | | 88.4 | 59.4 | 60.1 |
| | 9650 | | 525D | | 20A | | | | | | |
| 47 | Surlyn | 72.2 | Fusabond | 15.8 | Cloisite | 12 | | | 88.9 | 59.9 | 72.6 |
| | 9650 | | 525D | | 20A | | | | | | |
| 48 | Surlyn | 74.6 | Fusabond | 16.4 | Cloisite | 9 | | | * | * | * |
| | 9650 | | 525D | | 20A | | | | | | |
| 49 | Surlyn | 72.2 | Fusabond | 15.8 | Cloisite | 12 | | | * | * | * |
| | 9650 | | 525D | | 20A | | | | | | |
| 50 | Surlyn | 69.6 | Fusabond | 24.4 | Cloisite | 6 | | | * | * | * |
| | 9650 | | 525D | | 20A | | | | | | |
| 51 | Surlyn | 67.3 | Fusabond | 23.7 | Cloisite | 9 | | | * | * | * |
| | 9650 | | 525D | | 20A | | | | | | |
| 52 | Surlyn | 65.1 | Fusabond | 22.9 | Cloisite | 12 | | | * | * | * |
| | 9650 | | 525D | | 20A | | | | | | |
| 53 | Surlyn | 62.9 | Fusabond | 22.1 | Cloisite | 15 | | | * | * | * |
| | 9650 | | 525D | | 20A | | | | | | |
| 54 | Surlyn | 61.6 | Fusabond | 26.4 | Cloisite | 12 | | | 91.6 | 64.9 | 73.5 |
| | 8150 | | 525D | | 30B | | | | | | |
| 55 | Surlyn | 63.7 | Fusabond | 27.3 | Cloisite | 9 | | | 90.8 | 63.9 | 66.8 |
| | 8150 | | 525D | | 30B | | | | | | |
| 56 | Surlyn | 65.8 | Fusabond | 28.2 | Cloisite | 6 | | | 89.1 | 62.2 | 52.4 |
| | 8150 | | 525D | | 30B | | | | | | |
| 57 | Surlyn | 67.9 | Fusabond | 29.1 | Cloisite | 3 | | | 88.0 | 60.5 | 41.5 |
| | 8150 | | 525D | | 30B | | | | | | |
| 58 | Surlyn | 69 | Fusabond | 22 | Glass Flake | 9 | | | 89.3 | 62.4 | 60.6 |
| | 8150 | | 525D | | | | | | | | |
| 59 | Surlyn | 69 | Fusabond | 22 | Milled | 9 | | | 89.0 | 62.3 | 69.9 |
| | 8150 | | 525D | | Glass | | | | | | |
| 60 | Amplify | 57 | Fusabond | 38 | Surlyn | 5 | | | * | * | * |
| | GR205 | | 525D | | 9910 | | | | | | |
| 61 | Amplify | 66.5 | Fusabond | 28.5 | Surlyn | 5 | | | * | * | * |
| | GR205 | | 525D | | 9910 | | | | | | |
| 62 | Amplify | 47.5 | Fusabond | 47.5 | Surlyn | 5 | | | * | * | * |
| | GR205 | | 525D | | 9910 | | | | | | |
| 63 | Amplify | 37 | Fusabond | 58 | Surlyn | 5 | | | * | * | * |
| | GR205 | | 525D | | 9910 | | | | | | |
| 64 | Surlyn | 69.6 | Fusabond | 24.4 | Luzenac | 6 | | | * | * | * |
| | 9650 | | 525D | | HAR T-84 | | | | | | |
| | | | | | Talc | | | | | | |
| 65 | Surlyn | 67.3 | Fusabond | 23.7 | Luzenac | 9 | | | * | * | * |
| | 9650 | | 525D | | HAR T-84 | | | | | | |
| | | | | | Talc | | | | | | |
| 66 | Surlyn | 65.1 | Fusabond | 22.9 | Luzenac | 12 | | | * | * | * |
| | 9650 | | 525D | | HAR T-84 | | | | | | |
| | | | | | Talc | | | | | | |
| 67 | Surlyn | 62.9 | Fusabond | 22.1 | Luzenac | 15 | | | * | * | * |
| | 9650 | | 525D | | HAR T-84 | | | | | | |
| | | | | | Talc | | | | | | |
| 68 | Surlyn | 76 | Fusabond | 24 | | | | | 88.5 | 60.7 | * |
| | 8150 | | 525D | | | | | | | | |
| 69 | Surlyn | 76 | Fusabond | 24 | | | | | 88.2 | 60.9 | * |
| | 8150 | | 525D | | | | | | | | |
| 70 | Surlyn | 76 | Fusabond | 24 | | | | | 89.0 | 59.9 | * |
| | 8150 | | 525D | | | | | | | | |
| 71 | Surlyn | 76.75 | Fusabond | 23.25 | | | | | 89.6 | 60.1 | * |
| | 8150 | | 525D | | | | | | | | |
| 72 | Surlyn | 80 | Fusabond | 20 | | | | | 89.6 | 62.1 | 53.2 |
| | AD8546 | | 525D | | | | | | | | |
| 73 | Surlyn | 75 | Fusabond | 25 | | | | | 88.2 | 62.0 | 45.5 |
| | AD8546 | | 525D | | | | | | | | |
| 74 | Surlyn | 70 | Fusabond | 30 | | | | | 86.1 | 57.8 | 41.2 |
| | AD8546 | | 525D | | | | | | | | |
| 75 | Surlyn | 83.5 | Fusabond | 16.5 | | | | | 93.3 | 63.8 | 51.3 |
| | 8150 | | 525D | | | | | | | | |
| 76 | Surlyn | 76 | Fusabond | 24 | | | | | 90.3 | 60.7 | 40.8 |
| | 8150 | | 525D | | | | | | | | |
| 77 | Clarix | 88 | Fusabond | 12 | | | | | 92.9 | 64.7 | 54.6 |
| | 511705-01 | | 525D | | | | | | | | |
| 78 | Clarix | 83 | Fusabond | 17 | | | | | 92.3 | 63.0 | 50.0 |
| | 511705-01 | | 525D | | | | | | | | |
| 79 | Clarix | 78 | Fusabond | 22 | | | | | 91.4 | 63.6 | 43.4 |
| | 511705-01 | | 525D | | | | | | | | |
| 80 | Clarix | 90 | Fusabond | 10 | | | | | 91.0 | 67.4 | 53.1 |
| | 5152 | | 525D | | | | | | | | |
| 81 | Clarix | 85 | Fusabond | 15 | | | | | 90.1 | 65.7 | 49.4 |
| | 5152 | | 525D | | | | | | | | |
| 82 | Clarix | 80 | Fusabond | 20 | | | | | 89.2 | 63.9 | 44.4 |
| | 5152 | | 525D | | | | | | | | |
| 83 | Amplify | 40 | Fusabond | 60 | | | | | * | * | * |
| | GR205 | | 525D | | | | | | | | |
| 84 | Amplify | 60 | Fusabond | 40 | | | | | * | * | * |
| | GR205 | | 525D | | | | | | | | |
| 85 | Amplify | 70 | Fusabond | 30 | | | | | * | * | * |
| | GR205 | | 525D | | | | | | | | |
| 86 | Surlyn | 83.5 | Fusabond | 16.5 | | | | | 89.8 | 64.7 | * |
| | 8150 | | 525D | | | | | | | | |
| 87 | Surlyn | 76 | Fusabond | 24 | | | | | 87.5 | 62.6 | * |
| | 8150 | | 525D | | | | | | | | |
| 88 | Surlyn | 90 | Fusabond | 10 | | | | | 92.0 | 65.2 | 57.0 |
| | 7940 | | 525D | | | | | | | | |
| 89 | Surlyn | 85 | Fusabond | 15 | | | | | 91.6 | 63.4 | 55.5 |
| | 7940 | | 525D | | | | | | | | |
| 90 | Surlyn | 80 | Fusabond | 20 | | | | | 89.0 | 59.8 | 43.3 |
| | 7940 | | 525D | | | | | | | | |
| 91 | Surlyn | 88 | Fusabond | 12 | | | | | 93.3 | 64.4 | * |
| | 8150 | | 525D | | | | | | | | |
| 92 | Surlyn | 83.5 | Fusabond | 16.5 | | | | | 90.5 | 62.2 | * |
| | 8150 | | 525D | | | | | | | | |
| 93 | Surlyn | 76 | Fusabond | 24 | | | | | 89.0 | 60.4 | * |
| | 8150 | | 525D | | | | | | | | |
| 94 | Surlyn | 70 | Fusabond | 30 | | | | | 86.6 | 58.8 | 34.9 |
| | 8150 | | 525D | | | | | | | | |
| 95 | Surlyn | 92 | Fusabond | 8 | | | | | 87.3 | 60.3 | 37.1 |
| | 9650 | | 525D | | | | | | | | |
| 96 | Surlyn | 88 | Fusabond | 12 | | | | | 87.0 | 59.3 | 33.7 |
| | 9650 | | 525D | | | | | | | | |
| 97 | Surlyn | 86 | Fusabond | 14 | | | | | 87.0 | 59.6 | 35.8 |
| | 9650 | | 525D | | | | | | | | |
| 98 | Surlyn | 84 | Fusabond | 16 | | | | | 85.3 | 57.1 | 31.1 |
| | 9650 | | 525D | | | | | | | | |
| 99 | Surlyn | 82 | Fusabond | 18 | | | | | 85.4 | 55.6 | 37.0 |
| | 9650 | | 525D | | | | | | | | |
| 100 | Surlyn | 80 | Fusabond | 20 | | | | | 90.1 | 62.3 | 46.6 |
| | 8150 | | 525D | | | | | | | | |
| 101 | Surlyn | 75 | Fusabond | 25 | | | | | 87.2 | 59.7 | 41.2 |
| | 8150 | | 525D | | | | | | | | |
| 102 | Surlyn | 70 | Fusabond | 30 | | | | | 86.6 | 58.7 | 37.6 |
| | 8150 | | 525D | | | | | | | | |
| 103 | Amplify | 50 | Fusabond | 50 | | | | | * | * | * |
| | GR205 | | 525D | | | | | | | | |
| 104 | Surlyn | 74 | Fusabond | 26 | | | | | * | * | * |
| | 9650 | | 525D | | | | | | | | |
| 105 | Surlyn | 65 | Fusabond | 35 | | | | | * | * | * |
| | AD8546 | | 525D | | | | | | | | |
| 106 | Surlyn | 70 | Fusabond | 30 | | | | | * | * | * |
| | AD8546 | | 525D | | | | | | | | |
| 107 | Surlyn | 60 | Fusabond | 40 | | | | | * | * | * |
| | AD8546 | | 525D | | | | | | | | |
| 108 | Surlyn | 70 | Fusabond | 30 | | | | | * | * | * |
| | AD8546 | | 525D | | | | | | | | |
| 109 | Surlyn | 76 | Fusabond | 24 | | | | | * | * | * |
| | AD8546 | | 525D | | | | | | | | |
| 110 | Surlyn | 80 | Fusabond | 20 | | | | | 88.7 | 61.2 | 51.8 |
| | 8150 | | A560 | | | | | | | | |
| 111 | Surlyn | 75 | Fusabond | 25 | | | | | 87.6 | 58.8 | 49.5 |
| | 8150 | | A560 | | | | | | | | |
| 112 | Surlyn | 70 | Fusabond | 30 | | | | | 86.4 | 57.9 | 43.1 |
| | 8150 | | A560 | | | | | | | | |
| 113 | Surlyn | 76 | Fusabond | 24 | | | | | * | * | * |
| | 8150 | | A560 | | | | | | | | |
| 114 | Surlyn | 70 | Fusabond | 30 | | | | | * | * | * |
| | 8150 | | A560 | | | | | | | | |
| 115 | Surlyn | 70 | Fusabond | 30 | | | | | * | * | * |
| | AD8546 | | A560 | | | | | | | | |
| 116 | Surlyn | 76 | Fusabond | 24 | | | | | * | * | * |
| | AD8546 | | A560 | | | | | | | | |
| 117 | Surlyn | 80 | Fusabond | 20 | | | | | 89.5 | 62.1 | 49.2 |
| | 8150 | | C190 | | | | | | | | |
| 118 | Surlyn | 75 | Fusabond | 25 | | | | | 87.7 | 59.8 | 44.6 |
| | 8150 | | C190 | | | | | | | | |
| 119 | Surlyn | 70 | Fusabond | 30 | | | | | 86.7 | 58.6 | 40.2 |
| | 8150 | | C190 | | | | | | | | |
| 120 | Surlyn | 80 | Fusabond | 20 | | | | | * | * | * |
| | 8150 | | C250 | | | | | | | | |
| 121 | Surlyn | 75 | Fusabond | 25 | | | | | * | * | * |
| | 8150 | | C250 | | | | | | | | |
| 122 | Surlyn | 70 | Fusabond | 30 | | | | | * | * | * |
| | 8150 | | C250 | | | | | | | | |
| 123 | Surlyn | 80 | Fusabond | 20 | | | | | * | * | * |
| | 8150 | | E100 | | | | | | | | |
| 124 | Surlyn | 75 | Fusabond | 25 | | | | | * | * | * |
| | 8150 | | E100 | | | | | | | | |
| 125 | Surlyn | 70 | Fusabond | 30 | | | | | * | * | * |
| | 8150 | | E100 | | | | | | | | |
| 126 | Surlyn | 80 | Fusabond | 20 | | | | | * | * | * |
| | 8150 | | E528 | | | | | | | | |
| 127 | Surlyn | 75 | Fusabond | 25 | | | | | * | * | * |
| | 8150 | | E528 | | | | | | | | |
| 128 | Surlyn | 70 | Fusabond | 30 | | | | | * | * | * |
| | 8150 | | E528 | | | | | | | | |
| 129 | Surlyn | 80 | Fusabond | 20 | | | | | * | * | * |
| | 8150 | | M603 | | | | | | | | |
| 130 | Surlyn | 75 | Fusabond | 25 | | | | | * | * | * |
| | 8150 | | M603 | | | | | | | | |
| 131 | Surlyn | 70 | Fusabond | 30 | | | | | * | * | * |
| | 8150 | | M603 | | | | | | | | |
| 132 | Surlyn | 80 | Fusabond | 20 | | | | | * | * | * |
| | 8150 | | N416 | | | | | | | | |
| 133 | Surlyn | 75 | Fusabond | 25 | | | | | * | * | * |
| | 8150 | | N416 | | | | | | | | |
| 134 | Surlyn | 70 | Fusabond | 30 | | | | | * | * | * |
| | 8150 | | N416 | | | | | | | | |
| 135 | Surlyn | 45 | Fusabond | 45 | Fusabond | 10 | | | * | * | * |
| | 9945 | | P353 | | 525D | | | | | | |
| 136 | Surlyn | 40 | Fusabond | 40 | Fusabond | 20 | | | * | * | * |
| | 9945 | | P353 | | 525D | | | | | | |
| 137 | Surlyn | 35 | Fusabond | 35 | Fusabond | 30 | | | * | * | * |
| | 9945 | | P353 | | 525D | | | | | | |
| 138 | Surlyn | 80 | Fusabond | 20 | | | | | * | * | * |
| | 8150 | | P353 | | | | | | | | |
| 139 | Surlyn | 75 | Fusabond | 25 | | | | | * | * | * |
| | 8150 | | P353 | | | | | | | | |
| 140 | Surlyn | 70 | Fusabond | 30 | | | | | * | * | * |
| | 8150 | | P353 | | | | | | | | |
| 141 | Surlyn | 50 | Fusabond | 50 | | | | | * | * | * |
| | 9945 | | P353 | | | | | | | | |
| 142 | Surlyn | 45 | Fusabond | 45 | Fusabond | 10 | | | * | * | * |
| | 9945 | | P613 | | 525D | | | | | | |
| 143 | Surlyn | 40 | Fusabond | 40 | Fusabond | 20 | | | * | * | * |
| | 9945 | | P613 | | 525D | | | | | | |
| 144 | Surlyn | 35 | Fusabond | 35 | Fusabond | 30 | | | * | * | * |
| | 9945 | | P613 | | 525D | | | | | | |
| 145 | Surlyn | 80 | Fusabond | 20 | | | | | * | * | * |
| | 8150 | | P613 | | | | | | | | |
| 146 | Surlyn | 75 | Fusabond | 25 | | | | | * | * | * |
| | 8150 | | P613 | | | | | | | | |
| 147 | Surlyn | 70 | Fusabond | 30 | | | | | * | * | * |
| | 8150 | | P613 | | | | | | | | |
| 148 | Surlyn | 50 | Fusabond | 50 | | | | | * | * | * |
| | 9945 | | P613 | | | | | | | | |
| 149 | Surlyn | 80 | Fusabond | 20 | | | | | * | * | * |
| | 9945 | | P613 | | | | | | | | |
| 150 | Surlyn | 75 | Fusabond | 25 | | | | | * | * | * |
| | 9945 | | P613 | | | | | | | | |
| 151 | Clarix | 50 | HPF 1000 | 50 | | | | | 87.8 | 62.3 | 40.6 |
| | 5152 | | | | | | | | | | |
| 152 | Clarix | 75 | HPF 1000 | 25 | | | | | 89.6 | 64.9 | 46.2 |
| | 5152 | | | | | | | | | | |
| 153 | Clarix | 25 | HPF 1000 | 75 | | | | | 84.1 | 58.2 | 34.0 |
| | 5152 | | | | | | | | | | |
| 154 | Clarix | 50 | HPF 2000 | 50 | | | | | 89.8 | 64.0 | 38.3 |
| | 5152 | | | | | | | | | | |
| 155 | Surlyn | 95 | Iriodin 211 | 5 | | | | | 93.3 | 66.4 | 55.9 |
| | 8945 | | Rutile Fine | | | | | | | | |
| | | | Red | | | | | | | | |
| 156 | Surlyn | 99.7 | Kemamide | 0.3 | | | | | 91.6 | 65.4 | 67.2 |
| | 7940 | | W-40 | | | | | | | | |
| 157 | Surlyn | 99.4 | Kemamide | 0.6 | | | | | 91.9 | 65.9 | 68.4 |
| | 7940 | | W-40 | | | | | | | | |
| 158 | Surlyn | 99.1 | Kemamide | 0.9 | | | | | 92.5 | 66.5 | 66.3 |
| | 7940 | | W-40 | | | | | | | | |
| 159 | Surlyn | 80 | Kraton | 20 | | | | | 88.8 | 63.9 | 50.0 |
| | 8150 | | FG1901GT | | | | | | | | |
| 160 | Surlyn | 75 | Kraton | 25 | | | | | 87.2 | 61.8 | 42.8 |
| | 8150 | | FG1901GT | | | | | | | | |
| 161 | Surlyn | 70 | Kraton | 30 | | | | | 85.6 | 60.0 | 36.0 |
| | 8150 | | FG1901GT | | | | | | | | |
| 162 | Surlyn | 80 | Kraton | 20 | | | | | 87.7 | 61.7 | 46.1 |
| | 8150 | | FG1924GT | | | | | | | | |
| 163 | Surlyn | 75 | Kraton | 25 | | | | | 87.3 | 60.2 | 41.9 |
| | 8150 | | FG1924GT | | | | | | | | |
| 164 | Surlyn | 70 | Kraton | 30 | | | | | 84.3 | 57.3 | 37.5 |
| | 8150 | | FG1924GT | | | | | | | | |
| 165 | Surlyn | 80 | Kraton | 20 | | | | | 89.7 | 63.2 | 52.2 |
| | 8150 | | RP6670GT | | | | | | | | |
| 166 | Surlyn | 75 | Kraton | 25 | | | | | 88.7 | 62.6 | 45.5 |
| | 8150 | | RP6670GT | | | | | | | | |
| 167 | Surlyn | 70 | Kraton | 30 | | | | | 87.1 | 61.0 | 44.3 |
| | 8150 | | RP6670GT | | | | | | | | |
| 168 | Surlyn | 70 | Lotader | 30 | | | | | 91.6 | 62.5 | 50.0 |
| | 8150 | | 4210 | | | | | | | | |
| 169 | Surlyn | 75 | Lotader | 25 | | | | | 92.3 | 63.4 | 52.0 |
| | 8150 | | 4210 | | | | | | | | |
| 170 | Surlyn | 80 | Lotader | 20 | | | | | 92.3 | 64.3 | 57.6 |
| | 8150 | | 4210 | | | | | | | | |
| 171 | Surlyn | 80 | Lotader | 20 | | | | | 89.5 | 61.5 | * |
| | 8150 | | 4603 | | | | | | | | |
| 172 | Surlyn | 75 | Lotader | 25 | | | | | 88.4 | 59.7 | * |
| | 8150 | | 4603 | | | | | | | | |
| 173 | Surlyn | 70 | Lotader | 30 | | | | | 87.4 | 58.3 | * |
| | 8150 | | 4603 | | | | | | | | |
| 174 | Surlyn | 70 | Lotader | 30 | | | | | 87.1 | 58.4 | 39.4 |
| | 8150 | | 4700 | | | | | | | | |
| 175 | Surlyn | 75 | Lotader | 25 | | | | | 89.7 | 60.8 | 44.2 |
| | 8150 | | 4700 | | | | | | | | |
| 176 | Surlyn | 80 | Lotader | 20 | | | | | 88.3 | 59.2 | 50.1 |
| | 8150 | | 4700 | | | | | | | | |
| 177 | Surlyn | 80 | Lotader | 20 | | | | | 89.7 | 60.6 | * |
| | 8150 | | 4720 | | | | | | | | |
| 178 | Surlyn | 75 | Lotader | 25 | | | | | 87.5 | 58.8 | * |
| | 8150 | | 4720 | | | | | | | | |
| 179 | Surlyn | 70 | Lotader | 30 | | | | | 86.1 | 55.9 | * |
| | 8150 | | 4720 | | | | | | | | |
| 180 | Surlyn | 80 | Lotader | 20 | | | | | 91.0 | 62.7 | 59.0 |
| | 8150 | | 6200 | | | | | | | | |
| 181 | Surlyn | 75 | Lotader | 25 | | | | | 90.9 | 61.8 | 57.4 |
| | 8150 | | 6200 | | | | | | | | |
| 182 | Surlyn | 70 | Lotader | 30 | | | | | 90.2 | 60.7 | 54.4 |
| | 8150 | | 6200 | | | | | | | | |
| 183 | Surlyn | 80 | Lotader | 20 | | | | | 91.3 | 63.0 | 62.7 |
| | 8150 | | 8200 | | | | | | | | |
| 184 | Surlyn | 75 | Lotader | 25 | | | | | 90.9 | 61.8 | 60.8 |
| | 8150 | | 8200 | | | | | | | | |
| 185 | Surlyn | 70 | Lotader | 30 | | | | | 90.4 | 61.0 | 53.6 |
| | 8150 | | 8200 | | | | | | | | |
| 186 | Surlyn | 85 | Mg Stearate | 15 | | | | | * | * | * |
| | 7940 | | | | | | | | | | |
| 187 | Surlyn | 90 | Microglass | 10 | | | | | 92.8 | 68.3 | 66.4 |
| | 9945 | | REF-600 | | | | | | | | |
| 188 | Nucrel | 85 | Nanoclay | 15 | | | | | * | * | * |
| | 0609HS | | | | | | | | | | |
| 189 | HPF 1000 | 85 | Nanoclay | 15 | | | | | * | * | * |
| 190 | Surlyn | 75 | Nucrel | 25 | | | | | * | * | * |
| | AD8546 | | 0910HS | | | | | | | | |
| 191 | Surlyn | 50 | Nucrel | 50 | | | | | * | * | * |
| | AD8546 | | 0910HS | | | | | | | | |
| 192 | Surlyn | 25 | Nucrel | 75 | | | | | * | * | * |
| | AD8546 | | 0910HS | | | | | | | | |
| 193 | Surlyn | 75 | Nucrel | 25 | | | | | * | * | * |
| | AD8546 | | 1202HC | | | | | | | | |
| 194 | Surlyn | 50 | Nucrel | 50 | | | | | * | * | * |
| | AD8546 | | 1202HC | | | | | | | | |
| 195 | Surlyn | 25 | Nucrel | 75 | | | | | * | * | * |
| | AD8546 | | 1202HC | | | | | | | | |
| 196 | Surlyn | 45 | Polybond | 45 | Fusabond | 10 | | | * | * | * |
| | 9945 | | 3009 | | 525D | | | | | | |
| 197 | Surlyn | 40 | Polybond | 40 | Fusabond | 20 | | | * | * | * |
| | 9945 | | 3009 | | 525D | | | | | | |
| 198 | Surlyn | 35 | Polybond | 35 | Fusabond | 30 | | | * | * | * |
| | 9945 | | 3009 | | 525D | | | | | | |
| 199 | Surlyn | 50 | Polybond | 50 | | | | | * | * | * |
| | 9945 | | 3009 | | | | | | | | |
| 200 | Surlyn | 70 | Royaltuf | 30 | | | | | 84.4 | 53.7 | 33.5 |
| | 8150 | | 485 | | | | | | | | |
| 201 | Surlyn | 75 | Royaltuf | 25 | | | | | 88.8 | 59.4 | 39.5 |
| | 8150 | | 485 | | | | | | | | |
| 202 | Surlyn | 80 | Royaltuf | 20 | | | | | 90.1 | 60.6 | 45.4 |
| | 8150 | | 485 | | | | | | | | |
| 203 | Surlyn | 70 | Royaltuf | 30 | Dicumyl | 1 | | | * | * | * |
| | 8150 | | 498 | | Peroxide | pph | | | | | |
| 204 | Surlyn | 80 | Royaltuf | 20 | | | | | 88.4 | 59.1 | 46.0 |
| | 8150 | | 498 | | | | | | | | |
| 205 | Surlyn | 75 | Royaltuf | 25 | | | | | 86.5 | 56.2 | 40.1 |
| | 8150 | | 498 | | | | | | | | |
| 206 | Surlyn | 70 | Royaltuf | 30 | | | | | 83.9 | 53.9 | 34.0 |
| | 8150 | | 498 | | | | | | | | |
| 207 | Surlyn | 47 | Surlyn | 31 | Fusabond | 22 | | | 87.2 | 58.0 | * |
| | 9650 | | 7940 | | 525D | | | | | | |
| 208 | Surlyn | 28 | Surlyn | 21 | Surlyn | 21 | Fusabond | | * | * | * |
| | AD8546 | | 8150 | | 9120 | | 525D | | | | |
| | | | | | | | (30 wt %) | | | | |
| 209 | Surlyn | 30 | Surlyn | 22.5 | Surlyn | 22.5 | Fusabond | | * | * | * |
| | AD8546 | | 8150 | | 9120 | | 525D | | | | |
| | | | | | | | (25 wt %) | | | | |
| 210 | Surlyn | 32 | Surlyn | 24 | Surlyn | 24 | Fusabond | | * | * | * |
| | AD8546 | | 8150 | | 9120 | | 525D | | | | |
| | | | | | | | (20 wt %) | | | | |
| 211 | Surlyn | 50 | Surlyn | 50 | | | | | 94.3 | 68.9 | * |
| | 7940 | | 8150 | | | | | | | | |
| 212 | Surlyn | 72.8 | Surlyn | 24.3 | Cloisite | 3 | | | 87.5 | 57.9 | 41.0 |
| | 9650 | | 8320 | | 20A | | | | | | |
| 213 | Surlyn | 70.5 | Surlyn | 23.5 | Cloisite | 6 | | | 88.0 | 60.6 | 42.2 |
| | 9650 | | 8320 | | 20A | | | | | | |
| 214 | Surlyn | 68.3 | Surlyn | 22.8 | Cloisite | 9 | | | 88.6 | 61.4 | 50.5 |
| | 9650 | | 8320 | | 20A | | | | | | |
| 215 | Surlyn | 66 | Surlyn | 22 | Cloisite | 12 | | | 89.2 | 62.3 | 66.7 |
| | 9650 | | 8320 | | 20A | | | | | | |
| 216 | Surlyn | 56.4 | Surlyn | 37.6 | Cloisite | 6 | | | 85.5 | 58.6 | * |
| | 9650 | | 8320 | | 20A | | | | | | |
| 217 | Surlyn | 54.6 | Surlyn | 36.4 | Cloisite | 9 | | | 86.0 | 59.3 | * |
| | 9650 | | 8320 | | 20A | | | | | | |
| 218 | Surlyn | 52.8 | Surlyn | 35.2 | Cloisite | 12 | | | 87.9 | 61.0 | * |
| | 9650 | | 8320 | | 20A | | | | | | |
| 219 | Surlyn | 51 | Surlyn | 34 | Cloisite | 15 | | | 88.5 | 62.7 | * |
| | 9650 | | 8320 | | 20A | | | | | | |
| 220 | Surlyn | 58.2 | Surlyn | 38.8 | Cloisite | 3 | | | 83.9 | 57.4 | * |
| | 9650 | | 8320 | | 20A | | | | | | |
| 221 | Surlyn | 50 | Surlyn | 35 | Luzenac | 15 | | | * | * | * |
| | 7940 | | 8320 | | HAR T-84 | | | | | | |
| | | | | | Talc | | | | | | |
| 222 | Surlyn | 56.4 | Surlyn | 37.6 | Luzenac | 6 | | | 86.0 | 57.5 | * |
| | 9650 | | 8320 | | HAR T-84 | | | | | | |
| | | | | | Talc | | | | | | |
| 223 | Surlyn | 54.6 | Surlyn | 36.4 | Luzenac | 9 | | | 84.9 | 57.2 | * |
| | 9650 | | 8320 | | HAR T-84 | | | | | | |
| | | | | | Talc | | | | | | |
| 224 | Surlyn | 52.8 | Surlyn | 35.2 | Luzenac | 12 | | | 86.1 | 58.3 | * |
| | 9650 | | 8320 | | HAR T-84 | | | | | | |
| | | | | | Talc | | | | | | |
| 225 | Surlyn | 51 | Surlyn | 34 | Luzenac | 15 | | | 87.3 | 59.4 | * |
| | 9650 | | 8320 | | HAR T-84 | | | | | | |
| | | | | | Talc | | | | | | |
| 226 | Surlyn | 75 | Surlyn | 25 | | | | | 87.1 | 57.5 | 35.5 |
| | 9650 | | 8320 | | | | | | | | |
| 227 | Surlyn | 60 | Surlyn | 40 | | | | | 82.5 | 55.6 | * |
| | 9650 | | 8320 | | | | | | | | |
| 228 | Surlyn | 35 | Surlyn | 35 | Surlyn | 30 | | | 88.0 | 59.0 | * |
| | 8320 | | 8528 | | 9650 | | | | | | |
| 229 | Surlyn | 40 | Surlyn | 40 | Amplify | 20 | | | * | * | 44.0 |
| | 7940 | | 8940 | | GR216 | | | | | | |
| 230 | Surlyn | 37.5 | Surlyn | 37.5 | Amplify | 25 | | | * | * | 39.4 |
| | 7940 | | 8940 | | GR216 | | | | | | |
| 231 | Surlyn | 35 | Surlyn | 35 | Amplify | 30 | | | * | * | 31.6 |
| | 7940 | | 8940 | | GR216 | | | | | | |
| 232 | Surlyn | 46 | Surlyn | 46 | Cloisite | 8 | | | 93.0 | 68.8 | 97.5 |
| | 7940 | | 8940 | | 20A | | | | | | |
| 233 | Surlyn | 35 | Surlyn | 35 | Fusabond | 30 | | | 85.4 | 55.5 | 38.5 |
| | 7940 | | 8940 | | 525D | | | | | | |
| 234 | Surlyn | 37.5 | Surlyn | 37.5 | Fusabond | 25 | | | 87.5 | 57.8 | 32.6 |
| | 7940 | | 8940 | | 525D | | | | | | |
| 235 | Surlyn | 40 | Surlyn | 40 | Fusabond | 20 | | | 89.4 | 59.9 | 45.1 |
| | 7940 | | 8940 | | 525D | | | | | | |
| 236 | Surlyn | 39 | Surlyn | 39 | Fusabond | 22 | | | 89.4 | 59.2 | * |
| | 7940 | | 8940 | | 525D | | | | | | |
| 237 | Surlyn | 39 | Surlyn | 39 | Fusabond | 20 | NanoMax | | 88.3 | 61.9 | 44.8 |
| | 7940 | | 8940 | | 525D | | I.31PS | | | | |
| | | | | | | | (2 wt %) | | | | |
| 238 | Surlyn | 38 | Surlyn | 38 | Fusabond | 20 | NanoMax | | 88.6 | 62.6 | 52.4 |
| | 7940 | | 8940 | | 525D | | I.31PS | | | | |
| | | | | | | | (4 wt %) | | | | |
| 239 | Surlyn | 36.8 | Surlyn | 36.8 | Fusabond | 20 | NanoMax | | 89.7 | 64.1 | 61.1 |
| | 7940 | | 8940 | | 525D | | I.31PS | | | | |
| | | | | | | | (6.4 wt %) | | | | |
| 240 | Surlyn | 39 | Surlyn | 39 | Fusabond | 20 | NanoMax | | 88.9 | 63.4 | 47.9 |
| | 7940 | | 8940 | | 525D | | I.44P | | | | |
| | | | | | | | (2 wt %) | | | | |
| 241 | Surlyn | 38 | Surlyn | 38 | Fusabond | 20 | NanoMax | | 89.3 | 64.3 | 52.8 |
| | 7940 | | 8940 | | 525D | | I.44P | | | | |
| | | | | | | | (4 wt %) | | | | |
| 242 | Surlyn | 36.8 | Surlyn | 36.8 | Fusabond | 20 | NanoMax | | 89.3 | 63.6 | 55.1 |
| | 7940 | | 8940 | | 525D | | I.44P | | | | |
| | | | | | | | (6.4 wt %) | | | | |
| 243 | Surlyn | 46 | Surlyn | 46 | NanoMax | 8 | | | 92.7 | 70.3 | 98.4 |
| | 7940 | | 8940 | | I.31PS | | | | | | |
| 244 | Surlyn | 47.5 | Surlyn | 47.5 | NanoMax | 5 | | | 92.6 | 69.6 | 82.4 |
| | 7940 | | 8940 | | I.31PS | | | | | | |
| 245 | Surlyn | 48.75 | Surlyn | 48.75 | NanoMax | 2.5 | | | 92.5 | 69.4 | 77.3 |
| | 7940 | | 8940 | | I.31PS | | | | | | |
| 246 | Surlyn | 48.75 | Surlyn | 48.75 | NanoMax | 2.5 | | | 93.2 | 69.4 | 77.0 |
| | 7940 | | 8940 | | I.44P | | | | | | |
| 247 | Surlyn | 47.5 | Surlyn | 47.5 | NanoMax | 5 | | | 93.3 | 69.2 | 84.4 |
| | 7940 | | 8940 | | I.44P | | | | | | |
| 248 | Surlyn | 46 | Surlyn | 46 | NanoMax | 8 | | | 93.3 | 70.9 | 98.6 |
| | 7940 | | 8940 | | I.44P | | | | | | |
| 249 | Surlyn | 35 | Surlyn | 35 | Nucrel 960 | 30 | | | 93.8 | 65.4 | 63.1 |
| | 7940 | | 8940 | | | | | | | | |
| 250 | Surlyn | 37.5 | Surlyn | 37.5 | Nucrel 960 | 25 | | | 93.6 | 65.4 | 63.0 |
| | 7940 | | 8940 | | | | | | | | |
| 251 | Surlyn | 40 | Surlyn | 40 | Nucrel 960 | 20 | | | 93.9 | 65.9 | 63.4 |
| | 7940 | | 8940 | | | | | | | | |
| 252 | Surlyn | 45 | Surlyn | 45 | Nucrel 960 | 10 | | | 94.7 | * | * |
| | 7940 | | 8940 | | | | | | | | |
| 253 | Surlyn | 47.5 | Surlyn | 47.5 | Nucrel 960 | 5 | | | 93.2 | * | * |
| | 7940 | | 8940 | | | | | | | | |
| 254 | Surlyn | 55 | Surlyn | 45 | SU11140 | 5 | | | 94.0 | 68.6 | * |
| | 7940 | | 8940 | | TiO₂ color | phr | | | | | |
| | | | | | concentrate | | | | | | |
| 255 | Surlyn | 35 | Surlyn | 35 | Surlyn | 30 | | | 89.5 | 60.4 | 38.5 |
| | 7940 | | 8940 | | 8320 | | | | | | |
| 256 | Surlyn | 37.5 | Surlyn | 37.5 | Surlyn | 25 | | | 90.3 | 61.0 | 41.4 |
| | 7940 | | 8940 | | 8320 | | | | | | |
| 257 | Surlyn | 40 | Surlyn | 40 | Surlyn | 20 | | | 91.9 | 62.5 | 45.1 |
| | 7940 | | 8940 | | 8320 | | | | | | |
| 258 | Surlyn | 35 | Surlyn | 35 | Surlyn | 30 | | | * | * | * |
| | 7940 | | 8940 | | 9020 | | | | | | |
| 259 | Surlyn | 37.5 | Surlyn | 37.5 | Surlyn | 25 | | | * | * | * |
| | 7940 | | 8940 | | 9020 | | | | | | |
| 260 | Surlyn | 40 | Surlyn | 40 | Surlyn | 20 | | | * | * | * |
| | 7940 | | 8940 | | 9020 | | | | | | |
| 261 | Surlyn | 28 | Surlyn | 21 | Surlyn | 21 | Fusabond | | 86.2 | 56.9 | 36.6 |
| | 7940 | | 8940 | | 9910 | | 525D | | | | |
| | | | | | | | (30 wt %) | | | | |
| 262 | Surlyn | 32 | Surlyn | 24 | Surlyn | 24 | Fusabond | | 89.7 | 59.8 | 46.5 |
| | 7940 | | 8940 | | 9910 | | 525D | | | | |
| | | | | | | | (20 wt %) | | | | |
| 263 | Surlyn | 30 | Surlyn | 22.5 | Surlyn | 22.5 | Fusabond | | 87.2 | 57.8 | 39.1 |
| | 7940 | | 8940 | | 9910 | | 525D | | | | |
| | | | | | | | (25 wt %) | | | | |
| 264 | Surlyn | 50 | Surlyn | 50 | | | | | 94.6 | * | * |
| | 7940 | | 8940 | | | | | | | | |
| 265 | Surlyn | 50 | Surlyn | 50 | | | | | 94.2 | 66.0 | * |
| | 7940 | | 8940 | | | | | | | | |
| 266 | Surlyn | 50 | Surlyn | 50 | | | | | 93.7 | 66.5 | * |
| | 7940 | | 8940 | | | | | | | | |
| 267 | Surlyn | 90 | Surlyn | 10 | | | | | 93.7 | 65.7 | * |
| | 7940 | | 8940 | | | | | | | | |
| 268 | Surlyn | 50 | Surlyn | 50 | | | | | 93.2 | 66.6 | * |
| | 7940 | | 8940 | | | | | | | | |
| 269 | Surlyn | 38 | Surlyn | 38 | Fusabond | 24 | | | 88.6 | 59.3 | * |
| | 7940 | | 8940 | | 525D | | | | | | |
| 270 | Surlyn | 35 | Surlyn | 35 | Fusabond | 30 | | | 87.2 | 57.3 | 37.6 |
| | 8150 | | 9120 | | 525D | | | | | | |
| 271 | Surlyn | 37.5 | Surlyn | 37.5 | Fusabond | 25 | | | 88.9 | 59.5 | 45.6 |
| | 8150 | | 9120 | | 525D | | | | | | |
| 272 | Surlyn | 40 | Surlyn | 40 | Fusabond | 20 | | | 90.8 | 61.1 | 48.3 |
| | 8150 | | 9120 | | 525D | | | | | | |
| 273 | Surlyn | 49 | Surlyn | 21 | Fusabond | 30 | | | 88.4 | 60.2 | 39.9 |
| | AD8546 | | 9120 | | 525D | | | | | | |
| 274 | Surlyn | 52.5 | Surlyn | 22.5 | Fusabond | 25 | | | 90.4 | 62.6 | 46.5 |
| | AD8546 | | 9120 | | 525D | | | | | | |
| 275 | Surlyn | 56 | Surlyn | 24 | Fusabond | 20 | | | 91.8 | 64.2 | 51.6 |
| | AD8546 | | 9120 | | 525D | | | | | | |
| 276 | Surlyn | 37.5 | Surlyn | 37.5 | Nucrel | 25 | | | * | * | * |
| | 8150 | | 9120 | | 0910HS | | | | | | |
| 277 | Surlyn | 25 | Surlyn | 25 | Nucrel | 50 | | | * | * | * |
| | 8150 | | 9120 | | 0910HS | | | | | | |
| 278 | Surlyn | 12.5 | Surlyn | 12.5 | Nucrel | 75 | | | * | * | * |
| | 8150 | | 9120 | | 0910HS | | | | | | |
| 279 | Surlyn | 37.5 | Surlyn | 37.5 | Nucrel | 25 | | | * | * | * |
| | 8150 | | 9120 | | 1202HC | | | | | | |
| 280 | Surlyn | 25 | Surlyn | 25 | Nucrel | 50 | | | * | * | * |
| | 8150 | | 9120 | | 1202HC | | | | | | |
| 281 | Surlyn | 12.5 | Surlyn | 12.5 | Nucrel | 75 | | | * | * | * |
| | 8150 | | 9120 | | 1202HC | | | | | | |
| 282 | Surlyn | 35 | Surlyn | 35 | Surlyn | 15 | Fusabond | | * | * | 48.4 |
| | 8150 | | 9120 | | 9020 | | 525D | | | | |
| | | | | | | | (15 wt %) | | | | |
| 283 | Surlyn | 37.5 | Surlyn | 37.5 | Surlyn | 10 | Fusabond | | * | * | 50.9 |
| | 8150 | | 9120 | | 9020 | | 525D | | | | |
| | | | | | | | (15 wt %) | | | | |
| 284 | Surlyn | 40 | Surlyn | 40 | Surlyn | 5 | Fusabond | | * | * | 57.1 |
| | 8150 | | 9120 | | 9020 | | 525D | | | | |
| | | | | | | | (15 wt %) | | | | |
| 285 | Surlyn | 50 | Surlyn | 50 | | | | | * | * | * |
| | 8150 | | 9120 | | | | | | | | |
| 286 | Surlyn | 56.4 | Surlyn | 37.6 | Cloisite | 6 | | | 82.5 | 55.5 | * |
| | 9650 | | 9320 | | 20A | | | | | | |
| 287 | Surlyn | 54.6 | Surlyn | 36.4 | Cloisite | 9 | | | 85.5 | 59.1 | * |
| | 9650 | | 9320 | | 20A | | | | | | |
| 288 | Surlyn | 52.8 | Surlyn | 35.2 | Cloisite | 12 | | | * | * | * |
| | 9650 | | 9320 | | 20A | | | | | | |
| 289 | Surlyn | 51 | Surlyn | 34 | Cloisite | 15 | | | 87.5 | 61.1 | * |
| | 9650 | | 9320 | | 20A | | | | | | |
| 290 | Surlyn | 58 | Surlyn | 38 | Cloisite | 4 | | | * | * | * |
| | AD8546 | | 9320 | | 30B | | | | | | |
| 291 | Surlyn | 55.2 | Surlyn | 36.8 | Cloisite | 8 | | | * | * | * |
| | AD8546 | | 9320 | | 30B | | | | | | |
| 292 | Surlyn | 53 | Surlyn | 35 | Cloisite | 12 | | | * | * | * |
| | AD8546 | | 9320 | | 30B | | | | | | |
| 293 | Surlyn | 56.4 | Surlyn | 37.6 | Luzenac | 6 | | | 82.0 | 54.0 | * |
| | 9650 | | 9320 | | HAR T-84 | | | | | | |
| | | | | | Talc | | | | | | |
| 294 | Surlyn | 54.6 | Surlyn | 36.4 | Luzenac | 9 | | | 82.7 | 55.1 | * |
| | 9650 | | 9320 | | HAR T-84 | | | | | | |
| | | | | | Talc | | | | | | |
| 295 | Surlyn | 52.8 | Surlyn | 35.2 | Luzenac | 12 | | | 84.8 | 57.3 | * |
| | 9650 | | 9320 | | HAR T-84 | | | | | | |
| | | | | | Talc | | | | | | |
| 296 | Surlyn | 51 | Surlyn | 34 | Luzenac | 15 | | | * | * | * |
| | 9650 | | 9320 | | HAR T-84 | | | | | | |
| | | | | | Talc | | | | | | |
| 297 | Surlyn | 60 | Surlyn | 40 | | | | | 81.7 | 55.3 | * |
| | 9650 | | 9320 | | | | | | | | |
| 298 | Surlyn | 60 | Surlyn | 40 | | | | | * | * | * |
| | AD8546 | | 9320 | | | | | | | | |
| 299 | Surlyn | 27 | Surlyn | 27 | Clarix | 46 | Carbon | | 91.6 | 55.4 | * |
| | 7940 | | 9650 | | 011370-01 | | Black | | | | |
| | | | | | | | (7.5 pph) | | | | |
| 300 | Surlyn | 27 | Surlyn | 27 | Clarix | 46 | Carbon | | 91.4 | 64.8 | * |
| | 7940 | | 9650 | | 011370-01 | | Black | | | | |
| | | | | | | | (7.5 pph) | | | | |
| 301 | Surlyn | 27 | Surlyn | 27 | Clarix | 46 | | | 90.0 | 61.2 | 48.7 |
| | 7940 | | 9650 | | 011370-01 | | | | | | |
| 302 | Surlyn | 40 | Surlyn | 40 | Fusabond | 20 | | | 87.6 | 58.2 | 44.7 |
| | 7940 | | 9650 | | 525D | | | | | | |
| 303 | Surlyn | 37.5 | Surlyn | 37.5 | Fusabond | 25 | | | 85.1 | 55.2 | 36.3 |
| | 7940 | | 9650 | | 525D | | | | | | |
| 304 | Surlyn | 35 | Surlyn | 35 | Fusabond | 30 | | | 84.4 | 54.8 | 33.8 |
| | 7940 | | 9650 | | 525D | | | | | | |
| 305 | Surlyn | 37.5 | Surlyn | 37.5 | Fusabond | 25 | | | 83.1 | 53.3 | 27.6 |
| | 8528 | | 9650 | | 525D | | | | | | |
| 306 | Surlyn | 40 | Surlyn | 40 | Fusabond | 20 | | | 85.5 | 54.8 | 32.7 |
| | 8528 | | 9650 | | 525D | | | | | | |
| 307 | Surlyn | 35 | Surlyn | 35 | Fusabond | 30 | | | 82.1 | 52.6 | 26.6 |
| | 8528 | | 9650 | | 525D | | | | | | |
| 308 | Surlyn | 9 | Surlyn | 81 | Fusabond | 10 | | | 89.4 | 61.1 | 46.2 |
| | 7940 | | 9650 | | 525D | | | | | | |
| 309 | Surlyn | 8.5 | Surlyn | 76.5 | Fusabond | 15 | | | 88.0 | 58.1 | 42.0 |
| | 7940 | | 9650 | | 525D | | | | | | |
| 310 | Surlyn | 8 | Surlyn | 72 | Fusabond | 20 | | | 86.1 | 57.0 | 34.8 |
| | 7940 | | 9650 | | 525D | | | | | | |
| 311 | Surlyn | 27 | Surlyn | 63 | Fusabond | 10 | | | 90.7 | 63.0 | 53.2 |
| | 7940 | | 9650 | | 525D | | | | | | |
| 312 | Surlyn | 25.5 | Surlyn | 59.5 | Fusabond | 15 | | | 89.4 | 61.5 | 44.6 |
| | 7940 | | 9650 | | 525D | | | | | | |
| 313 | Surlyn | 24 | Surlyn | 56 | Fusabond | 20 | | | 87.0 | 57.2 | 39.7 |
| | 7940 | | 9650 | | 525D | | | | | | |
| 314 | Surlyn | 44 | Surlyn | 44 | Fusabond | 12 | | | 91.0 | 62.9 | 49.9 |
| | 7940 | | 9650 | | 525D | | | | | | |
| 315 | Surlyn | 42.5 | Surlyn | 42.5 | Fusabond | 15 | | | 90.5 | 61.7 | 46.2 |
| | 7940 | | 9650 | | 525D | | | | | | |
| 316 | Surlyn | 41 | Surlyn | 41 | Fusabond | 18 | | | 89.4 | 61.1 | 42.2 |
| | 7940 | | 9650 | | 525D | | | | | | |
| 317 | Surlyn | 39.5 | Surlyn | 39.5 | Fusabond | 21 | | | 88.0 | 58.8 | 40.0 |
| | 7940 | | 9650 | | 525D | | | | | | |
| 318 | Surlyn | 38 | Surlyn | 38 | Fusabond | 24 | | | 85.3 | 56.9 | 34.6 |
| | 7940 | | 9650 | | 525D | | | | | | |
| 319 | Surlyn | 38 | Surlyn | 38 | Fusabond | 21 | Cloisite | | 89.3 | 61.1 | 44.3 |
| | 7940 | | 9650 | | 525D | | 30B | | | | |
| | | | | | | | (3 wt %) | | | | |
| 320 | Surlyn | 36.5 | Surlyn | 36.5 | Fusabond | 21 | Cloisite | | 89.9 | 61.0 | 49.8 |
| | 7940 | | 9650 | | 525D | | 30B | | | | |
| | | | | | | | (6 wt %) | | | | |
| 321 | Surlyn | 35 | Surlyn | 35 | Fusabond | 21 | Cloisite | | 90.1 | 62.3 | 54.9 |
| | 7940 | | 9650 | | 525D | | 30B | | | | |
| | | | | | | | (9 wt %) | | | | |
| 322 | Surlyn | 38 | Surlyn | 38 | Fusabond | 21 | Cloisite 6A | | 89.6 | 60.5 | 46.2 |
| | 7940 | | 9650 | | 525D | | (3 wt %) | | | | |
| 323 | Surlyn | 36.5 | Surlyn | 36.5 | Fusabond | 21 | Cloisite 6A | | 89.8 | 61.0 | 51.2 |
| | 7940 | | 9650 | | 525D | | (6 wt %) | | | | |
| 324 | Surlyn | 35 | Surlyn | 35 | Fusabond | 21 | Cloisite 6A | | 89.9 | 61.3 | 52.3 |
| | 7940 | | 9650 | | 525D | | (9 wt %) | | | | |
| 325 | Clarix | 45 | Surlyn | 45 | Fusabond | 10 | | | 90.7 | 62.8 | 51.8 |
| | 5152 | | 9650 | | 525D | | | | | | |
| 326 | Clarix | 42.5 | Surlyn | 42.5 | Fusabond | 15 | | | 87.5 | 59.8 | 42.9 |
| | 5152 | | 9650 | | 525D | | | | | | |
| 327 | Clarix | 40 | Surlyn | 40 | Fusabond | 20 | | | 86.4 | 59.1 | 37.4 |
| | 5152 | | 9650 | | 525D | | | | | | |
| 328 | Surlyn | 41 | Surlyn | 41 | Fusabond | 18 | | | 88.9 | 62.0 | 45.2 |
| | 7940 | | 9650 | | 525D | | | | | | |
| 329 | Surlyn | 39.5 | Surlyn | 39.5 | Fusabond | 21 | | | 88.3 | 61.0 | 42.4 |
| | 7940 | | 9650 | | 525D | | | | | | |
| 330 | Surlyn | 38 | Surlyn | 38 | Fusabond | 24 | | | 85.9 | 57.7 | 37.9 |
| | 7940 | | 9650 | | 525D | | | | | | |
| 331 | Surlyn | 36.5 | Surlyn | 36.5 | Fusabond | 27 | | | 84.9 | 57.6 | 35.2 |
| | 7940 | | 9650 | | 525D | | | | | | |
| 332 | Surlyn | 35 | Surlyn | 35 | Fusabond | 30 | | | 82.9 | 55.9 | 30.3 |
| | 7940 | | 9650 | | 525D | | | | | | |
| 333 | Surlyn | 45 | Surlyn | 45 | Fusabond | 10 | | | 90.5 | 63.0 | 54.9 |
| | 7940 | | 9650 | | 525D | | | | | | |
| 334 | Surlyn | 38 | Surlyn | 38 | Fusabond | 24 | | | 86.5 | 57.6 | 34.6 |
| | 8945 | | 9650 | | 525D | | | | | | |
| 335 | Surlyn | 36.9 | Surlyn | 36.9 | Fusabond | 23.3 | Luzenac | | 88.3 | 60.6 | 43.3 |
| | 8945 | | 9650 | | 525D | | HAR T-84 | | | | |
| | | | | | | | (3 wt %) | | | | |
| 336 | Surlyn | 35.7 | Surlyn | 35.7 | Fusabond | 22.6 | Luzenac | | 87.6 | 59.9 | 43.2 |
| | 8945 | | 9650 | | 525D | | HAR T-84 | | | | |
| | | | | | | | (6 wt %) | | | | |
| 337 | Surlyn | 34.6 | Surlyn | 34.6 | Fusabond | 21.8 | Luzenac | | 87.7 | 60.6 | 63.8 |
| | 8945 | | 9650 | | 525D | | HAR T-84 | | | | |
| | | | | | | | (9 wt %) | | | | |
| 338 | Surlyn | 33.8 | Surlyn | 33.8 | Fusabond | 21.4 | Luzenac | | 87.9 | 60.2 | 54.2 |
| | 8945 | | 9650 | | 525D | | HAR T-84 | | | | |
| | | | | | | | (11 wt %)) | | | | |
| 339 | Surlyn | 36.9 | Surlyn | 36.9 | Fusabond | 23.3 | Muscovite | | 85.5 | 58.2 | 33.0 |
| | 8945 | | 9650 | | 525D | | Mica SG | | | | |
| | | | | | | | 90 | | | | |
| | | | | | | | (3 wt %) | | | | |
| 340 | Surlyn | 35.7 | Surlyn | 35.7 | Fusabond | 22.6 | Muscovite | | 84.8 | 57.9 | 36.0 |
| | 8945 | | 9650 | | 525D | | Mica SG | | | | |
| | | | | | | | 90 | | | | |
| | | | | | | | (6 wt %) | | | | |
| 341 | Surlyn | 34.6 | Surlyn | 34.6 | Fusabond | 21.8 | Muscovite | | 87.7 | 60.1 | 38.2 |
| | 8945 | | 9650 | | 525D | | Mica SG | | | | |
| | | | | | | | 90 | | | | |
| | | | | | | | (9 wt %) | | | | |
| 342 | Surlyn | 33.8 | Surlyn | 33.8 | Fusabond | 21.4 | Muscovite | | 86.6 | 59.4 | 39.4 |
| | 8945 | | 9650 | | 525D | | Mica SG | | | | |
| | | | | | | | 90 | | | | |
| | | | | | | | (11 wt %) | | | | |
| 343 | Surlyn | 36.9 | Surlyn | 36.9 | Fusabond | 23.3 | Cloisite | | 87.7 | 59.0 | 45.2 |
| | 8945 | | 9650 | | 525D | | 20A | | | | |
| | | | | | | | (3 wt %) | | | | |
| 344 | Surlyn | 35.7 | Surlyn | 35.7 | Fusabond | 22.6 | Cloisite | | 89.4 | 61.0 | 56.7 |
| | 8945 | | 9650 | | 525D | | 20A | | | | |
| | | | | | | | (6 wt %) | | | | |
| 345 | Surlyn | 34.6 | Surlyn | 34.6 | Fusabond | 21.8 | Cloisite | | 90.6 | 61.8 | 68.5 |
| | 8945 | | 9650 | | 525D | | 20A | | | | |
| | | | | | | | (9 wt %) | | | | |
| 346 | Surlyn | 33.8 | Surlyn | 33.8 | Fusabond | 21.3 | Cloisite | | 90.5 | 62.0 | 72.3 |
| | 8945 | | 9650 | | 525D | | 20A | | | | |
| | | | | | | | (11.1 wt %) | | | | |
| 347 | Surlyn | 36.9 | Surlyn | 36.9 | Fusabond | 23.3 | Suzorite | | 86.7 | 59.1 | 38.0 |
| | 8945 | | 9650 | | 525D | | Mica 200- | | | | |
| | | | | | | | PE | | | | |
| | | | | | | | (3 wt %) | | | | |
| 348 | Surlyn | 35.7 | Surlyn | 35.7 | Fusabond | 22.6 | Suzorite | | 87.4 | 59.9 | 43.0 |
| | 8945 | | 9650 | | 525D | | Mica 200- | | | | |
| | | | | | | | PE (6 wt %) | | | | |
| 349 | Surlyn | 34.6 | Surlyn | 34.6 | Fusabond | 21.8 | Suzorite | | 87.9 | 60.9 | 45.8 |
| | 8945 | | 9650 | | 525D | | Mica 200- | | | | |
| | | | | | | | PE | | | | |
| | | | | | | | (9 wt %) | | | | |
| 350 | Surlyn | 33.8 | Surlyn | 33.8 | Fusabond | 21.4 | Suzorite | | 88.1 | 60.9 | 51.9 |
| | 8945 | | 9650 | | 525D | | Mica 200- | | | | |
| | | | | | | | PE | | | | |
| | | | | | | | (11 wt %) | | | | |
| 351 | Surlyn | 36.9 | Surlyn | 36.9 | Fusabond | 23.3 | Raven | | 87.8 | 59.7 | 42.2 |
| | 8945 | | 9650 | | 525D | | 2500 | | | | |
| | | | | | | | (3 wt %) | | | | |
| 352 | Surlyn | 35.7 | Surlyn | 35.7 | Fusabond | 22.6 | Raven | | 88.6 | 60.3 | 46.3 |
| | 8945 | | 9650 | | 525D | | 2500 | | | | |
| | | | | | | | (6 wt %) | | | | |
| 353 | Surlyn | 34.6 | Surlyn | 34.6 | Fusabond | 21.8 | Raven | | 88.6 | 61.2 | 52.0 |
| | 8945 | | 9650 | | 525D | | 2500 | | | | |
| | | | | | | | (9 wt %) | | | | |
| 354 | Surlyn | 33.8 | Surlyn | 33.8 | Fusabond | 21.4 | Raven | | 88.9 | 61.0 | 55.5 |
| | 8945 | | 9650 | | 525D | | 2500 | | | | |
| | | | | | | | (11 wt %) | | | | |
| 355 | Surlyn | 36.9 | Surlyn | 36.9 | Fusabond | 23.3 | Raven | | 86.7 | 58.6 | 46.4 |
| | 8945 | | 9650 | | 525D | | 1170 | | | | |
| | | | | | | | (3 wt %) | | | | |
| 356 | Surlyn | 35.7 | Surlyn | 35.7 | Fusabond | 22.6 | Raven | | 87.5 | 59.8 | 45.8 |
| | 8945 | | 9650 | | 525D | | 1170 | | | | |
| | | | | | | | (6 wt %) | | | | |
| 357 | Surlyn | 34.6 | Surlyn | 34.6 | Fusabond | 21.8 | Raven | | 88.1 | 60.0 | 49.4 |
| | 8945 | | 9650 | | 525D | | 1170 | | | | |
| | | | | | | | (9 wt %) | | | | |
| 358 | Surlyn | 33.8 | Surlyn | 33.8 | Fusabond | 21.4 | Raven | | 88.7 | 61.1 | 59.2 |
| | 8945 | | 9650 | | 525D | | 1170 | | | | |
| | | | | | | | (11 wt %) | | | | |
| 359 | Surlyn | 37 | Surlyn | 37 | Fusabond | 26 | | | 87.1 | 57.3 | 39.0 |
| | 7940 | | 9650 | | 525D | | | | | | |
| 360 | Surlyn | 35.9 | Surlyn | 35.9 | Fusabond | 25.2 | Cloisite | | 88.0 | 59.0 | 43.7 |
| | 7940 | | 9650 | | 525D | | 20A | | | | |
| | | | | | | | (3 wt %) | | | | |
| 361 | Surlyn | 34.8 | Surlyn | 34.8 | Fusabond | 24.4 | Cloisite | | 88.3 | 59.8 | 50.2 |
| | 7940 | | 9650 | | 525D | | 20A | | | | |
| | | | | | | | (6 wt %) | | | | |
| 362 | Surlyn | 33.7 | Surlyn | 33.7 | Fusabond | 23.7 | Cloisite | | 88.5 | 59.7 | 52.8 |
| | 7940 | | 9650 | | 525D | | 20A | | | | |
| | | | | | | | (9 wt %) | | | | |
| 363 | Surlyn | 32.9 | Surlyn | 32.9 | Fusabond | 23.1 | Cloisite | | 88.8 | 60.1 | 57.9 |
| | 7940 | | 9650 | | 525D | | 20A | | | | |
| | | | | | | | (11 wt %) | | | | |
| 364 | Surlyn | 39 | Surlyn | 39 | Fusabond | 22 | | | 84.6 | 55.5 | 31.4 |
| | 8528 | | 9650 | | 525D | | | | | | |
| 365 | Surlyn | 37.8 | Surlyn | 37.8 | Fusabond | 21.3 | Cloisite | | 86.0 | 57.1 | 43.6 |
| | 8528 | | 9650 | | 525D | | 20A | | | | |
| | | | | | | | (3 wt %) | | | | |
| 366 | Surlyn | 36.7 | Surlyn | 36.7 | Fusabond | 20.7 | Cloisite | | 86.9 | 58.4 | 48.6 |
| | 8528 | | 9650 | | 525D | | 20A | | | | |
| | | | | | | | (6 wt %) | | | | |
| 367 | Surlyn | 35.5 | Surlyn | 35.5 | Fusabond | 20 | Cloisite | | 87.5 | 59.2 | 58.7 |
| | 8528 | | 9650 | | 525D | | 20A | | | | |
| | | | | | | | (9 wt %) | | | | |
| 368 | Surlyn | 34.7 | Surlyn | 34.7 | Fusabond | 19.6 | Cloisite | | 88.0 | 59.5 | 65.7 |
| | 8528 | | 9650 | | 525D | | 20A | | | | |
| | | | | | | | (11 wt %) | | | | |
| 369 | Surlyn | 35.7 | Surlyn | 35.7 | Fusabond | 22.6 | Mayan | | 83.9 | 56.7 | 35.9 |
| | 8945 | | 9650 | | 525D | | Pigments | | | | |
| | | | | | | | Mica | | | | |
| | | | | | | | (6 wt %) | | | | |
| 370 | Surlyn | 36.9 | Surlyn | 36.9 | Fusabond | 23.3 | NanoMax | | 86.9 | 57.5 | 45.0 |
| | 8945 | | 9650 | | 525D | | I.31PS | | | | |
| | | | | | | | (3 wt %) | | | | |
| 371 | Surlyn | 35.7 | Surlyn | 35.7 | Fusabond | 22.6 | NanoMax | | 88.2 | 58.8 | 52.4 |
| | 8945 | | 9650 | | 525D | | I.31PS | | | | |
| | | | | | | | (6 wt %) | | | | |
| 372 | Surlyn | 34.6 | Surlyn | 34.6 | Fusabond | 21.8 | NanoMax | | 88.2 | 59.0 | 56.2 |
| | 8945 | | 9650 | | 525D | | I.31PS | | | | |
| | | | | | | | (9 wt %) | | | | |
| 373 | Surlyn | 33.4 | Surlyn | 33.4 | Fusabond | 21.1 | NanoMax | | 89.4 | 60.3 | 65.5 |
| | 8945 | | 9650 | | 525D | | I.31PS | | | | |
| | | | | | | | (12 wt %) | | | | |
| 374 | Surlyn | 36.9 | Surlyn | 36.9 | Fusabond | 23.3 | NanoMax | | 87.9 | 60.7 | 47.9 |
| | 8945 | | 9650 | | 525D | | I.44P | | | | |
| | | | | | | | (3 wt %) | | | | |
| 375 | Surlyn | 35.7 | Surlyn | 35.7 | Fusabond | 22.6 | NanoMax | | 88.1 | 60.7 | 57.2 |
| | 8945 | | 9650 | | 525D | | I.44P | | | | |
| | | | | | | | (6 wt %) | | | | |
| 376 | Surlyn | 34.6 | Surlyn | 34.6 | Fusabond | 21.8 | NanoMax | | 89.0 | 61.8 | 64.3 |
| | 8945 | | 9650 | | 525D | | I.44P | | | | |
| | | | | | | | (9 wt %) | | | | |
| 377 | Surlyn | 33.4 | Surlyn | 33.4 | Fusabond | 21.1 | NanoMax | | 89.7 | 62.0 | 74.1 |
| | 8945 | | 9650 | | 525D | | I.44P | | | | |
| | | | | | | | (12 wt %) | | | | |
| 378 | Surlyn | 21 | Surlyn | 48 | Fusabond | 22 | Luzenac | | 86.5 | 59.6 | 56.0 |
| | 8945 | | 9650 | | 525D | | HAR T-84 | | | | |
| | | | | | | | Talc | | | | |
| | | | | | | | (9 wt %) | | | | |
| 379 | Surlyn | 15 | Surlyn | 52 | Fusabond | 21 | Luzenac | | 87.6 | 59.4 | 62.8 |
| | 8945 | | 9650 | | 525D | | HAR T-84 | | | | |
| | | | | | | | Talc | | | | |
| | | | | | | | (12 wt %) | | | | |
| 380 | Surlyn | 34.6 | Surlyn | 34.6 | Fusabond | 21.8 | Luzenac | | 87.3 | 58.7 | 52.5 |
| | 8945 | | 9650 | | 525D | | HAR T-84 | | | | |
| | | | | | | | Talc | | | | |
| | | | | | | | (9 wt %) | | | | |
| 381 | Surlyn | 33.8 | Surlyn | 33.8 | Fusabond | 21.4 | Luzenac | | 88.0 | 59.6 | 59.1 |
| | 8945 | | 9650 | | 525D | | HAR T-84 | | | | |
| | | | | | | | Talc | | | | |
| | | | | | | | (11 wt %) | | | | |
| 382 | Surlyn | 37.8 | Surlyn | 37.8 | Fusabond | 21.3 | Cloisite | | 85.3 | 58.1 | 45.5 |
| | 8528 | | 9650 | | 525D | | 20A | | | | |
| | | | | | | | (3 wt %) | | | | |
| 383 | Surlyn | 35.5 | Surlyn | 35.5 | Fusabond | 20 | Cloisite | | 86.6 | 59.1 | 56.5 |
| | 8528 | | 9650 | | 525D | | 20A | | | | |
| | | | | | | | (9 wt %) | | | | |
| 384 | Surlyn | 35.7 | Surlyn | 35.7 | Fusabond | 22.6 | NanoMax | | 88.1 | 59.1 | * |
| | 8945 | | 9650 | | 525D | | I.44P | | | | |
| | | | | | | | (6 wt %) | | | | |
| 385 | Surlyn | 33.4 | Surlyn | 33.4 | Fusabond | 21.1 | NanoMax | | * | * | * |
| | 8945 | | 9650 | | 525D | | I.31PS | | | | |
| | | | | | | | (12 wt %) | | | | |
| 386 | Surlyn | 34.7 | Surlyn | 34.7 | Fusabond | 19.6 | Cloisite | | * | * | * |
| | 8528 | | 9650 | | 525D | | 20A | | | | |
| | | | | | | | (11 wt %) | | | | |
| 387 | Surlyn | 34.7 | Surlyn | 34.7 | Fusabond | 19.6 | Cloisite | Aktiplast | * | * | * |
| | 8528 | | 9650 | | 525D | | 20A | PP | | | |
| | | | | | | | (11 wt %) | (10 pph) | | | |
| 388 | Surlyn | 34.7 | Surlyn | 34.7 | Fusabond | 19.6 | Cloisite | Aktiplast | * | * | * |
| | 8528 | | 9650 | | 525D | | 20A | PP | | | |
| | | | | | | | (11 wt %) | (2 pph) | | | |
| 389 | Surlyn | 34.7 | Surlyn | 34.7 | Fusabond | 19.6 | Cloisite | Aktiplast | * | * | * |
| | 8528 | | 9650 | | 525D | | 20A | PP | | | |
| | | | | | | | (11 wt %) | (5 pph) | | | |
| 390 | Surlyn | 34.2 | Surlyn | 34.2 | Fusabond | 19.3 | Cloisite | Kemamide | * | * | * |
| | 8528 | | 9650 | | 525D | | 20A | W-40 | | | |
| | | | | | | | (11.4 wt %) | (1 wt %) | | | |
| 391 | Surlyn | 33.8 | Surlyn | 33.8 | Fusabond | 19.1 | Cloisite | Kemamide | * | * | * |
| | 8528 | | 9650 | | 525D | | 20A | W-40 | | | |
| | | | | | | | (11.3 wt %) | (2 wt %) | | | |
| 392 | Surlyn | 33.5 | Surlyn | 33.5 | Fusabond | 18.9 | Cloisite | Kemamide | * | * | * |
| | 8528 | | 9650 | | 525D | | 20A | W-40 | | | |
| | | | | | | | (11.2 wt %) | (3 wt %) | | | |
| 393 | Surlyn | 36.9 | Surlyn | 36.9 | Fusabond | 23.3 | Luzenac | | * | * | * |
| | 8945 | | 9650 | | 525D | | HAR T-84 | | | | |
| | | | | | | | Talc | | | | |
| | | | | | | | (3 wt %) | | | | |
| 394 | Surlyn | 35.7 | Surlyn | 35.7 | Fusabond | 22.6 | Luzenac | | * | * | * |
| | 8945 | | 9650 | | 525D | | HAR T-84 | | | | |
| | | | | | | | Talc | | | | |
| | | | | | | | (6 wt %) | | | | |
| 395 | Surlyn | 34.6 | Surlyn | 34.6 | Fusabond | 21.8 | Luzenac | | * | * | * |
| | 8945 | | 9650 | | 525D | | HAR T-84 | | | | |
| | | | | | | | Talc | | | | |
| | | | | | | | (9 wt %) | | | | |
| 396 | Surlyn | 33.7 | Surlyn | 33.7 | Fusabond | 21.3 | Luzenac | | * | * | * |
| | 8945 | | 9650 | | 525D | | HAR T-84 | | | | |
| | | | | | | | Talc | | | | |
| | | | | | | | (11.2 wt %) | | | | |
| 397 | Surlyn | 34 | Surlyn | 34 | Fusabond | 32 | | | * | * | * |
| | 8945 | | 9650 | | 525D | | | | | | |
| 398 | Surlyn | 32.6 | Surlyn | 32.6 | Fusabond | 30.7 | Cloisite | | * | * | * |
| | 8945 | | 9650 | | 525D | | 20A | | | | |
| | | | | | | | (4 wt %) | | | | |
| 399 | Surlyn | 32 | Surlyn | 32 | Fusabond | 30 | Cloisite | | * | * | * |
| | 8945 | | 9650 | | 525D | | 20A | | | | |
| | | | | | | | (6 wt %) | | | | |
| 400 | Surlyn | 31.3 | Surlyn | 31.3 | Fusabond | 29.4 | Cloisite | | * | * | * |
| | 8945 | | 9650 | | 525D | | 20A | | | | |
| | | | | | | | (8 wt %) | | | | |
| 401 | Surlyn | 30.5 | Surlyn | 30.5 | Fusabond | 28.7 | Cloisite | | * | * | * |
| | 8945 | | 9650 | | 525D | | 20A | | | | |
| | | | | | | | (10.2 wt %) | | | | |
| 402 | Surlyn | 33 | Surlyn | 33 | Fusabond | 34 | | | * | * | * |
| | 7940 | | 9650 | | 525D | | | | | | |
| 403 | Surlyn | 31.7 | Surlyn | 31.7 | Fusabond | 32.6 | Cloisite | | * | * | * |
| | 7940 | | 9650 | | 525D | | 20A | | | | |
| | | | | | | | (4 wt %) | | | | |
| 404 | Surlyn | 31 | Surlyn | 31 | Fusabond | 32 | Cloisite | | * | * | * |
| | 7940 | | 9650 | | 525D | | 20A | | | | |
| | | | | | | | (6 wt %) | | | | |
| 405 | Surlyn | 30.4 | Surlyn | 30.4 | Fusabond | 31.3 | Cloisite | | * | * | * |
| | 7940 | | 9650 | | 525D | | 20A | | | | |
| | | | | | | | (8 wt %) | | | | |
| 406 | Surlyn | 29.7 | Surlyn | 29.7 | Fusabond | 30.6 | Cloisite | | * | * | * |
| | 7940 | | 9650 | | 525D | | 20A | | | | |
| | | | | | | | (10 wt %) | | | | |
| 407 | Surlyn | 35 | Surlyn | 35 | Fusabond | 30 | | | * | * | * |
| | 8528 | | 9650 | | 525D | | | | | | |
| 408 | Surlyn | 33.6 | Surlyn | 33.6 | Fusabond | 28.8 | Cloisite | | * | * | * |
| | 8528 | | 9650 | | 525D | | 20A | | | | |
| | | | | | | | (4 wt %) | | | | |
| 409 | Surlyn | 32.9 | Surlyn | 32.9 | Fusabond | 28.2 | Cloisite | | * | * | * |
| | 8528 | | 9650 | | 525D | | 20A | | | | |
| | | | | | | | (6 wt %) | | | | |
| 410 | Surlyn | 32.2 | Surlyn | 32.2 | Fusabond | 27.6 | Cloisite | | * | * | * |
| | 8528 | | 9650 | | 525D | | 20A | | | | |
| | | | | | | | (8 wt %) | | | | |
| 411 | Surlyn | 31.4 | Surlyn | 31.4 | Fusabond | 26.9 | Cloisite | | * | * | * |
| | 8528 | | 9650 | | 525D | | 20A | | | | |
| | | | | | | | (10.3 wt %) | | | | |
| 412 | Surlyn | 32.6 | Surlyn | 32.6 | Fusabond | 30.7 | Luzenac | | * | * | * |
| | 8945 | | 9650 | | 525D | | HAR T-84 | | | | |
| | | | | | | | Talc | | | | |
| | | | | | | | (4 wt %) | | | | |
| 413 | Surlyn | 32 | Surlyn | 32 | Fusabond | 30.1 | Luzenac | | * | * | * |
| | 8945 | | 9650 | | 525D | | HAR T-84 | | | | |
| | | | | | | | Talc | | | | |
| | | | | | | | (6 wt %) | | | | |
| 414 | Surlyn | 31.3 | Surlyn | 31.3 | Fusabond | 29.4 | Luzenac | | * | * | * |
| | 8945 | | 9650 | | 525D | | HAR T-84 | | | | |
| | | | | | | | Talc | | | | |
| | | | | | | | (8 wt %) | | | | |
| 415 | Surlyn | 30.5 | Surlyn | 30.5 | Fusabond | 28.7 | Luzenac | | * | * | * |
| | 8945 | | 9650 | | 525D | | HAR T-84 | | | | |
| | | | | | | | Talc | | | | |
| | | | | | | | (10.3 wt %) | | | | |
| 416 | Surlyn | 31.7 | Surlyn | 31.7 | Fusabond | 32.6 | Luzenac | | * | * | * |
| | 7940 | | 9650 | | 525D | | HAR T-84 | | | | |
| | | | | | | | Talc | | | | |
| | | | | | | | (4 wt %) | | | | |
| 417 | Surlyn | 31 | Surlyn | 31 | Fusabond | 32 | Luzenac | | * | * | * |
| | 7940 | | 9650 | | 525D | | HAR T-84 | | | | |
| | | | | | | | Talc | | | | |
| | | | | | | | (6 wt %) | | | | |
| 418 | Surlyn | 30.4 | Surlyn | 30.4 | Fusabond | 31.3 | Luzenac | | * | * | * |
| | 7940 | | 9650 | | 525D | | HAR T-84 | | | | |
| | | | | | | | Talc | | | | |
| | | | | | | | (8 wt %) | | | | |
| 419 | Surlyn | 29.7 | Surlyn | 29.7 | Fusabond | 30.6 | Luzenac | | * | * | * |
| | 7940 | | 9650 | | 525D | | HAR T-84 | | | | |
| | | | | | | | Talc | | | | |
| | | | | | | | (10 wt %) | | | | |
| 420 | Surlyn | 33.6 | Surlyn | 33.6 | Fusabond | 28.8 | Luzenac | | * | * | * |
| | 8528 | | 9650 | | 525D | | HAR T-84 | | | | |
| | | | | | | | Talc | | | | |
| | | | | | | | (4 wt %) | | | | |
| 421 | Surlyn | 32.9 | Surlyn | 32.9 | Fusabond | 28.2 | Luzenac | | * | * | * |
| | 8528 | | 9650 | | 525D | | HAR T-84 | | | | |
| | | | | | | | Talc | | | | |
| | | | | | | | (6 wt %) | | | | |
| 422 | Surlyn | 32.2 | Surlyn | 32.2 | Fusabond | 27.6 | Luzenac | | * | * | * |
| | 8528 | | 9650 | | 525D | | HAR T-84 | | | | |
| | | | | | | | Talc | | | | |
| | | | | | | | (8 wt %) | | | | |
| 423 | Surlyn | 31.4 | Surlyn | 31.4 | Fusabond | 26.9 | Luzenac | | * | * | * |
| | 8528 | | 9650 | | 525D | | HAR T-84 | | | | |
| | | | | | | | Talc | | | | |
| | | | | | | | (10.3 wt %) | | | | |
| 424 | Surlyn | 32 | Surlyn | 32 | Fusabond | 30 | NanoMax | | * | * | * |
| | 8945 | | 9650 | | 525D | | I.31PS | | | | |
| | | | | | | | (6 wt %) | | | | |
| 425 | Surlyn | 30.9 | Surlyn | 30.9 | Fusabond | 29.1 | NanoMax | | * | * | * |
| | 8945 | | 9650 | | 525D | | I.31PS | | | | |
| | | | | | | | (9 wt %) | | | | |
| 426 | Surlyn | 29.9 | Surlyn | 29.9 | Fusabond | 28.2 | NanoMax | | * | * | * |
| | 8945 | | 9650 | | 525D | | I.31PS | | | | |
| | | | | | | | (12 wt %) | | | | |
| 427 | Surlyn | 28.9 | Surlyn | 28.9 | Fusabond | 27.2 | NanoMax | | * | * | * |
| | 8945 | | 9650 | | 525D | | I.31PS | | | | |
| | | | | | | | (15 wt %) | | | | |
| 428 | Surlyn | 32 | Surlyn | 32 | Fusabond | 30 | NanoMax | | * | * | * |
| | 8945 | | 9650 | | 525D | | I.44P | | | | |
| | | | | | | | (6 wt %) | | | | |
| 429 | Surlyn | 30.9 | Surlyn | 30.9 | Fusabond | 29.1 | NanoMax | | * | * | * |
| | 8945 | | 9650 | | 525D | | I.44P | | | | |
| | | | | | | | (9 wt %) | | | | |
| 430 | Surlyn | 29.9 | Surlyn | 29.9 | Fusabond | 28.2 | NanoMax | | * | * | * |
| | 8945 | | 9650 | | 525D | | I.44P | | | | |
| | | | | | | | (12 wt %) | | | | |
| 431 | Surlyn | 28.9 | Surlyn | 28.9 | Fusabond | 27.2 | NanoMax | | * | * | * |
| | 8945 | | 9650 | | 525D | | I.44P | | | | |
| | | | | | | | (15 wt %) | | | | |
| 432 | Surlyn | 32.6 | Surlyn | 32.6 | Fusabond | 30.7 | Muscovite | | * | * | * |
| | 8945 | | 9650 | | 525D | | Mica SG90 | | | | |
| | | | | | | | (4 wt %) | | | | |
| 433 | Surlyn | 32 | Surlyn | 32 | Fusabond | 30 | Muscovite | | * | * | * |
| | 8945 | | 9650 | | 525D | | Mica SG90 | | | | |
| | | | | | | | (6 wt %) | | | | |
| 434 | Surlyn | 31.3 | Surlyn | 31.3 | Fusabond | 29.4 | Muscovite | | * | * | * |
| | 8945 | | 9650 | | 525D | | Mica SG90 | | | | |
| | | | | | | | (8 wt %) | | | | |
| 435 | Surlyn | 30.5 | Surlyn | 30.5 | Fusabond | 28.7 | Muscovite | | * | * | * |
| | 8945 | | 9650 | | 525D | | Mica SG90 | | | | |
| | | | | | | | (10.2 wt %) | | | | |
| 436 | Surlyn | 32.6 | Surlyn | 32.6 | Fusabond | 30.7 | Suzorite | | * | * | * |
| | 8945 | | 9650 | | 525D | | Mica 200- | | | | |
| | | | | | | | PE | | | | |
| | | | | | | | (4 wt %) | | | | |
| 437 | Surlyn | 32 | Surlyn | 32 | Fusabond | 30 | Suzorite | | * | * | * |
| | 8945 | | 9650 | | 525D | | Mica 200- | | | | |
| | | | | | | | PE | | | | |
| | | | | | | | (6 wt %) | | | | |
| 438 | Surlyn | 31.3 | Surlyn | 31.3 | Fusabond | 29.4 | Suzorite | | * | * | * |
| | 8945 | | 9650 | | 525D | | Mica 200- | | | | |
| | | | | | | | PE | | | | |
| | | | | | | | (8 wt %) | | | | |
| 439 | Surlyn | 30.5 | Surlyn | 30.5 | Fusabond | 28.8 | Suzorite | | * | * | * |
| | 8945 | | 9650 | | 525D | | Mica 200- | | | | |
| | | | | | | | PE | | | | |
| | | | | | | | (10.2 wt %) | | | | |
| 440 | Surlyn | 32.6 | Surlyn | 32.6 | Fusabond | 30.7 | Raven | | * | * | * |
| | 8945 | | 9650 | | 525D | | 2500 | | | | |
| | | | | | | | (4 wt %) | | | | |
| 441 | Surlyn | 32 | Surlyn | 32 | Fusabond | 30 | Raven | | * | * | * |
| | 8945 | | 9650 | | 525D | | 2500 | | | | |
| | | | | | | | (6 wt %) | | | | |
| 442 | Surlyn | 31.3 | Surlyn | 31.3 | Fusabond | 29.4 | Raven | | * | * | * |
| | 8945 | | 9650 | | 525D | | 2500 | | | | |
| | | | | | | | (8 wt %) | | | | |
| 443 | Surlyn | 30.5 | Surlyn | 30.5 | Fusabond | 28.7 | Raven | | * | * | * |
| | 8945 | | 9650 | | 525D | | 2500 | | | | |
| | | | | | | | (10.2 wt %) | | | | |
| 444 | Surlyn | 32.6 | Surlyn | 32.6 | Fusabond | 30.7 | Raven | | * | * | * |
| | 8945 | | 9650 | | 525D | | 1170 | | | | |
| | | | | | | | (4 wt %) | | | | |
| 445 | Surlyn | 32 | Surlyn | 32 | Fusabond | 30 | Raven | | * | * | * |
| | 8945 | | 9650 | | 525D | | 1170 | | | | |
| | | | | | | | (6 wt %) | | | | |
| 446 | Surlyn | 31.3 | Surlyn | 31.3 | Fusabond | 29.4 | Raven | | * | * | * |
| | 8945 | | 9650 | | 525D | | 1170 | | | | |
| | | | | | | | (8 wt %) | | | | |
| 447 | Surlyn | 30.5 | Surlyn | 30.5 | Fusabond | 28.7 | Raven | | * | * | * |
| | 8945 | | 9650 | | 525D | | 1170 | | | | |
| | | | | | | | (10.2 wt %) | | | | |
| 448 | Surlyn | 14 | Surlyn | 56 | Fusabond | 30 | | | * | * | * |
| | 8945 | | 9650 | | 525D | | | | | | |
| 449 | Surlyn | 13.4 | Surlyn | 53.8 | Fusabond | 28.8 | Cloisite | | * | * | * |
| | 8945 | | 9650 | | 525D | | 20A | | | | |
| | | | | | | | (4 wt %) | | | | |
| 450 | Surlyn | 13.4 | Surlyn | 53.8 | Fusabond | 28.8 | Luzenac | | * | * | * |
| | 8945 | | 9650 | | 525D | | HAR T-84 | | | | |
| | | | | | | | Talc | | | | |
| | | | | | | | (4 wt %) | | | | |
| 451 | Surlyn | 12.9 | Surlyn | 51.5 | Fusabond | 27.6 | Cloisite | | * | * | * |
| | 8945 | | 9650 | | 525D | | 20A | | | | |
| | | | | | | | (8 wt %) | | | | |
| 452 | Surlyn | 12.9 | Surlyn | 51.5 | Fusabond | 27.6 | Luzenac | | * | * | * |
| | 8945 | | 9650 | | 525D | | HAR T-84 | | | | |
| | | | | | | | Talc | | | | |
| | | | | | | | (8 wt %) | | | | |
| 453 | Surlyn | 12.3 | Surlyn | 49.3 | Fusabond | 26.4 | Cloisite | | * | * | * |
| | 8945 | | 9650 | | 525D | | 20A | | | | |
| | | | | | | | (12 wt %) | | | | |
| 454 | Surlyn | 12.3 | Surlyn | 49.3 | Fusabond | 26.4 | Luzenac | | * | * | * |
| | 8945 | | 9650 | | 525D | | HAR T-84 | | | | |
| | | | | | | | Talc | | | | |
| | | | | | | | (12 wt %) | | | | |
| 455 | Surlyn | 11.8 | Surlyn | 47.2 | Fusabond | 25.3 | Cloisite | | * | * | * |
| | 8945 | | 9650 | | 525D | | 20A | | | | |
| | | | | | | | (15.7 wt %) | | | | |
| 456 | Surlyn | 11.8 | Surlyn | 47.2 | Fusabond | 25.3 | Luzenac | | * | * | * |
| | 8945 | | 9650 | | 525D | | HAR T-84 | | | | |
| | | | | | | | Talc | | | | |
| | | | | | | | (15.7 wt %) | | | | |
| 457 | Surlyn | 32.6 | Surlyn | 32.6 | Fusabond | 30.7 | Cloisite | | * | * | * |
| | 8945 | | 9650 | | 525D | | 30B | | | | |
| | | | | | | | (4 wt %) | | | | |
| 458 | Surlyn | 32 | Surlyn | 32 | Fusabond | 30.1 | Cloisite | | * | * | * |
| | 8945 | | 9650 | | 525D | | 30B | | | | |
| | | | | | | | (6 wt %) | | | | |
| 459 | Surlyn | 31.3 | Surlyn | 31.3 | Fusabond | 29.4 | Cloisite | | * | * | * |
| | 8945 | | 9650 | | 525D | | 30B | | | | |
| | | | | | | | (8 wt %) | | | | |
| 460 | Surlyn | 30.5 | Surlyn | 30.5 | Fusabond | 28.7 | Cloisite | | * | * | * |
| | 8945 | | 9650 | | 525D | | 30B | | | | |
| | | | | | | | (10.2 wt %) | | | | |
| 461 | Surlyn | 14 | Surlyn | 54 | Fusabond | 32 | | | * | * | * |
| | 7940 | | 9650 | | 525D | | | | | | |
| 462 | Surlyn | 13.4 | Surlyn | 51.8 | Fusabond | 30.7 | Cloisite | | * | * | * |
| | 7940 | | 9650 | | 525D | | 20A | | | | |
| | | | | | | | (4 wt %) | | | | |
| 463 | Surlyn | 12.9 | Surlyn | 49.7 | Fusabond | 29.4 | Cloisite | | * | * | * |
| | 7940 | | 9650 | | 525D | | 20A | | | | |
| | | | | | | | (8 wt %) | | | | |
| 464 | Surlyn | 12.3 | Surlyn | 47.5 | Fusabond | 28.2 | Cloisite | | * | * | * |
| | 7940 | | 9650 | | 525D | | 20A | | | | |
| | | | | | | | (12 wt %) | | | | |
| 465 | Surlyn | 11.9 | Surlyn | 45.8 | Fusabond | 27.1 | Cloisite | | * | * | * |
| | 7940 | | 9650 | | 525D | | 20A | | | | |
| | | | | | | | (15.2 wt %) | | | | |
| 466 | Surlyn | 13.4 | Surlyn | 51.8 | Fusabond | 30.7 | Luzenac | | * | * | * |
| | 7940 | | 9650 | | 525D | | HAR T-84 | | | | |
| | | | | | | | Talc | | | | |
| | | | | | | | (4 wt %) | | | | |
| 467 | Surlyn | 12.9 | Surlyn | 49.7 | Fusabond | 29.4 | Luzenac | | * | * | * |
| | 7940 | | 9650 | | 525D | | HAR T-84 | | | | |
| | | | | | | | Talc | | | | |
| | | | | | | | (8 wt %) | | | | |
| 468 | Surlyn | 12.3 | Surlyn | 47.5 | Fusabond | 28.2 | Luzenac | | * | * | * |
| | 7940 | | 9650 | | 525D | | HAR T-84 | | | | |
| | | | | | | | Talc | | | | |
| | | | | | | | (12 wt %) | | | | |
| 469 | Surlyn | 11.9 | Surlyn | 45.8 | Fusabond | 27.1 | Luzenac | | * | * | * |
| | 7940 | | 9650 | | 525D | | HAR T-84 | | | | |
| | | | | | | | Talc | | | | |
| | | | | | | | (15.2 wt %) | | | | |
| 470 | Surlyn | 14 | Surlyn | 56 | Fusabond | 30 | | | * | * | * |
| | 8528 | | 9650 | | 525D | | | | | | |
| 471 | Surlyn | 13.4 | Surlyn | 53.8 | Fusabond | 28.8 | Cloisite | | * | * | * |
| | 8528 | | 9650 | | 525D | | 20A | | | | |
| | | | | | | | (4 wt %) | | | | |
| 472 | Surlyn | 12.9 | Surlyn | 51.5 | Fusabond | 27.6 | Cloisite | | * | * | * |
| | 8528 | | 9650 | | 525D | | 20A | | | | |
| | | | | | | | (8 wt %) | | | | |
| 473 | Surlyn | 12.3 | Surlyn | 49.3 | Fusabond | 26.4 | Cloisite | | * | * | * |
| | 8528 | | 9650 | | 525D | | 20A | | | | |
| | | | | | | | (12 wt %) | | | | |
| 474 | Surlyn | 11.8 | Surlyn | 47.2 | Fusabond | 25.3 | Cloisite | | * | * | * |
| | 8528 | | 9650 | | 525D | | 20A | | | | |
| | | | | | | | (15.7 wt %) | | | | |
| 475 | Surlyn | 13.2 | Surlyn | 52.6 | Fusabond | 28.2 | Luzenac | | * | * | * |
| | 8528 | | 9650 | | 525D | | HAR T-84 | | | | |
| | | | | | | | Talc | | | | |
| | | | | | | | (6 wt %) | | | | |
| 476 | Surlyn | 12.7 | Surlyn | 51 | Fusabond | 27.3 | Luzenac | | * | * | * |
| | 8528 | | 9650 | | 525D | | HAR T-84 | | | | |
| | | | | | | | Talc | | | | |
| | | | | | | | (9 wt %) | | | | |
| 477 | Surlyn | 12.3 | Surlyn | 49.3 | Fusabond | 26.4 | Luzenac | | * | * | * |
| | 8528 | | 9650 | | 525D | | HAR T-84 | | | | |
| | | | | | | | Talc | | | | |
| | | | | | | | (12 wt %) | | | | |
| 478 | Surlyn | 11.9 | Surlyn | 47.6 | Fusabond | 25.5 | Luzenac | | * | * | * |
| | 8528 | | 9650 | | 525D | | HAR T-84 | | | | |
| | | | | | | | Talc | | | | |
| | | | | | | | (15 wt %) | | | | |
| 479 | Surlyn | 40 | Surlyn | 40 | Fusabond | 20 | | | * | * | * |
| | 7940 | | 9650 | | 525D | | | | | | |
| 480 | Surlyn | 35.7 | Surlyn | 35.7 | Fusabond | 22.6 | Cloisite | | 86.5 | 58.2 | 38.7 |
| | 8945 | | 9650 | | 525D | | 30B | | | | |
| | | | | | | | (6 wt %) | | | | |
| 481 | Surlyn | 40 | Surlyn | 40 | Fusabond | 20 | | | * | * | * |
| | 7940 | | 9650 | | A560 | | | | | | |
| 482 | Surlyn | 37.5 | Surlyn | 37.5 | Fusabond | 25 | | | * | * | * |
| | 7940 | | 9650 | | A560 | | | | | | |
| 483 | Surlyn | 35 | Surlyn | 35 | Fusabond | 30 | | | * | * | * |
| | 7940 | | 9650 | | A560 | | | | | | |
| 484 | Surlyn | 31.7 | Surlyn | 31.7 | Fusabond | 32.6 | Cloisite | | * | * | * |
| | 7940 | | 9650 | | A560 | | 20A | | | | |
| | | | | | | | (4 wt %) | | | | |
| 485 | Surlyn | 31 | Surlyn | 31 | Fusabond | 32 | Cloisite | | * | * | * |
| | 7940 | | 9650 | | A560 | | 20A | | | | |
| | | | | | | | (6 wt %) | | | | |
| 486 | Surlyn | 30.4 | Surlyn | 30.4 | Fusabond | 31.3 | Cloisite | | * | * | * |
| | 7940 | | 9650 | | A560 | | 20A | | | | |
| | | | | | | | (8 wt %) | | | | |
| 487 | Surlyn | 29.7 | Surlyn | 29.7 | Fusabond | 30.6 | Cloisite | | * | * | * |
| | 7940 | | 9650 | | A560 | | 20A | | | | |
| | | | | | | | (10 wt %) | | | | |
| 488 | Surlyn | 37.5 | Surlyn | 37.5 | Surlyn | 25 | | | 89.6 | 61.4 | 39.3 |
| | 7940 | | 9650 | | 8320 | | | | | | |
| 489 | Surlyn | 35 | Surlyn | 35 | Surlyn | 30 | | | 88.0 | 59.5 | 35.3 |
| | 7940 | | 9650 | | 8320 | | | | | | |
| 490 | Surlyn | 32.5 | Surlyn | 32.5 | Surlyn | 35 | | | 87.5 | 60.0 | 32.5 |
| | 7940 | | 9650 | | 8320 | | | | | | |
| 491 | Surlyn | 25 | Surlyn | 25 | Surlyn | 35 | Luzenac | | * | * | * |
| | 7940 | | 9650 | | 8320 | | HAR T-84 | | | | |
| | | | | | | | (15 wt %) | | | | |
| 492 | Surlyn | 50 | Surlyn | 50 | | | | | 92.8 | 65.9 | 61.4 |
| | 7940 | | 9650 | | | | | | | | |
| 493 | Clarix | 10 | Surlyn | 90 | | | | | 89.4 | 62.7 | * |
| | 5152 | | 9650 | | | | | | | | |
| 494 | Clarix | 30 | Surlyn | 70 | | | | | 90.2 | 63.5 | * |
| | 5152 | | 9650 | | | | | | | | |
| 495 | Clarix | 50 | Surlyn | 50 | | | | | 91.5 | 65.4 | * |
| | 5152 | | 9650 | | | | | | | | |
| 496 | Clarix | 65 | Surlyn | 35 | | | | | 92.5 | 66.1 | * |
| | 5152 | | 9650 | | | | | | | | |
| 497 | Surlyn | 10 | Surlyn | 90 | | | | | 91.4 | 63.8 | 54.0 |
| | 7940 | | 9650 | | | | | | | | |
| 498 | Surlyn | 30 | Surlyn | 70 | | | | | 93.0 | 64.1 | 61.1 |
| | 7940 | | 9650 | | | | | | | | |
| 499 | Surlyn | 65 | Surlyn | 35 | | | | | 92.1 | 65.6 | 64.7 |
| | 7940 | | 9650 | | | | | | | | |
| 500 | Surlyn | 50 | Surlyn | 50 | | | | | * | * | * |
| | 7930 | | 9650 | | | | | | | | |
| 501 | Surlyn | 40 | Surlyn | 40 | Fusabond | 20 | | | 88.3 | 58.9 | 43.3 |
| | 8940 | | 9910 | | 525D | | | | | | |
| 502 | Surlyn | 37.5 | Surlyn | 37.5 | Fusabond | 25 | | | 86.7 | 57.0 | 39.0 |
| | 8940 | | 9910 | | 525D | | | | | | |
| 503 | Surlyn | 35 | Surlyn | 35 | Fusabond | 30 | | | 85.8 | 56.5 | 36.0 |
| | 8940 | | 9910 | | 525D | | | | | | |
| 504 | Surlyn | 40 | Surlyn | 40 | Fusabond | 20 | | | 88.6 | 59.3 | 45.0 |
| | 7940 | | 9910 | | 525D | | | | | | |
| 505 | Surlyn | 37.5 | Surlyn | 37.5 | Fusabond | 25 | | | 87.0 | 58.0 | 39.3 |
| | 7940 | | 9910 | | 525D | | | | | | |
| 506 | Surlyn | 35 | Surlyn | 35 | Fusabond | 30 | | | 85.2 | 56.4 | 35.1 |
| | 7940 | | 9910 | | 525D | | | | | | |
| 507 | Surlyn | 35 | Surlyn | 35 | Fusabond | 30 | | | 84.0 | 58.0 | 31.1 |
| | 8940 | | 9910 | | 525D | | | | | | |
| 508 | Surlyn | 34 | Surlyn | 34 | Fusabond | 29.1 | Cloisite | | 87.1 | 58.7 | 37.9 |
| | 8940 | | 9910 | | 525D | | 30B | | | | |
| | | | | | | | (2.9 wt %) | | | | |
| 509 | Surlyn | 32.9 | Surlyn | 32.9 | Fusabond | 28.2 | Cloisite | | 88.3 | 59.6 | 46.4 |
| | 8940 | | 9910 | | 525D | | 30B | | | | |
| | | | | | | | (6 wt %) | | | | |
| 510 | Surlyn | 31.9 | Surlyn | 31.9 | Fusabond | 27.3 | Cloisite | | 89.3 | 61.3 | 62.3 |
| | 8940 | | 9910 | | 525D | | 30B | | | | |
| | | | | | | | (8.9 wt %) | | | | |
| 511 | Surlyn | 30.8 | Surlyn | 30.8 | Fusabond | 26.4 | Cloisite | | 90.5 | 62.7 | 62.8 |
| | 8940 | | 9910 | | 525D | | 30B | | | | |
| | | | | | | | (12 wt %) | | | | |
| 512 | Surlyn | 37.5 | Surlyn | 37.5 | Nucrel | 25 | | | * | * | * |
| | 8945 | | 9910 | | 0910HS | | | | | | |
| 513 | Surlyn | 25 | Surlyn | 25 | Nucrel | 50 | | | * | * | * |
| | 8945 | | 9910 | | 0910HS | | | | | | |
| 514 | Surlyn | 12.5 | Surlyn | 12.5 | Nucrel | 75 | | | * | * | * |
| | 8945 | | 9910 | | 0910HS | | | | | | |
| 515 | Surlyn | 37.5 | Surlyn | 37.5 | Nucrel | 25 | | | * | * | * |
| | 8945 | | 9910 | | 1202HC | | | | | | |
| 516 | Surlyn | 25 | Surlyn | 25 | Nucrel | 50 | | | * | * | * |
| | 8945 | | 9910 | | 1202HC | | | | | | |
| 517 | Surlyn | 12.5 | Surlyn | 12.5 | Nucrel | 75 | | | * | * | * |
| | 8945 | | 9910 | | 1202HC | | | | | | |
| 518 | Surlyn | 50 | Surlyn | 50 | | | | | * | * | * |
| | 8940 | | 9910 | | | | | | | | |
| 519 | Surlyn | 50 | Surlyn | 50 | | | | | * | * | 68.2 |
| | 7940 | | 9910 | | | | | | | | |
| 520 | Amplify | 95 | Surlyn | 5 | | | | | * | * | * |
| | GR205 | | 9910 | | | | | | | | |
| 521 | Surlyn | 50 | Surlyn | 50 | | | | | * | * | * |
| | 8945 | | 9910 | | | | | | | | |
| 522 | Clarix | 45 | Surlyn | 45 | Fusabond | 10 | | | 92.0 | 63.6 | 54.6 |
| | 5152 | | 9945 | | 525D | | | | | | |
| 523 | Clarix | 42.5 | Surlyn | 42.5 | Fusabond | 15 | | | 90.6 | 62.9 | 46.5 |
| | 5152 | | 9945 | | 525D | | | | | | |
| 524 | Clarix | 40 | Surlyn | 40 | Fusabond | 20 | | | 89.1 | 61.6 | 40.5 |
| | 5152 | | 9945 | | 525D | | | | | | |
| 525 | Clarix | 58 | Surlyn | 32 | Fusabond | 10 | | | 93.1 | 66.2 | 52.2 |
| | 5152 | | 9945 | | 525D | | | | | | |
| 526 | Clarix | 55 | Surlyn | 30 | Fusabond | 15 | | | 91.6 | 63.8 | 45.4 |
| | 5152 | | 9945 | | 525D | | | | | | |
| 527 | Clarix | 52 | Surlyn | 28 | Fusabond | 20 | | | 91.0 | 63.2 | 41.8 |
| | 5152 | | 9945 | | 525D | | | | | | |
| 528 | Clarix | 72 | Surlyn | 18 | Fusabond | 10 | | | 92.6 | 65.0 | 50.7 |
| | 5152 | | 9945 | | 525D | | | | | | |
| 529 | Clarix | 68 | Surlyn | 17 | Fusabond | 15 | | | 91.8 | 64.5 | 49.5 |
| | 5152 | | 9945 | | 525D | | | | | | |
| 530 | Clarix | 65 | Surlyn | 15 | Fusabond | 20 | | | 90.2 | 62.0 | 41.7 |
| | 5152 | | 9945 | | 525D | | | | | | |
| 531 | Surlyn | 70 | Surlyn | 15 | Fusabond | 15 | | | 89.6 | 63.1 | 52.1 |
| | 7940 | | 9945 | | 525D | | | | | | |
| 532 | Surlyn | 65 | Surlyn | 15 | Fusabond | 20 | | | 88.4 | 61.8 | 46.7 |
| | 7940 | | 9945 | | 525D | | | | | | |
| 533 | Surlyn | 65 | Surlyn | 20 | Fusabond | 15 | | | 89.7 | 64.2 | 51.4 |
| | 7940 | | 9945 | | 525D | | | | | | |
| 534 | Surlyn | 60 | Surlyn | 20 | Fusabond | 20 | | | 88.6 | 62.5 | 47.8 |
| | 7940 | | 9945 | | 525D | | | | | | |
| 535 | Surlyn | 60 | Surlyn | 25 | Fusabond | 15 | | | 89.1 | 63.4 | 48.9 |
| | 7940 | | 9945 | | 525D | | | | | | |
| 536 | Surlyn | 55 | Surlyn | 25 | Fusabond | 20 | | | 87.9 | 61.9 | 43.8 |
| | 7940 | | 9945 | | 525D | | | | | | |
| 537 | Clarix | 80 | Surlyn | 10 | Fusabond | 10 | | | 92.1 | 64.3 | 53.1 |
| | 5152 | | 9945 | | 525D | | | | | | |
| 538 | Surlyn | 40 | Surlyn | 40 | Fusabond | 20 | | | * | * | 42.7 |
| | 8150 | | 9945 | | 525D | | | | | | |
| 539 | Surlyn | 37.5 | Surlyn | 37.5 | Fusabond | 25 | | | * | * | 39.7 |
| | 8150 | | 9945 | | 525D | | | | | | |
| 540 | Surlyn | 35 | Surlyn | 35 | Fusabond | 30 | | | * | * | 33.0 |
| | 8150 | | 9945 | | 525D | | | | | | |
| 541 | Clarix | 9 | Surlyn | 81 | Fusabond | 10 | | | 88.7 | 61.4 | * |
| | 5152 | | 9945 | | 525D | | | | | | |
| 542 | Clarix | 8.5 | Surlyn | 76.5 | Fusabond | 15 | | | 87.4 | 59.9 | * |
| | 5152 | | 9945 | | 525D | | | | | | |
| 543 | Clarix | 8 | Surlyn | 72 | Fusabond | 20 | | | 85.9 | 58.9 | * |
| | 5152 | | 9945 | | 525D | | | | | | |
| 544 | Clarix | 27 | Surlyn | 63 | Fusabond | 10 | | | 90.0 | 63.8 | * |
| | 5152 | | 9945 | | 525D | | | | | | |
| 545 | Clarix | 25.5 | Surlyn | 59.5 | Fusabond | 15 | | | 88.5 | 61.5 | * |
| | 5152 | | 9945 | | 525D | | | | | | |
| 546 | Clarix | 24 | Surlyn | 56 | Fusabond | 20 | | | 87.5 | 60.3 | * |
| | 5152 | | 9945 | | 525D | | | | | | |
| 547 | Surlyn | 40 | Surlyn | 40 | Fusabond | 20 | | | 89.5 | 61.6 | 42.9 |
| | 7940 | | 9945 | | 525D | | | | | | |
| 548 | Surlyn | 42.5 | Surlyn | 42.5 | Fusabond | 15 | | | 90.8 | 63.4 | 48.4 |
| | 7940 | | 9945 | | 525D | | | | | | |
| 549 | Surlyn | 45 | Surlyn | 45 | Fusabond | 10 | | | 92.4 | 65.8 | 57.1 |
| | 7940 | | 9945 | | 525D | | | | | | |
| 550 | Surlyn | 9 | Surlyn | 81 | Fusabond | 10 | | | 88.8 | 62.0 | 48.0 |
| | 7940 | | 9945 | | 525D | | | | | | |
| 551 | Surlyn | 8.5 | Surlyn | 76.5 | Fusabond | 15 | | | 90.9 | 63.6 | 44.2 |
| | 7940 | | 9945 | | 525D | | | | | | |
| 552 | Surlyn | 8 | Surlyn | 72 | Fusabond | 20 | | | 90.9 | 63.1 | 38.7 |
| | 7940 | | 9945 | | 525D | | | | | | |
| 553 | Surlyn | 27 | Surlyn | 63 | Fusabond | 10 | | | 90.9 | 63.1 | 51.8 |
| | 7940 | | 9945 | | 525D | | | | | | |
| 554 | Surlyn | 25.5 | Surlyn | 59.5 | Fusabond | 15 | | | 89.7 | 62.3 | 48.2 |
| | 7940 | | 9945 | | 525D | | | | | | |
| 555 | Surlyn | 24 | Surlyn | 56 | Fusabond | 20 | | | 87.7 | 60.0 | 43.0 |
| | 7940 | | 9945 | | 525D | | | | | | |
| 556 | Surlyn | 47.5 | Surlyn | 47.5 | Nucrel 960 | 5 | | | 91.7 | * | * |
| | 8945 | | 9945 | | | | | | | | |
| 557 | Surlyn | 75 | Surlyn | 25 | | | | | 93.4 | * | * |
| | 8945 | | 9945 | | | | | | | | |
| 558 | Surlyn | 50 | Surlyn | 50 | | | | | 93.8 | * | 60.7 |
| | 8945 | | 9945 | | | | | | | | |
| 559 | Surlyn | 25 | Surlyn | 75 | | | | | 94.2 | * | * |
| | 8945 | | 9945 | | | | | | | | |
| 560 | Clarix | 50 | Surlyn | 50 | | | | | 91.5 | 64.9 | 61.2 |
| | 5152 | | 9945 | | | | | | | | |
| 561 | Clarix | 80 | Surlyn | 20 | | | | | 91.8 | 65.0 | 62.7 |
| | 5152 | | 9945 | | | | | | | | |
| 562 | Clarix | 65 | Surlyn | 35 | | | | | 91.8 | 68.1 | 62.9 |
| | 5152 | | 9945 | | | | | | | | |
| 563 | Surlyn | 10 | Surlyn | 90 | | | | | * | * | * |
| | 7940 | | 9945 | | | | | | | | |
| 564 | Surlyn | 30 | Surlyn | 70 | | | | | 90.8 | 66.0 | 58.4 |
| | 7940 | | 9945 | | | | | | | | |
| 565 | Surlyn | 65 | Surlyn | 35 | | | | | 93.0 | 68.0 | 68.4 |
| | 7940 | | 9945 | | | | | | | | |
| 566 | Clarix | 10 | Surlyn | 90 | | | | | 90.6 | 65.6 | * |
| | 5152 | | 9945 | | | | | | | | |
| 567 | Clarix | 30 | Surlyn | 70 | | | | | 91.7 | 66.4 | * |
| | 5152 | | 9945 | | | | | | | | |
| 568 | Surlyn | 35 | Surlyn | 35 | Fusabond | 30 | | | 88.9 | 60.4 | 37.8 |
| | 8150 | | AD8546 | | 525D | | | | | | |
| 569 | Surlyn | 37.5 | Surlyn | 37.5 | Fusabond | 25 | | | 90.5 | 62.3 | 42.3 |
| | 8150 | | AD8546 | | 525D | | | | | | |
| 570 | Surlyn | 40 | Surlyn | 40 | Fusabond | 20 | | | 92.2 | 64.2 | 47.6 |
| | 8150 | | AD8546 | | 525D | | | | | | |
| 571 | Surlyn | 97 | Luzenac | 3 | | | | | * | * | * |
| | 9650 | | HAR T-84 | | | | | | | | |
| | | | Talc | | | | | | | | |
| 572 | Surlyn | 94 | Luzenac | 6 | | | | | * | * | * |
| | 9650 | | HAR T-84 | | | | | | | | |
| | | | Talc | | | | | | | | |
| 573 | Surlyn | 91 | Luzenac | 9 | | | | | * | * | * |
| | 9650 | | HAR T-84 | | | | | | | | |
| | | | Talc | | | | | | | | |
| 574 | Surlyn | 88 | Luzenac | 12 | | | | | * | * | * |
| | 9650 | | HAR T-84 | | | | | | | | |
| | | | Talc | | | | | | | | |
| 575 | Surlyn | 85 | Luzenac | 15 | | | | | * | * | * |
| | 9650 | | HAR T-84 | | | | | | | | |
| | | | Talc | | | | | | | | |
| 576 | Surlyn | 90 | Vestenamer | 10 | | | | | * | * | * |
| | 9945 | | 8012 | | | | | | | | |

* not measured

TABLE 2

| Example | Melt flow | Melt flow |
|---|---|---|
| (from Table 1) | 190° C. 2.16 kg | 190° C. 5 kg |
| 3 | 0.70 | * |
| 11 | 0.12 | * |
| 13 | 0.21 | * |
| 16 | 1.50 | * |
| 17 | 0.60 | * |
| 18 | 0.38 | * |
| 19 | 2.20 | * |
| 34 | 2.52 | * |
| 36 | 5.00 | * |
| 37 | 3.30 | * |
| 38 | 1.70 | * |
| 39 | 1.00 | * |
| 44 | 2.20 | * |
| 45 | 1.50 | * |
| 46 | 0.83 | * |
| 47 | 0.33 | * |
| 49 | 0.10 | * |
| 54 | 0.00 | 0.33 |
| 55 | 0.05 | 0.46 |
| 56 | 0.08 | 0.88 |
| 57 | 0.19 | 1.46 |
| 74 | 0.67 | * |
| 94 | 0.26 | 1.86 |
| 96 | 3.00 | * |
| 98 | 1.75 | * |
| 99 | 2.90 | * |
| 110 | 3.50 | * |
| 111 | 3.50 | * |
| 112 | 3.30 | * |
| 117 | 2.50 | * |
| 118 | 2.50 | * |
| 119 | 1.90 | * |
| 157 | 3.05 | * |
| 158 | 3.65 | * |
| 159 | 1.90 | * |
| 160 | 1.60 | * |
| 161 | 0.80 | * |
| 162 | 1.80 | * |
| 163 | 1.50 | * |
| 164 | 1.00 | * |
| 165 | 2.40 | * |
| 166 | 1.70 | * |
| 167 | 1.20 | * |
| 180 | 3.10 | * |
| 181 | 2.30 | * |
| 182 | 1.50 | * |
| 183 | 2.80 | * |
| 184 | 2.40 | * |
| 185 | 2.10 | * |
| 200 | 1.30 | * |
| 201 | 1.30 | * |
| 212 | 3.20 | * |
| 213 | 2.10 | * |
| 214 | 1.50 | * |
| 215 | 1.00 | * |
| 216 | 1.10 | * |
| 217 | 0.71 | * |
| 218 | 0.23 | * |
| 219 | 0.14 | * |
| 220 | 1.70 | * |
| 222 | 2.50 | * |
| 223 | 2.60 | * |
| 224 | 2.70 | * |
| 225 | 2.70 | * |
| 226 | 4.60 | * |
| 227 | 2.50 | * |
| 232 | 1.40 | * |
| 261 | 0.88 | * |
| 263 | 1.04 | * |
| 286 | 1.30 | * |
| 287 | 0.51 | * |
| 288 | 0.13 | * |
| 289 | 0.04 | * |
| 293 | 4.00 | * |
| 294 | 3.60 | * |
| 295 | 3.20 | * |
| 296 | 3.40 | * |
| 297 | 2.50 | * |
| 303 | 1.46 | * |
| 304 | 1.29 | * |
| 305 | 0.55 | * |
| 306 | 0.92 | * |
| 307 | 0.55 | * |
| 310 | 2.51 | * |
| 313 | 2.13 | * |
| 315 | 2.26 | * |
| 316 | 2.09 | * |
| 322 | 1.68 | * |
| 323 | 1.10 | * |
| 324 | 1.03 | * |
| 328 | 2.27 | * |
| 330 | 1.40 | * |
| 332 | 1.41 | * |
| 334 | 1.20 | * |
| 335 | 1.20 | * |
| 336 | 0.89 | * |
| 337 | 0.89 | * |
| 338 | 0.87 | * |
| 345 | 0.16 | * |
| 346 | 0.09 | * |
| 347 | 1.00 | * |
| 348 | 1.10 | * |
| 349 | 1.30 | * |
| 350 | 1.10 | * |
| 351 | 0.96 | * |
| 352 | 1.00 | * |
| 353 | 0.09 | * |
| 354 | 0.09 | * |
| 355 | 1.00 | * |
| 364 | 1.00 | * |
| 365 | 0.85 | * |
| 366 | 0.62 | * |
| 367 | 0.32 | * |
| 368 | 0.16 | * |
| 370 | 1.60 | * |
| 371 | 1.65 | * |
| 372 | 1.72 | * |
| 373 | 1.84 | * |
| 374 | 1.40 | * |
| 375 | 1.00 | * |
| 376 | 0.64 | * |
| 377 | 0.24 | * |
| 378 | 1.10 | * |
| 379 | 1.00 | * |
| 380 | 0.74 | * |
| 381 | 0.71 | * |
| 382 | 0.80 | * |
| 383 | 0.32 | * |
| 387 | 1.30 | * |
| 390 | 0.22 | * |
| 392 | 0.42 | * |
| 502 | 0.86 | * |
| 503 | 0.77 | * |
| 505 | 1.02 | * |
| 506 | 0.81 | * |

* not measured

The following polymer, additive, and filler materials were used in the above examples:

Akroflock® CDV-2 dark cotton flock and Akroflock® ND-109 dark nylon flock, commercially available from Akrochem Corporation;

Aktiplast® PP combination of zinc salts of fatty acids, commercially available from Rhein Chemie;

Amplify® GR204 maleic anhydride grafted HDPE having a density of 0.953 g/cm, Amplify® GR205 maleic anhydride grafted HDPE having a density of 0.962 g/cm, Amplify® GR216 maleic anhydride grafted plastomer, commercially available from The Dow Chemical Company;

Clarix® 011370-01 ethylene acrylic acid copolymer, Clarix® 211702-01 and Clarix® 2155 ethylene acrylic acid copolymers partially neutralized with a zinc cation; Clarix® 111704-01 ethylene acrylic acid copolymer partially neutralized with a sodium cation; and Clarix® 5152 and Clarix® 511705-01 ethylene acrylic acid copolymers partially neutralized with a lithium cation, commercially available from A. Schulman, Inc.;

Cloisite® 20A, Cloisite® 30B, and Cloisite® 6A organoclays, commercially available from Southern Clay Products, Inc.;

DuPont® HPF 1000 and HPF 2000 ethylene/acrylic acid copolymers in which the acid groups have been highly neutralized with magnesium ions, commercially available from E. I. du Pont de Nemours and Company;

Fusabond® 525D metallocene-catalyzed polyethylene, Fusabond® A560 functionalized ethylene acrylate copolymer, Fusabond® C190 and Fusabond® C250 functionalized ethylene vinyl acetate copolymers, Fusabond® E100 and Fusabond® E528 anhydride modified HDPEs, Fusabond® M603 random ethylene copolymer, Fusabond® N416 chemically modified ethylene elastomer, Fusabond® P353 and Fusabond® P613 functionalized polypropylenes, commercially available from E. I. du Pont de Nemours and Company;

Iriodin® 211 Rutile Fine Red pearl luster pigment, commercially available from The Merck Group;

Kemamide® W-40 fatty bisamide (N,N′-ethylenebisstearamide), commercially available from Crompton Corporation;

Kraton® FG1901GT, Kraton® FG1924GT, and Kraton® RP6670GT linear triblock copolymers based on styrene and ethylene/butylene, commercially available from Kraton Performance Polymers Inc.;

Lotader® 4210, Lotader® 4603, Lotader® 4700, and Lotader® 6200 ethylene/acrylic ester/maleic anhydride random terpolymers, and Lotader® 4720 and Lotader® 8200 ethylene/ethyl acrylate/maleic anhydride random terpolymers, commercially available from Arkema Corporation;

Luzenac® HAR T-84 high aspect ratio talc, commercially available from Luzenac America, Inc.;

NanoMax® I.31PS and NanoMax® I.44P nanoclays, commercially available from Nanocor, Inc.;

Nucrel® 0609HS ethylene methacrylic acid copolymer made with 6.5 wt % acid, Nucrel® 0910HS ethylene methacrylic acid copolymer made with 9 wt % acid, Nucrel® 960 ethylene methacrylic acid copolymer made with 15 wt % acid, Nucrel® 1202HC highly crystalline ethylene methacrylic acid copolymer made with 11.5 wt % acid, commercially available from E. I. du Pont de Nemours and Company;

Polybond® 3009 maleic anhydride grafted HDPE, commercially available from Chemtura Corporation;

Royaltuf® 485 maleic anhydride modified polyolefin based on a semi-crystalline EPDM, and Royaltuf® 498 maleic anhydride modified polyolefin based on an amorphous EPDM, commercially available from Chemtura Corporation;

Surlyn® 7930 ethylene/methacrylic acid (E/MAA) copolymer in which the acid groups have been partially neutralized with lithium ions, Surlyn® 7940 ethylene/methacrylic acid/acrylate terpolymer (15 wt % acid) in which the acid groups have been partially neutralized with lithium ions, Surlyn® 8150 E/MAA copolymer (19 wt % acid) in which the acid groups have been partially neutralized with sodium ions, Suryln® 8320 very low modulus ethylene/methacrylic acid/acrylate terpolymer (9 wt % acid) in which the acid groups have been partially neutralized with sodium ions, Surlyn® 8528 E/MAA copolymer (10 wt % acid) in which the acid groups have been partially neutralized with sodium ions, Surlyn® AD8546 E/MAA copolymer (19 wt % acid) in which the acid groups have been partially neutralized with lithium ions, Surlyn® 8940 and Surlyn® 8945 E/MAA copolymers (15 wt % acid) in which the acid groups have been partially neutralized with sodium ions; Surlyn® 9020 low modulus ethylene/methacrylic acid/acrylate terpolymer (10 wt % acid) in which the acid groups have been partially neutralized with zinc ions, Surlyn® 9120 E/MAA copolymer (19 wt % acid) in which the acid groups have been partially neutralized with zinc ions; Surlyn® 9320 very low modulus ethylene/methacrylic acid/acrylate terpolymer (9 wt % acid) in which the acid groups have been partially neutralized with zinc ions, Surlyn® 9650 E/MAA copolymer (11 wt % acid) in which the acid groups have been partially neutralized with zinc ions, Surlyn® 9910 and Surlyn® 9945 E/MAA copolymers (15 wt % acid) in which the acid groups have been partially neutralized with zinc ions, commercially available from E. I. du Pont de Nemours and Company;

Vestenamer® 8012 high trans content polyoctenamer rubber, commercially available from Evonik Industries;

Microglass REF-600, commercially available from Microglass;

Muscovite Mica SG-90, commercially available from Georgia Industrial Minerals, Inc.;

Suzorite Mica 200-PE, commercially available from Lintech International LLC;

Raven® 2500 and Raven® 1170 carbon blacks, commercially available from Columbian Chemicals Company; and

MPMA 500 mica-based pigment, commercially available from Mayan Pigments, Inc.

When numerical lower limits and numerical upper limits are set forth herein, it is contemplated that any combination of these values may be used.

All patents, publications, test procedures, and other references cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A golf ball comprising at least one layer formed from a thermoplastic composition having a JIS-C hardness (H) and a flexural modulus in ksi (M) wherein H≦11.889Ln(M)+42, and wherein M>6 ksi.

2. The golf ball of claim 1, wherein H≦11.889Ln(M)+41.

3. The golf ball of claim 1, wherein H≦11.889Ln(M)+40.

4. The golf ball of claim 1, wherein M>40 ksi.

5. The golf ball of claim 4, wherein H≦9.45Ln(−0.0105M²+3.95M−14)+40.

6. The golf ball of claim 1, wherein H<87 JIS-C.

7. The golf ball of claim 6, wherein M>41 ksi.

8. The golf ball of claim 6, wherein M>45 ksi.

9. The golf ball of claim 6, wherein M>50 ksi.

10. The golf ball of claim 6, wherein M>51 ksi.

11. The golf ball of claim 1, wherein M>8 ksi.

12. The golf ball of claim 1, wherein M>10 ksi.

13. The golf ball of claim 1, wherein M>15 ksi.

14. The golf ball of claim 1, wherein the golf ball comprises a core, a cover, and an intermediate layer disposed between the core and the cover, and wherein the intermediate layer is formed from the thermoplastic composition.

15. The golf ball of claim 14, wherein the thermoplastic composition is a polymer blend composition.

16. The golf ball of claim 15, wherein the polymer blend composition comprises an ionomer.

17. The golf ball of claim 16, wherein the polymer blend composition comprises a filler, and wherein the total amount of filler present in the composition is an amount of from 3 to 20 wt %, based on the total weight of the polymer blend composition.

18. The golf ball of claim 15, wherein the filler materials are selected from the group consisting of talc, nano-fillers, glass, mica, and combinations thereof.

19. A golf ball comprising a core, a cover, and an intermediate layer disposed between the core and the cover, wherein the intermediate layer is formed from a polymer blend composition, wherein the polymer blend composition comprises an ionomer and has a JIS-C hardness (H) and a flexural modulus in ksi (M) wherein H≦9.45Ln(−0.0105M²+3.95M−14)+40, and wherein M>40 ksi.

20. The golf ball of claim 19, wherein H<87 JIS-C.

21. The golf ball of claim 19, wherein M>50 ksi.

22. A polymer blend composition comprising an ionomer and having a JIS-C hardness (H) and a flexural modulus in ksi (M) wherein H<11.889Ln(M)+42, and wherein M>6 ksi.

23. The polymer blend composition of claim 22, wherein M>8 ksi.

24. The polymer blend composition of claim 22, wherein M>10 ksi.

25. The polymer blend composition of claim 22, wherein M>15 ksi.

26. The polymer blend composition of claim 22, wherein M>40 ksi.

27. The polymer blend composition of claim 26, wherein H≦9.45Ln(−0.0105M²+3.95M−14)+40.

28. The polymer blend composition of claim 22, wherein H≦11.889Ln(M)+41.

29. The polymer blend composition of claim 22, wherein H≦11.889Ln(M)+40.
